(19) United States
(12) Patent Application Publication
(10) Pub. No.: US 2026/0325972 A1
(43) Pub. Date: Oct. 22, 2026

(54) Virtual Character Control Method and Apparatus, Device, Medium, and Program Product

(71) Applicant: Tencent Technology (Shenzhen) Company Limited., Shenzhen (CN)

(72) Inventors: Ruochen Liu, Shenzhen (CN); Wenya Wei, Shenzhen (CN); Hailong Wang, Shenzhen (CN); Tianzhou Wang, Shenzhen (CN); Qixian Zhou, Shenzhen (CN); Sze Yeung Liu, Shenzhen (CN); Xuelei Zhang, Shenzhen (CN); Peipei Jin, Shenzhen (CN)

(21) Appl. No.: 19/714,961

(22) Filed: Jun. 22, 2026

Related U.S. Application Data
(63) Continuation of application No. PCT/CN2025/105722, filed on Jun. 30, 2025.

(30) Foreign Application Priority Data
Aug. 9, 2024 (CN) 2024110963748

(51) Int. Cl. A63F 13/56; A63F 13/424; A63F 13/837; G10L 15/08; G10L 15/18; G10L 15/22; G10L 15/26

(52) U.S. Cl. CPC A63F 13/56; A63F 13/424; A63F 13/837; G10L 15/1815; G10L 15/22; G10L 15/26; G10L 2015/088; G10L 2015/223

(57) ABSTRACT

A virtual character control method and apparatus, a device, a medium, and a program product are disclosed. The method includes: displaying at least one of a main control virtual character and a non-player character (NPC) that are located in a virtual environment; obtaining a natural language command in a voice form, the natural language command including natural semantics for controlling the NPC; and controlling, based on a behavioral intention expressed by the natural language command, the NPC to perform a virtual activity.

### RELATED APPLICATIONS

This application claims priority to PCT/CN2025/105722, filed on Jun. 30, 2025, which claims priority to Chinese Patent Application No. 202411096374.8, entitled “VIRTUAL CHARACTER CONTROL METHOD AND APPARATUS, DEVICE, MEDIUM, AND PROGRAM PRODUCT” filed on Aug. 9, 2024, each of which is incorporated herein by reference in its entirety.

### FIELD OF THE TECHNOLOGY

Examples of this disclosure relate to the field of human-computer interaction, and in particular, to a virtual character control method and apparatus, a device, a medium, and a program product.

### BACKGROUND OF THE DISCLOSURE

In a current game application, a player may control a main control virtual character to participate in a virtual battle individually or through teaming.

In the related art, to make a game more interesting, when a player controls a main control virtual character to participate in a virtual battle, the player may select a non-player character (NPC) to participate in the virtual battle in coordination with the main control virtual character. If the player controls the NPC using a natural language command in a speech form (e.g., voice control), a pre-trained speech recognition system is typically used to perform text analysis on the natural language command, to control the NPC using text content obtained through analysis.

However, the speech recognition system is obtained through training based on a large quantity of text words. Therefore, it is likely that text words with similar pronunciations cannot be flexibly distinguished during text analysis. Consequently, outputted text content often has a broad meaning and low accuracy, leading to low control precision for the NPC and affecting efficiency of human-computer interaction.

### SUMMARY

Examples of this disclosure provide a virtual character control method and apparatus, a device, a medium, and a program product, to better understand a natural language command based on environmental perception information and improve precision of a recognized behavioral intention, to make the behavioral intention better match a virtual environment, reduce a misoperation rate of a player, and improve efficiency of human-computer interaction. The technical solutions are as follows:

According to an aspect, a virtual character control method is provided, and is performed by a computer device. The method includes: displaying at least one of a main control virtual character or an NPC that are located in a virtual environment; obtaining a natural language command in a speech form (e.g., a voice form), the natural language command including natural semantics for controlling the NPC; and controlling, based on a behavioral intention expressed by the natural language command, the NPC to perform a virtual activity. The behavioral intention can be recognized from the natural language command based on environmental perception information. The environmental perception information includes information obtained by perceiving the virtual environment by at least one of the main control virtual character and the NPC.

According to another aspect, a virtual character control method is provided. The method includes: obtaining a natural language command in a speech form, the natural language command including natural semantics for controlling an NPC; converting the natural language command into a command analysis result in a text form, the command analysis result being a result obtained by performing speech-to-text conversion on the natural language command based on environmental perception information, and the environmental perception information including information obtained by perceiving a virtual environment by at least one of a main control virtual character and the NPC; and performing behavioral intention recognition on the command analysis result to obtain a behavioral intention, the behavioral intention being configured to control the NPC to perform a virtual activity.

According to another aspect, a virtual character control apparatus is provided. The apparatus includes: a display module, configured to display at least one of a main control virtual character or an NPC that are located in a virtual environment; an obtaining module, configured to obtain a natural language command in a speech form, the natural language command including natural semantics for controlling the NPC; and a control module, configured to control, based on a behavioral intention expressed by the natural language command, the NPC to perform a virtual activity, the behavioral intention being recognized from the natural language command based on environmental perception information, the environmental perception information including information obtained by perceiving the virtual environment by at least one of the main control virtual character and the NPC.

According to another aspect, a virtual character control apparatus is provided. The apparatus includes: an obtaining module, configured to obtain a natural language command in a speech form, the natural language command including natural semantics for controlling an NPC; a conversion module, configured to convert the natural language command into a command analysis result in a text form, the command analysis result being a result obtained by performing speech-to-text conversion on the natural language command based on environmental perception information, and the environmental perception information including information obtained by perceiving a virtual environment by at least one of a main control virtual character or the NPC; and a recognition module, configured to perform behavioral intention recognition on the command analysis result to obtain a behavioral intention, the behavioral intention being configured to control the NPC to perform a virtual activity.

According to another aspect, a computer device is provided. The computer device includes a processor and a memory. The memory has at least one instruction, at least one program, a code set, or an instruction set stored therein. The at least one instruction, the at least one program, the code set, or the instruction set is loaded and executed by the processor to implement the virtual character control method according to any one of the foregoing examples of this disclosure.

According to another aspect, a non-transitory computer-readable storage medium is provided. The storage medium has at least one instruction, at least one program, a code set, or an instruction set stored therein. The at least one instruction, the at least one program, the code set, or the instruction set is loaded and executed by a processor to implement the virtual character control method according to any one of the foregoing examples of this disclosure.

According to another aspect, a computer program product or a computer program is provided. The computer program product or the computer program includes computer instructions. The computer instructions are stored in a computer-readable storage medium. A processor of a computer device reads the computer instructions from the computer-readable storage medium, and the processor executes the computer instructions, to enable the computer device to perform the virtual character control method according to any one of the foregoing examples.

The technical solutions provided in examples of this disclosure have at least the following beneficial effects:

After a natural language command that is in a speech (e.g. voice) form and that is configured to command an NPC is obtained, a behavioral intention is recognized from the natural language command based on environmental perception information obtained by perceiving a virtual environment by at least one of a main control virtual character and the NPC, to control, based on the behavioral intention, the NPC to perform a virtual activity. The environmental perception information of the main control virtual character and/or the NPC helps better understand the natural language command, to improve accuracy of analyzing the natural language command, and further improve precision of the recognized behavioral intention, so that the behavioral intention better matches the virtual environment. This greatly avoids ineffective command or incorrect command on the NPC, helps reduce a misoperation rate of a player, helps the player reduce a quantity of operations during a virtual battle to some extent, reduces an amount of operation-related data to be processed, and improves utilization of computing resources and efficiency of human-computer interaction.

### BRIEF DESCRIPTION OF THE DRAWINGS

FIG. 1 is a flowchart of commanding an NPC in a virtual environment using a speech command in a natural language form (a natural language instruction) according to an example of this disclosure.

FIG. 2 is a block diagram of a structure of a control system according to an example of this disclosure.

FIG. 3 is a flowchart of a virtual character control method according to an example of this disclosure.

FIG. 4 is a flowchart of a virtual character control method according to another example of this disclosure.

FIG. 5 is a flowchart of a virtual character control method according to still another example of this disclosure.

FIG. 6 is a diagram of an interface for determining an object perception range according to an example of this disclosure.

FIG. 7 is a flowchart of behavioral intention recognition according to an example of this disclosure.

FIG. 8 is a diagram of performing behavioral intention recognition on a command analysis result according to an example of this disclosure.

FIG. 9 is a diagram of first-level candidate labels according to an example of this disclosure.

FIG. 10 is a diagram of first-level candidate labels according to another example of this disclosure.

FIG. 11 is a flowchart of analysis of behavioral intention recognition according to an example of this disclosure.

FIG. 12 is a diagram of obtaining a command recognition result through segmentation according to an example of this disclosure.

FIG. 13 is a diagram of a prediction network training method according to an example of this disclosure.

FIG. 14 is a flowchart of obtaining, by a server, a behavioral intention through analysis based on a natural language command according to an example of this disclosure.

FIG. 15 is a technical flowchart of a virtual character control method according to an example of this disclosure.

FIG. 16 is a diagram of an interface of a virtual character control method according to an example of this disclosure.

FIG. 17 is a flowchart of a virtual character control method according to an example of this disclosure.

FIG. 18 is a block diagram of a structure of a virtual character control apparatus according to an example of this disclosure.

FIG. 19 is a block diagram of a structure of a virtual character control apparatus according to an example of this disclosure.

FIG. 20 is a diagram of a structure of a terminal according to an example of this disclosure.

### DESCRIPTION OF EMBODIMENTS

First, terms used in examples of this disclosure are briefly described.

Virtual scene: a virtual scene displayed (or provided) when an application runs on a terminal.

Virtual model: a model for simulating a real scene in a virtual scene.

Virtual character/Virtual object: a movable object in a virtual scene.

In examples of this disclosure, a virtual character control method is described. A natural language command in a speech form can be better understood based on environmental perception information in a virtual scene, to obtain a more accurate command analysis result in a text form and further improve precision of a behavioral intention recognized based on the command analysis result, so that the behavioral intention better matches a virtual environment, to improve accuracy of controlling an NPC in the virtual environment. The virtual character control method provided in examples of this disclosure may be applied to a virtual scene in which a speech conversion process needs to be performed, for example, a terminal game scene, a virtual reality (VR) scene, an augmented reality (AR) scene, a virtual tourism scene, a virtual conference scene, a virtual shopping scene, or a virtual fitness scene. This is not limited in examples of this disclosure.

In an example, an example in which the virtual character control method is applied to a terminal game is used for description.

For example, a game application is installed on a terminal. During running of the game application, a virtual environment for a player to perform a virtual battle is displayed. The virtual environment includes at least one of a main control virtual character and an NPC. The NPC in a virtual scene may be commanded/controlled in a speech control mode. After the player initiates a natural language command in a speech form, the terminal obtains the natural language command. The natural language command includes natural semantics for controlling the NPC. When the natural language command is received, environmental perception information is obtained based on perception of the main control virtual character and/or the NPC for the virtual environment. For example, a virtual stable or a virtual obstacle around is perceived. Then recognition is performed on the natural language command with assistance of the environmental perception information to obtain a behavioral intention, and the NPC is controlled, based on the behavioral intention, to perform a virtual activity. Because of a constraint of the environmental perception information, the behavioral intention better matches the virtual environment. This helps improve accuracy of recognizing the behavioral intention, to more precisely control the NPC to perform the virtual activity, and improve efficiency and accuracy of controlling the NPC.

In an example, an example in which the virtual character control method is applied to the VR scene is used for description.

For example, a virtual environment received from a computer device may be transmitted and displayed through a VR head-mounted display. A player observes the virtual environment by wearing the VR head-mounted display. The player may further move to another location in the virtual environment by moving, adjusting a body part, or the like, to explore a virtual scene. For example, the player wearing the VR head-mounted display is a main control virtual character. The virtual environment displayed by the VR head-mounted display may further include a virtual character controlled and/or commanded by another player and an NPC. In some embodiments, the player may control the NPC by using a natural language command in a speech form. The VR head-mounted display may receive the natural language command in the speech form through a deployed microphone array, and perform autonomous analysis on the natural language command, or transmit the natural language command to a computer device connected to the VR head-mounted display for analysis. The natural language command includes natural semantics for controlling the NPC. When the natural language command is received, environmental perception information is obtained based on perception of the main control virtual character and/or the NPC for the virtual environment. For example, an enemy virtual character, a teammate virtual character, or a virtual knife around is perceived. Then recognition is performed on the natural language command with assistance of the environmental perception information to obtain a behavioral intention, and the NPC is controlled, based on the behavioral intention, to perform a virtual activity. Because of a constraint of the environmental perception information, the behavioral intention better matches the virtual environment. This helps improve accuracy of recognizing the behavioral intention, to more precisely control the NPC to perform the virtual activity, and make the VR scene more interesting, so that the player can enjoy more vivid and in-depth virtual experience.

In this application, before user-related data is collected and during collection of the user-related data, a prompt interface or a pop-up window may be displayed, or voice prompt information may be outputted. The prompt interface, the pop-up window, or the voice prompt information is configured for notifying the user that the user-related data is currently being collected. In this way, in this application, related operations of obtaining the user-related data start to be performed only after a confirmation operation of the user on the prompt interface or the pop-up window is obtained. Otherwise (to be specific, when no confirmation operation of the user on the prompt interface or the pop-up window is obtained), the related operations of obtaining the user-related data are ended, that is, the user-related data is not to be obtained. In other words, all user data collected in this application is collected with consent and authorization of the user. In addition, collection, use, and processing of the related user data need to comply with related laws, regulations, and standards of related regions. Information (including but not limited to user equipment information, user personal information, and the like), data (including but not limited to data for analysis, stored data, displayed data, and the like), and signals in this application are all authorized by users or fully authorized by all parties, and collection, use, and processing of related data need to comply with related laws, regulations, and standards of related regions. For example, all content such as natural language commands in this application is obtained with full authorization.

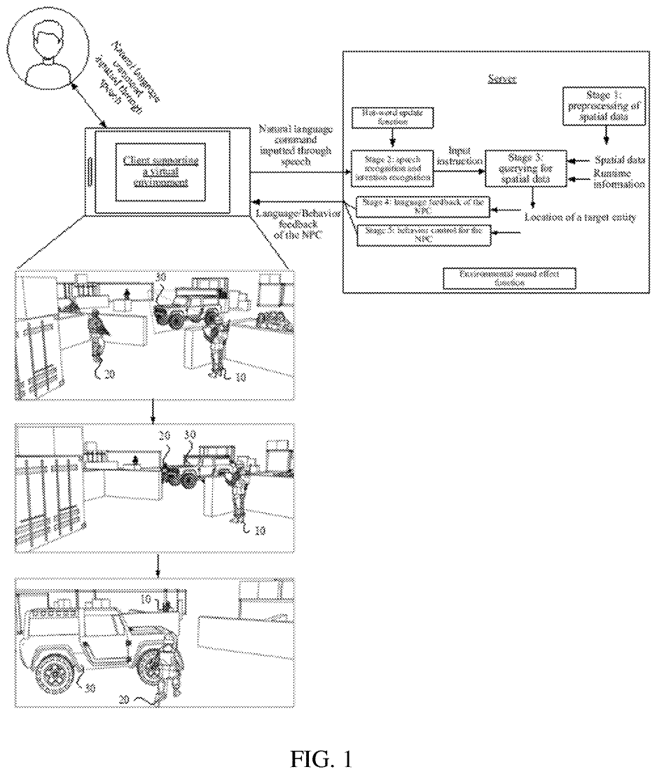

Examples of this disclosure provide a user with a solution for commanding and controlling an NPC in a virtual environment using a natural language speech command in a natural language speech form. In the solution, in addition to a main control virtual character controlled by the user, the user typically further has one or more NPCs as teammates. The user may command, through casual human conversation rather than a mechanical command, the NPC to make a user-expected feedback to a scene object in the virtual environment, to command the NPC to complete a task in cooperation with the main control virtual character. For example, as shown in FIG. 1, a user controls a main control virtual character 10 to play a game, and the main control virtual character 10 has an NPC teammate 20. There is an automobile 30 within a field of view (FOV) of the main control virtual character 10. The user utters a natural speech command instruction in a natural language speech form: “No. 2, go to the rear of the automobile 30 for an ambush”. Then the NPC teammate 20 autonomously walks to the rear of the automobile 30 for an ambush. There may be a plurality of automobiles in a scene shown in FIG. 1. The NPC teammate 20 accurately understands that the automobile mentioned by the user is the automobile 30 within the FOV of the user. That is, the NPC teammate 20 has an intelligent natural language understanding capability.

In comparison with the conventional technology in which an NPC is commanded using a fixed mechanical instruction, in examples of this disclosure, an NPC is commanded using a casual natural language command, so that a more natural, more complex, and more flexible language command capability can be provided for a user.

In addition, intelligence of the natural language understanding capability provided in examples of this disclosure lies in: When understanding a natural language command, an NPC teammate not only considers literal information of the natural language command, but also understands semantics in the natural language command with assistance of environmental perception information of a main control virtual character and/or the NPC for a virtual environment. That is, the NPC not only considers information in the natural language command modality, but also considers perception information in other modalities such as an FOV, hearing, and radar, to help understand and execute the natural language command. Because a natural language command in a speech form is a command in an oral form rather than a command in a written form, considering only literal information of the natural language command may lead to a plurality of candidate understanding manners or ambiguity. The NPC teammate can determine a proper understanding manner from the plurality of candidate understanding manners or eliminate a doubt about the ambiguity based on the environmental perception information of the main control virtual character and/or the NPC for the virtual environment, to implement an intelligent natural language understanding capability. The environmental perception information mentioned above includes, but is not limited to, at least one of the following:
visual information perceived within an FOV of the main control virtual character;
auditory information perceived within an auditory range of the main control virtual character;
information perceived by a perceptual skill or a perceptual item that is owned by the main control virtual character;
visual information perceived within an FOV of the NPC;
auditory information perceived within an auditory range of the NPC; or
information perceived by a perceptual skill or a perceptual item that is owned by the NPC.

With reference to FIG. 1, the solution includes at least one of the following five stages:

Stage 1: preprocessing of spatial data

A server preprocesses a scene object in a virtual scene to construct spatial data of the virtual scene.

The spatial data of the virtual scene includes a matching visual label of the scene object and a spatial location of the scene object. In some examples, the spatial data further includes an appearance image of the scene object. The scene object is any object appearing in the virtual scene, for example, the automobile, a wall, or a box in FIG. 1.

First, a process of pre-obtaining the matching visual label of the scene object is described. First, attribute information of the scene object in the virtual scene, for example, at least one of a name, a size, and the like of the scene object, is obtained, and the appearance image of the scene object is obtained. The appearance image includes images obtained by observing the scene object from at least two angles of view. Observing the scene object from a plurality of angles of view can ensure that the appearance image carries comprehensive appearance information of the scene object.

The server invokes a multi-modal model to perform prediction on the attribute information and the appearance image of the scene object, extracts a hidden-layer feature from the attribute information in a text dimension and the appearance image in an image dimension based on the multi-modal model with a capability of processing text-dimension information and image-dimension information, and decodes the hidden-layer feature to perform prediction to obtain a visual object label of the scene object. The visual object label is configured for describing the scene object in at least one dimension in a text form, for example, describing the scene object in material, transparency, color, and shape dimensions. The server invokes a natural language model to perform label optimization on the visual object label to obtain a matching visual label of the scene object. The natural language model has a text generation capability, and rewrites, in a manner conforming to oral expression of natural language, the visual object label inputted to the natural language model, to implement label optimization on the visual object label to obtain an optimized matching visual label of the scene object. The optimized visual label conforms to oral expression of natural language, and describes the scene object in at least one dimension in a manner close to oral expression. For example, a virtual bed in the virtual scene is described through oral expression. Usually, attention is paid to a color, a material, a placement location, and the like of the virtual bed, and little attention is paid to processes such as carving and embossing that are applied to a head of the bed or a side panel of the bed. An objective of performing quasi-colloquial rewriting on the visual label of the scene object is to obtain a matching label closer to oral expression. For example, a plurality of phrases with same semantics are used to enrich labels in the color, material, and placement location dimensions to which attention is paid during oral expression, and labels in a surface feature dimension of the head of the bed and the side panel of the bed to which little attention is paid during oral expression are deleted.

Next, the spatial location of the scene object is described. The spatial location includes at least one of the following of the scene object: a coordinate location, for example, coordinate information of a center point or a preset point of the scene object in the virtual scene; a rotation, for example, a direction that a front side of the scene object faces in the virtual scene; a bounding box, configured for indicating a size of the scene object in the virtual scene; or a cover point, configured for indicating a virtual character location point recommended when a virtual character approaches the scene object, to enable the scene object to cover the virtual character.

Next, a process of pre-obtaining the appearance image of the scene object is described. The appearance image is obtained in a process of performing prediction to obtain the matching visual label of the scene object. The appearance image includes images obtained by observing the scene object from at least two angles of view. In some embodiments, spatial data of scene objects in the entire virtual environment is pre-obtained and organized into a data set for use during querying in a subsequent stage.

Stage 2: speech recognition and behavioral intention recognition

In a process in which the user controls the main control virtual character, a terminal receives a natural language command inputted by the user through speech. The server performs speech recognition and behavioral intention recognition on the natural language command to analyze an input instruction of the user.

The speech recognition is intended to perform text conversion on the natural language instruction inputted by the user through speech to obtain instruction text corresponding to the natural language instruction, to convert speech information into text information. An encoding network is invoked to perform feature encoding on the instruction text to obtain a feature representation of the natural language instruction in hidden-layer space. A text segmentation network is invoked to segment the feature representation to obtain a plurality of clauses in the instruction text. Then behavioral intention recognition is separately performed on each of the plurality of clauses. When the natural language instruction inputted by the user through speech is a long sentence, the instruction text corresponding to the natural language instruction can be segmented, to meet a requirement of analyzing the input instruction of the user in a long-sentence scenario.

The behavioral intention recognition on each clause is described below. The input instruction of the user is obtained through behavioral intention recognition, and the input instruction of the user includes an entity, a semantic type, a subject type, and an intention type in at least one clause.

In one aspect, the entity in the clause is recognized by using a conditional random field (CRF). For example, the entity in the clause is recognized as a scene object like a building, a virtual object, or a virtual plant in the virtual scene. The entity in the clause is configured for indicating a scene object targeted by a virtual activity. For example, the entity in the clause is a virtual building, and the clause carries semantics for instructing the NPC to initiate a virtual attack. In this case, the virtual attack is performed against the virtual building. In other words, the virtual attack is initiated against the virtual building. In another aspect, a prediction network is invoked to separately predict the semantic type, the subject type, and the intention type in the clause. The semantic type includes whether to instruct the NPC to initiate a virtual attack. The subject type is configured for indicating that a subject of the clause is one or more NPCs, or the main control virtual character controlled by the user. The intention type is an expected virtual activity indicated by the clause, for example, moving or initiating a virtual attack.

Stage 3: querying for spatial data

A target entity in virtual space and a control instruction for the NPC is determined through an artificial intelligence (AI) model by using the input instruction of the user as an input and with reference to the spatial data of the virtual scene and runtime information corresponding to the main control virtual character.

For the entity in the input instruction, a spatial location of the entity in the virtual environment needs to be determined. For example, the input instruction in a text form is first parsed to obtain the entity in the text instruction. When a plurality of candidate entities in the virtual environment match the entity in the input instruction, a target entity matching the input instruction may be uniquely determined from the plurality of candidate entities based on the environmental perception information of the main control virtual character and/or the NPC. For example, the environmental perception information is FOV information of the main control virtual character. Then a spatial location, in the virtual environment, of the target entity corresponding to the input instruction is found by using spatial data of a scene in the virtual environment as a query range and using a real-time location and rotation of the main control virtual character as query reference conditions, to subsequently control the NPC to move near a location of the target entity, or perform, on the location of the target entity, behavior indicated by the input instruction.

However, because the main control virtual character and/or the NPC may have a plurality of types of environmental perception information, the plurality of types of environmental perception information may be integrated to assist in the process of determining the target entity, or the plurality of types of environmental perception information may be used, based on a priority, to assist in the process of determining the target entity. This is not limited.

Stage 4: speech feedback of the NPC

The NPC makes a speech feedback to the user. A type of the speech feedback includes at least one of an instant feedback, an instruction execution feedback, and a dynamic feedback. The instant feedback means that, after the user initiates a natural language instruction to the NPC, the NPC instantly makes a speech feedback, for example, “Got it”, “Execution started”, and “OK”, to the natural language instruction. The execution instruction feedback means that, after executing a control instruction indicated by an intention of the natural language instruction, the NPC makes a speech feedback on an execution result of the control instruction, for example, “Successfully executed” or “Execution failed”. The dynamic feedback means that the NPC makes a speech feedback based on real-time environmental perception when the user initiates no natural language instruction to the NPC.

The speech feedback is obtained by performing text-to-speech conversion on text content. The text content is content obtained through inference by using a large language model (LLM) based on the foregoing spatial data and dynamic runtime information and environmental perception information. Dynamically generating the text content of the speech feedback by using the LLM can address a monotonous, mechanical, and easily repeated speech feedback based on a fixed template. In addition, it is unnecessary to prestore too much pre-produced template speech, to prevent an overall data size of a client from being excessively large.

Stage 5: behavior control for the NPC

A target entity in virtual space and a control instruction for the NPC is determined through an AI model by using the input instruction of the user as an input and with reference to the spatial data of the virtual scene and runtime information corresponding to the main control virtual character.

The natural language command usually further includes the control instruction, and the control instruction is an instruction that may be executed by a behavior tree of the NPC. A subsequent action that the control instruction instructs the NPC to perform may be a single action or an action sequence. When the control instruction is a multi-action sequence instruction, the multi-action sequence instruction is configured for instructing the NPC to perform an action sequence. A data structure for storing the multi-action sequence instruction is in a list form, and a to-be-executed instruction in the sequence instruction is cached. When the behavior tree of the NPC completes executing a current instruction, the cache is called back, and the to-be-executed instruction in the cache is further delivered and executed.

Hot-word update function:

For the stage 2, a hot-word system is further introduced into the solution to help improve accuracy of speech recognition.

The hot-word system is configured to provide a scene hot-word related to a scene included in a natural language instruction during speech recognition. Therefore, when a natural language instruction inputted through speech is received, a word can be preferentially found, from a hot-word library based on a currently running virtual scene, as a speech recognition result/instruction analysis result, so that the instruction analysis result/speech recognition result better matches the virtual scene.

The virtual scene includes at least one of a plurality of scene types, for example, includes at least one of a plurality of virtual scenes such as a virtual battle scene type, a virtual transaction scene type, a virtual office scene type, and a virtual kitchen scene type. Words frequently used in a plurality of virtual scene types, a particular virtual element existing in a virtual scene type, and the like (for example, a virtual building or a virtual character object that exists only in a particular scene type) are pre-analyzed as scene hot-words, to obtain a scene hot-word library including a plurality of scene hot-words, the plurality of scene hot-words respectively corresponding to the virtual scene types. In addition, different scene language models are pre-trained for different virtual scene types. For example, a scene language model in a battle scene focuses more on battle-related words, and a scene language model in a transaction scene focuses more on transaction-related words. The scene language model can analyze, in a more targeted manner, a natural language instruction/natural language command received in a virtual scene type.

For example, a natural language instruction/natural language command is received in a process in which the user controls the main control virtual object character/NPC. It is determined, based on a game status, an object location, and a current task completion status, that a first virtual scene in which the main control virtual character and/or the NPC are/is currently located is a virtual battle scene and a target scene type is a battle scene type. A battle scene language model corresponding to the virtual battle scene type is obtained, and a target first scene hot-word in the virtual battle scene type is obtained based on an FOV of the main control target virtual object character, including “truck”, “virtual grass”, “virtual house”, “enter”, “open the truck”, “defense”, “desert”, “attack”, “oak tree”, “stable”, “enemy A” within the FOV, and the like. The natural language instruction/natural language command is decoded using a pre-trained natural language analysis model (including an acoustic model network, a target scene language network model, a preset dictionary, and the like) decoding network and the like under a constraint of the first target scene hot-word. Outputted text content is “Go to attack” instead of a result typically obtained through speech recognition: “Go to provide”, so that accuracy of an input instruction of the user is improved. In addition, an instruction analysis result is outputted to accurately control the NPC. The instruction analysis result is described using the following examples.

(1) The instruction analysis result is “No. 1, go to the front for defense”, and the instruction analysis result may specifically control No. 1 to move to the front for defense, to prevent an enemy virtual character from attacking the main control virtual character first. Without the constraint of the first scene hot-word, the natural language command is likely to be recognized as “No. 1, go to the front to make a sound”, affecting a virtual battle plan of a player.

(2) The instruction analysis result is “No. 2, go to explore the desert”, and the instruction analysis result may specifically control No. 2 to move to a location of the desert to check whether a virtual element such as an enemy virtual character or a virtual treasure box exists. Without the constraint of the first scene hot-word, the natural language command is likely to be recognized as “No. 2, go to explore the mountain”. Consequently, No. 2 moves to a wrong location, leading to low efficiency of human-computer interaction.

(3) The instruction analysis result is “No. 1 and No. 2, go to attack”, and the instruction analysis result may specially control No. 1 and No. 2 to perform virtual attacks against a nearby attackable virtual character. Without the constraint of the first scene hot-word, the natural language command is likely to be recognized as “No. 1 and No. 2, go to provide”. Consequently, No. 1 and No. 2 perform wrong actions that do not meet an expectation of a player. In this case, the main control virtual character cannot be protected, and an enemy virtual character is more likely to win a virtual battle.

(4) The instruction analysis result is “No. 1, go to find an oak tree nearby”, and the instruction analysis result may specially control No. 1 to find an oak tree in a nearby area, to complete a game task or find an oak tree for evading an attack. Without the constraint of the first scene hot-word, the natural language command is likely to be recognized as “No. 1, go to find an item book nearby”. Consequently, No. 1 searches for a nearby virtual element that does not meet an expectation of a player, failing to meet a virtual battle requirement of the player.

(5) The instruction analysis result is “No. 1 and No. 2, go to the stable there”, and the instruction analysis result may specially control No. 1 and No. 2 to search for a nearby stable and specially move to a location of the stable. Without the constraint of the first scene hot-word, the natural language command is likely to be recognized as “No. 1 and No. 2, go there. It'll be done soon.” Consequently, No. 1 and No. 2 mistakenly consider that the main control virtual character currently wants to individually complete a virtual battle, and therefore cannot provide good battle assistance for the main control virtual character.

Environmental sound effect function:

In addition, for an environmental sound effect of an entire virtual scene, the solution further provides a spatial audio enhancement solution.

Audio played by the terminal includes environmental audio and NPC audio. The environmental audio is audio generated based on scene characteristics of a virtual scene in which the main control virtual object is currently located, so that the user achieves an immersive feeling. The NPC audio is audio generated based on characteristics of an NPC, so that the user intuitively feels an emotion and a physical state of a character based on sound that the user hears.

Environmental audio: Scene elements in the virtual scene in which the main control virtual object are located is recognized, suitable element sound effects are generated in real time/selected from a sound effect library based on the scene elements, and the element sound effects are synthesized to obtain the environmental audio. For example, if the virtual scene is a forest at night, the scene elements include a tree, an owl, an insect, and the like, and the environmental audio includes rustling of tree leaves, hooting of the owl, whistling of the insect, and the like.

NPC audio: An NPC included in the virtual scene is determined, and corresponding character speech is generated based on a character type, a current emotion, and current behavior of the NPC. For example, when the NPC is a middle-aged man who is running, generated character speech is in a deep male voice timbre with a panting sound effect during running. When playing the environmental audio and/or the NPC audio to the user, the terminal performs audio enhancement on the environmental audio and/or the NPC audio to improve a sense of reality of the audio.

In some embodiments, a control system in the embodiments of this application is described. The virtual character control method provided in the embodiments of this application may be independently performed by a terminal, or may be performed by a server, or may be performed by a terminal and a server through data exchange. This is not limited in the embodiments of this application. In some embodiments, an example in which the virtual character control method is performed by a terminal and a server through interaction is used for description.

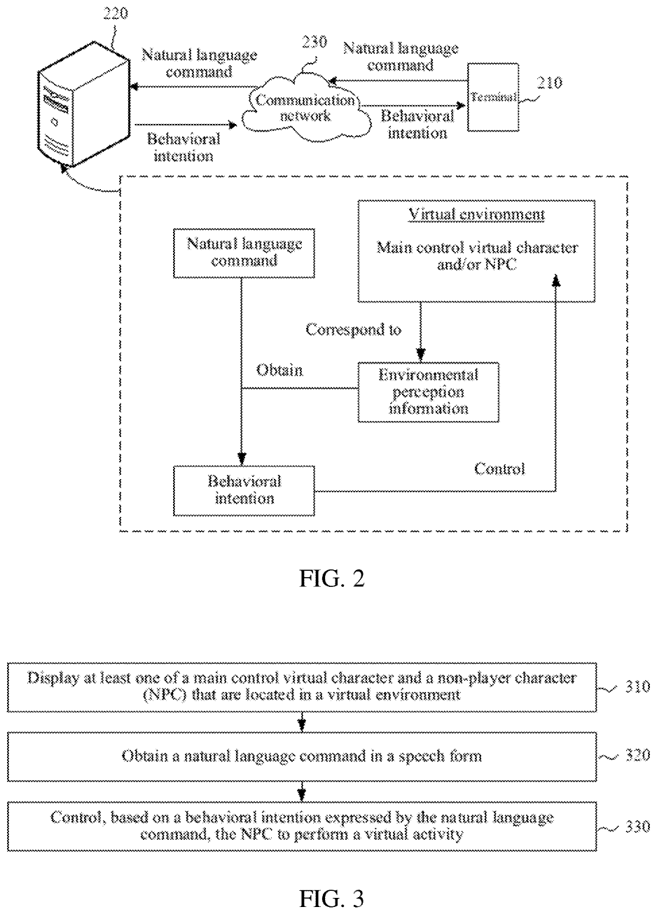

For example, as shown in FIG. 2, the control system includes a terminal 210 and a server 220. The terminal 210 is connected to the server 220 through a communication network 230.

In some implementations, a game application is installed on the terminal 210. During running of the game application, at least one of a main control virtual character and an NPC that are located in a virtual environment is displayed. The NPC includes at least one of a plurality of virtual characters such as a virtual soldier, a virtual hero, a virtual monster, and a virtual mount. A player may perform a speech control process on the NPC in a speech control mode.

In some implementations, for example, the player commands the NPC in a speech form. A microphone array is deployed on the terminal 210, and may obtain a natural language command in a speech form. The natural language command includes natural semantics for controlling the NPC.

In some implementations, the terminal 210 autonomously performs analysis based on the natural language command. Alternatively, the terminal 210 transmits the natural language command to the server 220 through the communication network 230, and the server 220 analyzes the natural language command.

In some implementations, an example in which the terminal 210 transmits the natural language command to the server 220 and the server 220 analyzes the natural language command is used for description.

The server 220 determines environmental perception information based on information perceived by at least one of the main control virtual character and the NPC for the virtual environment, and then recognizes a behavioral intention from the natural language command based on the environmental perception information, and transmits the behavioral intention to the terminal 210 through the communication network 230.

In some implementations, the terminal 210 controls, based on the behavioral intention expressed by the natural language command, the NPC to perform a virtual activity; and the terminal 210 renders and displays, on a screen interface, an activity animation corresponding to activity animation data.

The terminal includes, but is not limited to, a mobile terminal such as a mobile phone, a tablet computer, a portable laptop computer, an intelligent voice interaction device, an intelligent home appliance, or an in-vehicle terminal; or may be implemented as a desktop computer or the like. The server may be an independent physical server, or may be a server cluster including a plurality of physical servers or a distributed system, or may be a cloud server.

The virtual character control method provided in this disclosure is described with reference to the brief descriptions of terms and application scenarios described above. An example in which the method is applied to a terminal is used for description. As shown in FIG. 3, the method includes operation 310 to operation 330 below.

Operation 310: Display at least one of a main control virtual character and an NPC that are located in a virtual environment.

In some implementations, the virtual environment is a virtual scene displayed when an application runs on the terminal, or the virtual environment is a virtual scene displayed through projection. The virtual environment may be a simulated scene of a real scene, a semi-simulated and semi-fictional scene, or a purely fictional scene. The virtual environment may be any one of a two-dimensional virtual scene, a 2.5-dimensional virtual scene, and a three-dimensional virtual scene.

For example, the main control virtual character is a virtual character manually controlled by a player, for example, a virtual hero or a virtual mount. The NPC is a virtual character displayed in a game, or the NPC is a virtual character displayed in another virtual environment such as a VR scene or an AR scene. The NPC has autonomous mobility, and can autonomously move in the virtual environment.

In some implementations, the NPC is a virtual character that may be controlled by the player. When the NPC is not controlled by the player, the NPC moves in the virtual environment based on a preset trajectory, or the NPC attacks an enemy virtual character, assists the main control virtual character in performing a game task, or the like in the virtual environment based on preset game logic. When the NPC is controlled by the player, the NPC specially performs a virtual activity in the virtual environment according to a command, to assist the main control virtual character in a more targeted manner.

Usually, a virtual battle includes a main control virtual character and at least one NPC. There is a particular difference between the main control virtual character and the NPC.

In some implementations, the main control virtual character is a virtual character mainly controlled by the player, and the NPC is a virtual character selectively commanded by the player; or the main control virtual character is a virtual character autonomously selected by the player, and the NPC is a virtual character configured by a system by default; or both the main control virtual character and the NPC are virtual characters autonomously selected by the player, where the main control virtual character is a virtual character with a highest priority, and the NPC is a virtual character with a lower priority.

For example, when the NPC is a virtual character autonomously selected by the player, a plurality of candidate control characters with different personalities and/or autonomous behavioral capabilities may be provided. The personalities can represent attack strength of the candidate control characters in a virtual battle (for example, a candidate control character with a violent personality has higher attack strength, and a candidate control character with a mild personality has lower attack strength). The autonomous behavioral capabilities represent skill statuses of the candidate control characters in a virtual battle. For example, a candidate control character 1 can launch a skill A to attack an enemy virtual character in a circular area, and a candidate control character 2 can launch a skill B to defend against an attack from an enemy virtual character nearby. The player performs a character selection operation on the plurality of candidate control characters, to use at least one candidate control character as an NPC or the like that may be commanded in a game.

Operation 320: Obtain a natural language command in a speech form.

The speech form is a form of expression by using voice or sound. To be specific, information or an intention is transferred by using voice or sound. In the field of computer science, especially in human-computer interaction and natural language processing (NLP), the speech form is usually a manner of inputting information by an object in spoken language.

For example, the natural language command, as a command in the speech form, is usually implemented as audio data. For example, the player utters speech when operating the terminal, and the terminal automatically captures the speech based on a deployed microphone array and obtains audio data as the natural language command in the speech form; or the player utters speech after performing a trigger operation on an audio capture control when operating the terminal, and the terminal receives the speech and obtains audio data as the natural language command in the speech form.

The natural language command includes natural semantics for controlling the NPC.

For example, the natural semantics are semantic information expressed by the natural language command for controlling the NPC, and the NPC may be specifically controlled, based on the natural semantics, to perform a virtual activity.

In some implementations, the natural semantics include identification semantics for indicating the NPC and intention semantics for indicating an NPC activity. For example, the identification semantics include at least one of a name (for example, “hero A”) of the NPC, a label (for example, “No. 1”) of the NPC, and location information (for example, “beside the house”) of the NPC.

In some implementations, the NPC is a virtual character commanded by the player through speech, and includes at least one of a plurality of types of virtual characters such as a virtual soldier, a virtual hero, a virtual monster, and a virtual mount. Based on the natural language command in the speech form that is initiated by the player during the game, the NPC in the virtual environment may be commanded to perform an activity according to the natural language command.

In some implementations, a process of commanding the NPC is a process of unlocking a game account after the game account reaches a preset level, and the game account is an account that the player has logged in to. For example, the preset level is a level 10. When the game account does not reach the preset level, the NPC is an uncontrollable virtual character, that is, the player cannot command the NPC through speech. When the game account reaches the preset level, the NPC changes to a virtual character controllable by the player, that is, the player may currently command the NPC through speech.

Operation 330: Control, based on a behavioral intention expressed by the natural language command, the NPC to perform a virtual activity.

For example, the behavioral intention is an operation intention or a purpose expressed by the natural language command. Accurately understanding the behavioral intention helps control the NPC to specially perform the virtual activity.

The behavioral intention is recognized from the natural language command based on environmental perception information. The environmental perception information includes information obtained by perceiving the virtual environment by at least one of the main control virtual character and the NPC.

For example, because the natural language command is speech information received during displaying of the virtual environment, the natural language command may be comprehensively analyzed in association with the virtual environment during analysis of the natural language command.

In some implementations, the environmental perception information is obtained based on information perceived by at least one of the main control virtual character and the NPC for the virtual environment. For example, the environmental perception information is obtained based on information perceived by the main control virtual character for the virtual environment; or the environmental perception information is obtained based on information perceived by the NPC for the virtual environment; or the environmental perception information is obtained based on information perceived by both the main control virtual character and the NPC for the virtual environment.

In some implementations, the environmental perception information is configured to represent environmental information perceived and obtained by the main control virtual character and/or the NPC in an object perception range, and the object perception range is a three-dimensional space range in which the main control virtual character and/or the NPC have/has perception for another scene element.

In some implementations, the environmental perception information includes a virtual element determined by transmitting a ray, and may further include area structure information determined by analyzing a geometric structure and layout information of the virtual environment, and the like.

For example, the virtual environment further includes a plurality of virtual elements. During determining of the environmental perception information, a virtual element perceived by the main control virtual character and/or the NPC in the virtual environment is determined as the environmental perception information. Alternatively, during determining of the environmental perception information, an object perception range of the main control virtual character and/or the NPC in the virtual environment is determined, and a virtual element in the object perception range is used as the environmental perception information.

In some implementations, intention recognition is performed on the natural language command under a constraint of the environmental perception information to obtain the behavioral intention, and the NPC is controlled, based on the behavioral intention, to perform the virtual activity.

For example, because the environmental perception information is information obtained based on the main control virtual character and/or the NPC, the information is closely related not only to the virtual environment, but also to the main control virtual character and/or the NPC in the virtual environment. A process of analyzing the natural language command is constrained by the environmental perception information. This helps precisely obtain intention information expressed by the natural language command.

In some implementations, a behavioral intention recognition process is performed by a pre-trained machine learning model. The environmental perception information and the natural language command are used as inputs of the machine learning model, and the machine learning model performs an encoding process and a decoding process to output the behavioral intention.

For example, the machine learning model includes at least one of a plurality of networks such as a recurrent neural network (RNN), a long short-term memory (LSTM), a gated recurrent unit (GRU), and a convolutional neural network (CNN). This is not limited herein.

To sum up, the environmental perception information of the main control virtual character and/or the NPC helps better understand the natural language command, to improve accuracy of analyzing the natural language command, and further improve precision of the recognized behavioral intention, so that the behavioral intention better matches the virtual environment. This greatly avoids ineffective command or incorrect command on the NPC, helps reduce a misoperation rate of the player, helps the player reduce a quantity of operations during a virtual battle to some extent, reduces an amount of operation-related data to be processed, and improves utilization of computing resources and efficiency of human-computer interaction.

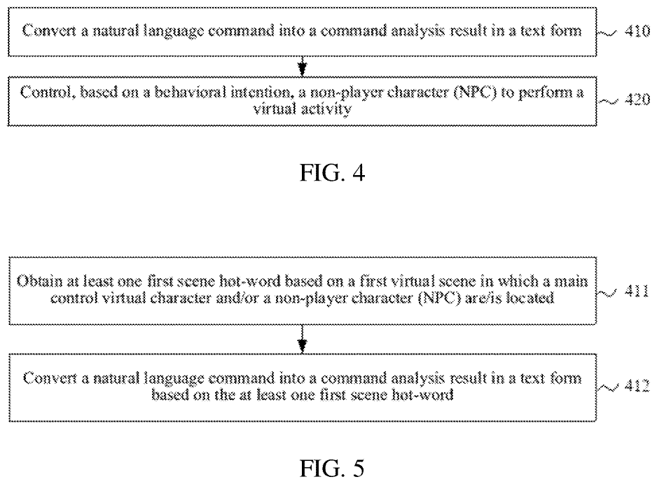

In an example, an example in which the virtual character control method is performed by a terminal is used for description. The terminal performs speech-to-text conversion on a natural language command to obtain a command analysis result in a text form, and the command analysis result may be displayed on a terminal interface. Behavioral intention recognition is performed based on the command analysis result in the text form to obtain a behavioral intention and control an NPC to perform a virtual activity. For example, as shown in FIG. 4, operation 330 shown in FIG. 3 may be further implemented as operation 410 to operation 420 below.

Operation 410: Convert the natural language command into the command analysis result in the text form.

For example, the terminal receives the natural language command in the speech form, and first converts the natural language command in the speech form into the command analysis result in the text form through a speech-to-text conversion technology.

The command analysis result is a result obtained by performing speech-to-text conversion on the natural language command based on the environmental perception information.

For example, during speech-to-text conversion on the natural language command, the natural language command is converted into the text form under the constraint of the environmental perception information of the main control virtual character and/or the NPC, to obtain the command analysis result.

The command analysis result is configured to perform behavior recognition to obtain the behavioral intention.

For example, the terminal performs a behavioral intention recognition process based on the command analysis result in the text form. The text form is more intuitive and clearer than the speech form, facilitating accuracy of behavioral intention recognition.

The behavioral intention is intention information expressed by the command analysis result. For example, the command analysis result is “No. 1, move to the location A”, and it is determined, based on behavioral intention recognition, that the behavioral intention is “No. 1” and “move to the location A”. That is, intention information for specially controlling the NPC to perform the virtual activity is obtained from the command analysis result through behavioral intention recognition.

In an exemplary embodiment, as shown in FIG. 5, operation 410 may be implemented as operation 411 and operation 412 below.

Operation 411: Obtain at least one first scene hot-word based on a first virtual scene in which the main control virtual character and/or the NPC are/is located.

The at least one first scene hot-word is a scene-associated word of the first virtual scene. To be specific, there is an association relationship between the first scene hot-word and the first virtual scene, and the first scene hot-word is a word for describing the first virtual scene.

In some implementations, the first scene hot-word includes a scene status of the first virtual scene. For example, the first virtual scene is a virtual restaurant, and the first scene hot-word includes an open state, a break state, a closed state, or the like.

In some implementations, the first scene hot-word includes an element name of a virtual element in the first virtual scene. For example, the first virtual scene is a virtual restaurant, and the first scene hot-word includes a virtual table, a virtual chair, virtual kitchenware, a virtual plate, or the like.

In some implementations, the first scene hot-word includes an interaction word for interaction between virtual elements in the first virtual scene. For example, the first virtual scene is a virtual battlefield, and the first scene hot-word includes attacking, attacking a virtual character, defense, building a barrier, or the like.

In some implementations, after the natural language command is received, the at least one first scene hot-word is collected based on the first virtual scene; or after the natural language command is received, the at least one first scene hot-word corresponding to the first virtual scene is selected from a plurality of pre-obtained scene hot-words based on the first virtual scene; or the like.

In an example, a first scene type corresponding to the first virtual scene in which the main control virtual character and/or the NPC are/is located is obtained.

For example, the first scene type is a scene type corresponding to the first virtual scene. The scene type is configured to represent a scene status of a virtual scene. For example, the scene type includes a plurality of types that describe a scene status, such as an office type, a battle type, a kitchen type, a bedroom type, a classroom type, a store type, and a factory type.

In some implementations, the first virtual scene corresponds to the first scene type, and the first scene type is configured to describe a scene status represented by the first virtual scene. For example, if the first virtual scene is a virtual office, the first scene type is the office type; or if the first virtual scene is a virtual battle area, the first scene type is the battle type; or if the first virtual scene is a virtual store, and the first scene type is the store type.

In an example, a hot-word set corresponding to the first scene type is obtained, at least one word in the hot-word set is used as the at least one first scene hot-word, and the hot-word set is a set of scene-associated words collected based on the first scene type.

For example, the plurality of scene types each correspond to a hot-word set. The hot-word set represents a set of scene-associated words collected based on the scene type, and also represents a set of scene-associated words collected based on at least one virtual scene of the scene type.

For example, the office type corresponds to a hot-word set 1, and the hot-word set 1includes a plurality of scene-associated words collected based on at least one virtual office scene of the office type. For example, the hot-word set 1 includes a scene-associated word collected based on a virtual office 1 and a scene-associated word collected based on a virtual office 2, and the virtual office 1 and the virtual office 2 are two virtual offices of the office type.

For example, the battle type corresponds to a hot-word set 2, and the hot-word set 2 includes a plurality of scene-associated words collected based on at least one virtual battle scene of the battle type. For example, the hot-word set 2 includes a scene-associated word collected based on a virtual battle scene 1 and a scene-associated word collected based on a virtual battle scene 2, and the virtual battle scene 1 and the virtual battle scene 2 are two virtual battle scenes of the battle type.

In some implementations, the hot-word set corresponding to the first scene type is obtained after the first scene type corresponding to the first virtual scene is determined. The hot-word set is a set of scene-associated words collected based on the first scene type. To be specific, the hot-word set corresponding to the first scene type is a set of scene-associated words collected based on the first scene type. For example, the first scene type of the first virtual scene is the battle type, and the hot-word set 2 corresponding to the battle type is used as the hot-word set corresponding to the first scene type.

In some implementations, words in the hot-word set are referred to as scene-associated words, or referred to as hot-words, or referred to as words. After the hot-word set corresponding to the first scene type is obtained, the words in the hot-word set are used as the at least one first scene hot-word. To be specific, when the at least one first scene hot-word is obtained based on the first virtual scene, the plurality of words in the hot-word set corresponding to the first scene type to which the first virtual scene belongs are used as the at least one first scene hot-word corresponding to the first virtual scene.

For example, the first virtual scene is a virtual kitchen 1, it is determined that a scene type corresponding to the virtual kitchen 1 is the kitchen type, a hot-word set corresponding to the kitchen type is obtained, and words in the hot-word set are used as the at least one first scene hot-word. The hot-word set corresponding to the kitchen type not only includes a word obtained based on the virtual kitchen 1, but also includes a word obtained based on a virtual kitchen 2. Therefore, the at least one first scene hot-word obtained in this manner is more extensive.

In an example, an object perception range of the main control virtual character and/or the NPC in the first virtual scene is obtained.

In some implementations, an object perception range of the main control virtual character in the first virtual scene is obtained; or an object perception range of the NPC in the first virtual scene is obtained; or an object perception range of the main control virtual character in the first virtual scene and an object perception range of the NPC in the first virtual scene are obtained.

The object perception range is a three-dimensional space range in which the main control virtual character and/or the NPC have/has perception for another scene element.

For example, the main control virtual character and the NPC are virtual characters in the first virtual scene, and may be considered as virtual elements in the first virtual scene. The first virtual scene may further include a scene element other than the main control virtual character and the NPC. Object perception of the main control virtual character and/or the NPC represents perception of the main control virtual character and/or the NPC for another scene element. The object perception range is a range of object perception, and is implemented as a three-dimensional space range in the first virtual scene.

In some embodiments, the object perception range includes at least one of the following:

(1) Visual perception range of the main control virtual character and/or the NPC

This is typically configured to describe a size of an area that a living body or a technical device can visually cover or perceive. The visual perception range of the main control virtual character and/or the NPC is a three-dimensional space range perceived through observation by the main control virtual character and/or the NPC with the main control virtual character and/or the NPC as an observer.

In some implementations, the visual perception range is obtained based on a location and a visual observation capability of the main control virtual character and/or the NPC in the first virtual scene.

For example, the location is configured to represent location information of the main control virtual character and/or the NPC relative to the first virtual scene, and is represented by, for example, location coordinates. The visual observation capability is configured to represent a capability of the main control virtual character and/or the NPC to observe the first virtual scene. For example, the visual observation capability includes a visual distance (to be specific, a longest distance that can be observed and perceived) and a visual angle (to be specific, an angle range that can be observed and perceived). The visual perception range of the main control virtual character and/or the NPC may be approximately determined from the first virtual scene based on the location and the visual observation capability.

In some implementations, when the object perception range includes the visual perception range, a preset frustum is generated as the visual perception range by using the location of the main control virtual character and/or the NPC as a start point and using a rotation of the main control virtual character and/or the NPC as a center line of the frustum.

The preset frustum is a three-dimensional area for measuring the visual perception range.

For example, when the object perception range includes the visual perception range, the location of the main control virtual character and/or the NPC and the rotation of the main control virtual character and/or the NPC are determined, and with the location as the start point and the rotation as the center line of the frustum, the preset frustum is used as the visual perception range determined based on the visual perception capability.

In some implementations, the preset frustum is a tetrahedron; or the preset frustum is a three-dimensional truncated pyramid (for example, the preset frustum is obtained by cutting a small tetrahedron from a large tetrahedron); or the preset frustum is in a cone shape; or the preset frustum is in a shape of a polygonal truncated pyramid or the like.

The foregoing content describes content in which the visual perception range is the preset frustum determined based on the location and the rotation of the main control virtual character and/or the NPC. The preset frustum is generated as the visual perception range based on a current location and rotation of the main control virtual character and/or the NPC, so that FOV perception of a virtual character can be can accurately simulated, to ensure a capability of the virtual character to perceive the virtual environment. A rotation and a location of the virtual character are considered during determining of the preset frustum, so that a visual perception range of the virtual character can be dynamically defined, to simulate visual behavior of a human or an animal in the physical world, and make behavior of the virtual character in a virtual scene better conform to practical logic. Especially in a complex environment, the virtual character can recognize a potential threat through visual perception and perform corresponding behavior adjustment. Therefore, the manner in which the preset frustum is the visual perception range greatly enhances immersion of the virtual environment, ensures operation experience of the player, and also helps provide more intelligent, flexible, and practical virtual character behavior control, to improve utilization of computing resources and efficiency of human-computer interaction.

(2) Auditory perception range of the main control virtual character and/or the NPC

For example, the auditory perception range is a space range that can be audibly perceived or understood by a listener, and is usually configured for describing a size of a range of sound that a living body or a technical device can audibly cover or perceive. The auditory perception range of the main control virtual character and/or the NPC is a three-dimensional space range perceived based on an auditory perception capability of the main control virtual character and/or the NPC with the main control virtual character and/or the NPC as a listener.

In some implementations, the auditory perception range is obtained based on a location and an auditory perception capability of the main control virtual character and/or the NPC in the first virtual scene.

For example, the location is configured to represent location information of the main control virtual character and/or the NPC relative to the first virtual scene, and is represented by, for example, location coordinates. The auditory perception capability is configured to represent a capability of the main control virtual character and/or the NPC to perceive a sound change in the first virtual scene. For example, the auditory perception capability includes a hearing distance (to be specific, a longest distance at which sound can be heard), a hearing angle (to be specific, a coverage angle range in which a direction of a sound source can be determined or sound can be heard), and a frequency range (to be specific, a sound frequency range that can be perceived). The auditory perception range of the main control virtual character and/or the NPC may be approximately determined from the first virtual scene based on the location and the auditory perception capability.

(3) Olfactory perception range of the main control virtual character and/or the NPC

For example, the olfactory perception range is a space range in which a smell is olfactorily perceived or recognized. The olfactory perception range of the main control virtual character and/or the NPC is a three-dimensional space range that can be olfactorily perceived by the main control virtual character and/or the NPC.

In some implementations, the olfactory perception range is obtained based on a location and an olfactory perception capability of the main control virtual character and/or the NPC in the first virtual scene.

For example, the location is configured to represent location information of the main control virtual character and/or the NPC relative to the first virtual scene, and is represented by, for example, location coordinates. The olfactory perception range is configured to represent a capability of the main control virtual character and/or the NPC to perceive a smell change in the first virtual scene. For example, the olfactory perception range includes olfactory sensitivity (to be specific, different degrees of response can be provided for an odor molecule) and an olfactory perception distance (indirectly representing a distance between a source of a smell and the main control virtual character and/or the NPC). The olfactory perception range of the main control virtual character and/or the NPC may be approximately determined from the first virtual scene based on the location and the olfactory perception capability.

(4) Range perceived by a perceptual skill or a perceptual item that is owned by the main control virtual character and/or the NPC

For example, the perceptual skill is a capability of the main control virtual character and/or the NPC to perform scene perception on the first virtual scene, and the perceptual skill includes at least one of a perception obtaining form and a perception enhancement form.

In some implementations, the perception obtaining form is configured to represent a process of obtaining a non-owned perceptual skill. After the perceptual skill is obtained in the perception obtaining form, the main control virtual character and/or the NPC may perform targeted scene perception on the first virtual scene using the perceptual skill. The perception enhancement form is configured to represent a process of enhancing a perception capability by owning a perceptual skill when the perception capability is owned.

For example, the perceptual item is a virtual item for perceiving the first virtual scene, and the perceptual item includes at least one of a perception obtaining form and a perception enhancement form. For example, a perceptual item in the perception obtaining form is a first perceptual item, and a perceptual item in the perception enhancement form is a second perceptual item.

In some implementations, the main control virtual character and/or the NPC may obtain the perceptual item based on a process of completing a specific game task or reaching a specific game level. In some implementations, different perceptual skills or perceptual items each correspond to a preset effective range representing a range that can be perceived when the perceptual skill or the perceptual item is applied. In this case, the preset effective range represents the object perception range.

The foregoing content describes exemplary implementations of the object perception range. For example, the visual perception range, the auditory perception range, and the olfactory perception range are real perception capabilities simulated for the main control virtual character and/or the NPC. Diversified perception means help comprehensively understand and respond to a dynamic change in the virtual environment, to improve naturalness and immersion of interaction in the virtual environment. In addition, the main control virtual character and/or the NPC may further extend a perception capability of the main control virtual character and/or the NPC to a field outside conventional senses based on the perceptual skill or the perceptual item. Setting diversified perception modes can further improve an intelligent response capability of a virtual character, to make behavior of the virtual character in a complex scene more flexible and more consistent with actual operation logic. Therefore, a variety of object perception ranges not only enhance adaptability of a virtual character to the virtual environment, but also improve a depth of interaction between the player and the virtual environment, to improve efficiency of human-computer interaction.

In some implementations, the object perception range is determined based on a first location of the main control virtual character in the first virtual scene.

In some implementations, the object perception range is determined based on a second location of the NPC in the first virtual scene.

In some implementations, when the main control virtual character and the NPC are in a same first virtual scene, a first object perception range of the main control virtual character in the first virtual scene is obtained, a second object perception range of the NPC in the first virtual scene is obtained, and both the first object perception range and the second object perception range are used as the object perception range.

The foregoing object perception ranges are merely examples. This is not limited in examples of this disclosure.

In an example, the at least one first scene hot-word is obtained based on environmental perception information in the object perception range.

For example, the environmental perception information is configured to indicate environmental information perceived and obtained by the main control virtual character and/or the NPC in the object perception range. In some implementations, the environmental perception information includes a virtual element determined by transmitting a ray, and may further include area structure information determined by analyzing a geometric structure and layout information of the virtual environment, and the like.

For example, after the object perception range is determined, the at least one first scene hot-word representing a status of the main control virtual character and/or the NPC is obtained based on a range of the object perception range in the first virtual scene and the environmental perception information that is determined by the main control virtual character and/or the NPC in the object perception range based on perception.

In an example, the environmental perception information includes a virtual element, and a virtual element within the object perception range in the first virtual scene is determined.

For example, the object perception range is a part of a three-dimensional space range in the first virtual scene. The first virtual scene includes a large quantity of virtual elements. The virtual elements are elements constituting a virtual scene. For example, the virtual elements include a virtual ground, a virtual building, a virtual tree, a virtual character, and a virtual stone.

In some embodiments, when the object perception range is determined, the virtual element within the object perception range is determined from a plurality of virtual elements corresponding to the first virtual scene.

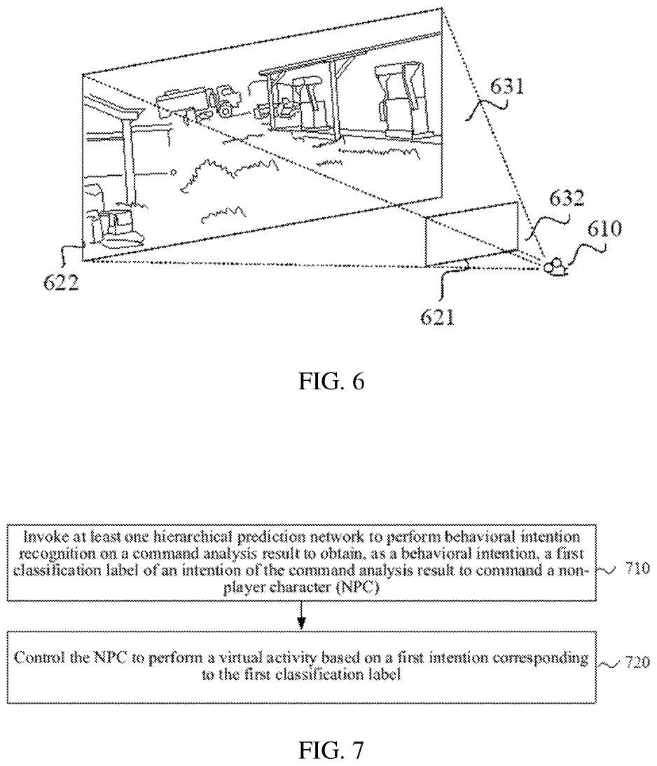

For example, as shown in FIG. 6, the visual perception range is the object perception range. If the first virtual scene in which the main control virtual character is located is displayed at a first-person perspective of the main control virtual character, a frustum shown in FIG. 6 may be determined as the visual perception range based on a location and a rotation of the main control virtual object.

In some implementations, the location and the rotation of the main control virtual object are represented based on a location and a rotation of a virtual camera 610, and a tetrahedral frustum shown in FIG. 6 is obtained as the object perception range by using the location of the virtual camera 610 as a start point and using the rotation of the virtual camera as a center line of the frustum.

Alternatively, two limiting planes during camera rendering are preset: a near clipping plane 621 and a far clipping plane 622 in FIG. 6. The near clipping plane 621 and the far clipping plane 622 are parallel to an XY plane of the virtual camera, and are spaced apart by a specific distance along a center line. Any virtual element closer to the virtual camera than the near clipping plane 621 and any virtual element farther away from the virtual camera than the far clipping plane 622 are not to be rendered. To be specific, a small tetrahedron 632 is cut from a large tetrahedron 631 shown in FIG. 6, and an obtained three-dimensional truncated pyramid is used as a frustum.

For example, a distance between the far clipping plane 622 and the virtual camera 610 is a longest distance observed by the main control virtual object. The frustum is used as the object perception range. The object perception range includes a plurality of virtual elements such as virtual grass, a virtual building, and a virtual car in a three-dimensional scene. To be specific, the virtual elements such as the virtual car, the virtual grass, and the virtual building are used as virtual elements within the object perception range. As shown in FIG. 6, a plurality of virtual elements are illustrated by using an example in which the plurality of virtual elements are displayed on the far clipping plane 622 through projection. Actually, the plurality of virtual elements may be dispersedly displayed at a plurality of locations within the visual perception range (for example, within a three-dimensional truncated pyramid enclosed by the near clipping plane 621 and the far clipping plane 622).

In some implementations, if the visual perception range used as the object perception range is determined from a third-person perspective, a virtual camera is located in an area outside the main control virtual character, and not only can observe a plurality of virtual elements, but also can observe the main control virtual character moving in the virtual environment. In this case, if the visual perception range is to be determined, a range captured by the virtual camera may be used as the visual perception range (the virtual camera moves with the main control virtual character, and the visual perception range is still related to the main control virtual character), or a frustum determined based on a location and a rotation of the main control virtual character is used as the visual perception range (as shown in FIG. 6, for example, an observation angle-of-view of the main control virtual character is consistent with an observation angle-of-view of the virtual camera 610). A process of determining the visual perception range is not limited herein.

In some implementations, the virtual element within the object perception range in the first virtual scene is highlighted.

In some implementations, after the virtual element within the object perception range is determined from the first virtual scene, the virtual element within the object perception range is highlighted, to differently display different virtual elements within and outside the object perception range. This further helps notify the player of statuses of virtual elements related to analysis of the natural language command.

In an example, an element name of the virtual element is used as the first scene hot-word, or an action name of an interactive action corresponding to the virtual element is used as the first scene hot-word.

For example, the virtual element corresponds to the element name. The element name is configured to represent the virtual element, and there may be one or more element names. To be specific, all of a plurality of element names may represent or indicate the virtual element, or the like. For example, an element name of a virtual element 621 is a truck or a car, and an element name of a virtual element 622 is little grass, grass, or the like.

In some implementations, after the virtual element within the object perception range is determined, element names of virtual elements are summarized, and all of a plurality of element names are used as first scene hot-words corresponding to the first virtual scene, to obtain the at least one first scene hot-word.

For example, during the game, the player may command the main control virtual character or the NPC to perform an interaction process with a virtual element, that is, there is an interactive action for implementing the interaction process, and an action name of the interactive action is used as the first scene hot-word.

For example, the element name of the virtual element 621 is the truck or the car, and the player may control the main control virtual character or command the NPC to perform an interaction process with the virtual element 621, for example, riding, drop-off, hitting the truck, or climbing the truck, which is the action name of the interactive action. Alternatively, the element name of the virtual element 622 is the little grass or the grass, and the player may control the main control virtual character or command the NPC to perform an interaction process with the virtual element 622, for example, hiding in the grass, mowing the grass, or stepping on the grass, which is the action name of the interactive action.

In some implementations, action names of interactive actions that may be performed with virtual elements are summarized, and at least one action name corresponding to each of a plurality of virtual elements is used as the first scene hot-word corresponding to the first virtual scene, to obtain the at least one first scene hot-word.

In some implementations, the first scene hot-word corresponding to the virtual element is highlighted beside the virtual element.

For example, after first scene hot-words respectively corresponding to a plurality of virtual elements are determined, the first scene hot-words associated with the plurality of virtual elements may be displayed around the virtual elements on an interface. For example, a text word “stable” is displayed around a virtual element “stable”, and text words “attack him” are displayed around a virtual element “enemy virtual character”.

The foregoing content describes a method for highlighting the virtual element within the object perception range and then using the element name or the action name as the first scene hot-word. The process can significantly enhance intelligent interaction experience in the virtual environment, and highlighting a virtual element helps a virtual character quickly recognize and focus on a key element related to a current task or scene, to reduce complexity of information processing and improve decision efficiency. In addition, using the element name of the virtual element or the action name of the interactive action thereof as the first scene hot-word helps subsequently generate a stronger association through operation behavior between the natural language command and the virtual character, so that the virtual character can flexibly cope with a natural language command change or even a scene change of the player, to provide more precise feedback and response. The process also makes a behavioral association between a virtual element and a virtual character in a virtual scene closer, and greatly enhances reality and smoothness of interaction, so that the virtual character more flexibly, naturally, and accurately performs a virtual activity in a constantly changing virtual environment, to ensure efficiency of human-computer interaction.

In an example, a first scene type corresponding to the first virtual scene is obtained, and a hot-word set corresponding to the first scene type is obtained.

For example, the first scene type is a scene type corresponding to the first virtual scene. The scene type is configured to represent a scene status of a virtual scene. For example, the scene type includes a plurality of types that describe a scene status, such as an office type, a battle type, a kitchen type, a bedroom type, a classroom type, a store type, and a factory type.

For example, the plurality of scene types each correspond to a hot-word set. The hot-word set represents a set of scene-associated words collected based on the scene type, and also represents a set of scene-associated words collected based on at least one virtual scene of the scene type.

In some implementations, the hot-word set corresponding to the first scene type is obtained after the first scene type corresponding to the first virtual scene is determined. The hot-word set is a set of scene-associated words collected based on the first scene type. For example, the first scene type of the first virtual scene is the battle type, and the hot-word set 2 corresponding to the battle type is used as the hot-word set corresponding to the first scene type.

In an example, an object perception range of the main control virtual character and/or the NPC in the first virtual scene is obtained.

For example, the main control virtual character and/or the NPC includes at least one of the main control virtual character and the NPC. When the object perception range is obtained based on the main control virtual character and/or the NPC, if the main control virtual character and/or the NPC is the main control virtual character, an object perception range of the main control virtual character in the first virtual scene is obtained; if the main control virtual character and/or the NPC is the NPC, an object perception range of the NPC in the first virtual scene is obtained; or if the main control virtual character and/or the NPC is the main control virtual character and the NPC, an object perception range of the main control virtual character in the first virtual scene is obtained, and an object perception range of the NPC in the first virtual scene is obtained.

In some implementations, the object perception range includes at least one of a visual perception range, an auditory perception range, or an olfactory perception range of the main control virtual character and/or the NPC, and a range perceived by a perceptual skill or a perceptual item that is owned by the main control virtual character and/or the NPC.

In an example, at least one word is obtained from the hot-word set as the at least one first scene hot-word based on environmental perception information in the object perception range.

In some implementations, after the object perception range is determined, a virtual element within the object perception range is determined, and a word, in the hot-word set, that has an element association relationship with the virtual element is used as the at least one first scene hot-word.

For example, the element association relationship is configured to represent a relationship indicating a status of the virtual element. For example, a word including an element name of the virtual element is obtained from the hot-word set as the first scene hot-word, or a word for triggering the virtual element is obtained from the hot-word set as the first scene hot-word, or an interaction word for interacting with the virtual element is obtained from the hot-word set as the first scene hot-word.

The foregoing content describes content of determining the first scene hot-word based on at least one of the first scene type and the object perception range. The first scene type to which at least one of the main control virtual character and the NPC belongs and the corresponding hot-word set are obtained, so that a range of interaction content can be dynamically adjusted based on a scene feature and a character location, to accurately understand a key element and potential information in the first virtual scene, enable the virtual character to precisely recognize a high-frequency word related to the first virtual scene, improve an intelligent perception and interaction capability of the virtual environment, and enhance interaction experience of the virtual character. In addition, the environmental perception information is determined based on the object perception range, so that a key word that may affect behavior of the character in the virtual environment can be dynamically obtained and recognized based on an FOV and an interaction range of the virtual character, to further improve a capability of the virtual character to respond to the virtual environment and task execution efficiency based on the selected first scene hot-word. In addition, the first scene hot-word is selected comprehensively based on the hot-word set and the object perception range, so that hot-words can be selected in the first virtual scene in a more targeted manner, to improve an intelligence level of the virtual character in the virtual environment, and ensure result accuracy of the command analysis result subsequently obtained based on the first scene hot-word.

The foregoing are merely examples. This is not limited in examples of this disclosure.

In an example, a first virtual scene corresponding to a first virtual battle is determined based on the first virtual battle in which the main control virtual character and/or the NPC participate/participates. A plurality of virtual battles each correspond to a virtual scene, and the plurality of virtual battles are simulated battle environments provided for the main control virtual character and/or the NPC.

For example, in addition to determining the first virtual scene based on a location of the main control virtual character and/or the NPC in the virtual environment, a virtual scene corresponding to the first virtual battle may alternatively be used as the first virtual scene based on the first virtual battle in which the main control virtual character and/or the NPC participate/participates. For example, the virtual environment includes a plurality of virtual battles, and each virtual battle corresponds to a virtual scene (for example, a virtual battle 1 is a virtual snow scene, and a virtual battle 2 is a virtual forest scene). If a virtual battle in which the main control virtual character and/or the NPC participate/participates is the first virtual battle, the virtual scene corresponding to the first virtual battle is used as the first virtual scene (if both the main control virtual character and an enemy virtual character participate in the virtual battle 1 in the virtual environment, the virtual scene is used as the first virtual scene, or the like). Alternatively, a plurality of virtual battles is provided before the game starts, and each virtual battle corresponds to a virtual scene. If the player selects the main control virtual character to participate in the first virtual battle, the NPC participates in the first virtual battle together with the main control virtual character, and the virtual scene corresponding to the first virtual battle is used as the first virtual scene.

In some implementations, the virtual battle includes a plurality of forms such as a game task (for example, a task 1 corresponds to a virtual scene 1, and a task 2 corresponds to a virtual scene 2) and a game level (for example, a game level 1 corresponds to the virtual scene 1, and a game level 2 corresponds to the virtual scene 2). This is not limited herein.

In an example, a plurality of scene hot-words are obtained, and the plurality of scene hot-words correspond to at least two virtual scenes.

For example, scene hot-words respectively corresponding to a plurality of virtual scenes in the virtual environment are pre-obtained. In some implementations, at least one scene hot-word corresponding to each of the plurality of virtual scenes is obtained based on a virtual element in each virtual scene, and is stored to obtain the plurality of scene hot-words.

In some implementations, an element name of the virtual element in the virtual scene is obtained as the scene hot-word; or an action name of an interactive action for interacting with the virtual element in the virtual scene is obtained as the scene hot-word; or a state name for describing an element state of the virtual element in the virtual scene is obtained as the scene hot-word.

In an example, the at least one first scene hot-word corresponding to the first virtual scene is obtained from the plurality of scene hot-words based on the first virtual scene in which the main control virtual character and/or the NPC are/is located.

In some implementations, the plurality of scene hot-words correspond to scene identifiers, and the scene identifiers are configured to indicate virtual scenes in which scene hot-words are collected. For example, if a scene hot-word 1 and a scene hot-word 2 are obtained based on a virtual scene A, the scene hot-word 1 is marked with a scene identifier a corresponding to the virtual scene A, and the scene hot-word 2 is also marked with the scene identifier a; and if a scene hot-word 3 is obtained based on a virtual scene B, the scene hot-word 3 is marked with a scene identifier b corresponding to the virtual scene B.

In some implementations, a plurality of candidate scene hot-words with a first scene identifier are obtained from the plurality of scene hot-words based on the first virtual scene in which the main control virtual character and/or the NPC are/is located, and the first scene identifier is a scene identifier corresponding to the first virtual scene.

For example, after the first virtual scene in which the main control virtual character and/or the NPC are/is located is determined, the plurality of scene hot-words are respectively marked with scene identifiers. Therefore, scene hot-words marked with the first scene identifier may be selected from the plurality of scene hot-words as the candidate scene hot-words.

The foregoing describes content of obtaining the at least one first scene hot-word from the plurality of obtained scene hot-words based on the first virtual scene. The process can significantly improve dynamic adaptability of the virtual environment and improve interaction quality of a virtual character in the virtual environment. A key element or activity related to a current scene can be accurately recognized and positioned through association with a specific hot-word of each virtual scene. When the main control virtual character or the NPC is located in a specific virtual scene, a system can automatically select a hot-word most related to the scene from a plurality of preset scene hot-words, and further precisely adjust behavior or a conversation of a character, to ensure consistency between the behavior of the virtual character and the virtual scene. In addition, dynamically obtaining scene hot-words also helps adjust movement and response of the virtual character in real time based on a change in the virtual scene, to provide strong support for intelligent interaction in a complex virtual environment, and ensure accuracy of interaction and efficiency of human-computer interaction.

In some implementations, at least one candidate scene hot-word is selected from the plurality of candidate scene hot-words as the first scene hot-word based on the object perception range of the main control virtual character and/or the NPC in the first virtual scene.

For example, after the plurality of candidate scene hot-words are selected based on the first virtual scene, because the object perception range is a partial range in the first virtual scene, the plurality of candidate scene hot-words may be further filtered based on the object perception range, and at least one candidate scene hot-word related to the object perception range is selected as the first scene hot-word.

In some embodiments, a virtual element within the object perception range is determined as a perceptual virtual element. To be specific, the perceptual virtual element is a virtual element that can be perceived by the main control virtual character and/or the NPC in the first virtual scene. An element name of the perceptual virtual element is selected from the plurality of candidate scene hot-words as the first scene hot-word, or an action name of an interactive action corresponding to the perceptual virtual element is selected from the plurality of candidate scene hot-words as the first scene hot-word.

The foregoing describes content of further obtaining the first scene hot-word from the plurality of selected candidate scene hot-words comprehensively based on the first virtual scene and the object perception range. The scene identifiers are introduced to establish a clear association between each hot-word and a virtual scene, so that a related hot-word can be quickly recognized in the virtual environment based on the first scene identifier of the first virtual scene, to avoid confusion between virtual scenes and hot-words, ensure accuracy of selecting hot-words, and preliminarily ensure accuracy of interaction between a virtual character and the virtual environment. In addition, the candidate scene hot-words determined based on the first scene identifier are further filtered based on the object perception range of the character, and priorities of the hot-words may be dynamically adjusted, so that the virtual character can more effectively interact with a virtual element in a current virtual scene, to improve interaction flexibility of the virtual character and operation experience of the player, and fully utilize computing resources to achieve more accurate and complete interaction.

Operation 412: Convert the natural language command into the command analysis result in the text form based on the at least one first scene hot-word.

In an example, the first virtual scene is one of the plurality of virtual scenes in the virtual environment, and the virtual environment is a three-dimensional simulated environment of a virtual battle in which both the main control virtual character and the NPC participate.

For example, a plurality of virtual characters participating in a virtual battle are located in the virtual environment, the virtual environment includes the plurality of virtual scenes, and the plurality of virtual scenes constitute the virtual environment. For example, the virtual environment includes a virtual kitchen 1, a virtual kitchen 2, a virtual office, and a virtual battle scene.

In some implementations, the first virtual scene in which the main control virtual character and/or the NPC are/is located is determined from the plurality of virtual scenes based on the location of the main control virtual character and/or the NPC in the virtual environment.

In some implementations, a virtual scene in which the main control virtual character is located is determined from the plurality of virtual scenes as the first virtual scene; or a virtual scene in which the NPC is located is determined from the plurality of virtual scenes as the first virtual scene; or a virtual scene in which both the main control virtual character and the NPC are located is determined from the plurality of virtual scenes as the first virtual scene.

The foregoing content describes content of determining the first virtual scene from the plurality of virtual scenes of the virtual environment. Using the virtual scene in which the main control virtual object or the NPC is located as the first virtual scene can ensure uniqueness of the first virtual scene, to facilitate targeted analysis based on the first virtual scene. Using both the virtual scene in which the main control virtual object is located and the virtual scene in which the NPC is located as the first virtual scene can ensure comprehensiveness of determining the first virtual scene, to facilitate more comprehensive control on a virtual object based on the first virtual scene. Using the virtual scene in which both the main control virtual object and the NPC are located helps achieve flexibility of tactical strategies in the virtual environment, so that the main control virtual object and the NPC cooperate to generate more abundant operations.

In addition, a virtual scene in which a character is located is automatically recognized based on a location of the character, to implement precise environment adaptation and scene switching. When a virtual character moves to a corresponding scene, information about the scene in which the virtual character is located can be updated in real time, to ensure consistent interaction between the virtual character and the virtual environment. In addition, the dynamic scene selection mechanism also helps the virtual character perform proper decision-making and behavioral response based on characteristics of the scene in which the virtual character is located, to improve naturalness and logic of interaction. In addition, the process also helps avoid an abrupt feeling caused by scene switching, so that switching between virtual scenes is smoother and more natural, to improve operation experience of the player and make the virtual environment more dynamic and intelligent.

In some implementations, when the command analysis result is not obtained, in response to that the main control virtual character and/or the NPC move/moves from the first virtual scene to a second virtual scene, at least one second scene hot-word corresponding to the second virtual scene is obtained.

For example, the virtual environment includes the plurality of virtual scenes, and the second virtual scene is another virtual scene different from the first virtual scene. The location of the main control virtual character and/or the NPC, as virtual characters participating in the virtual battle, may change in the virtual environment, for example, may move from a location A to a location B. If the main control virtual character and/or the NPC move/moves from the first virtual scene to the second virtual scene when the natural language command is received but the command analysis result has not been obtained, a scene hot-word for constraining generation of the command analysis result needs to be determined based on the second virtual scene to which the main control virtual character and/or the NPC have/has recently moved.

For example, when the natural language command is received but the command analysis result has not been generated, if the main control virtual character and/or the NPC move/moves from the first virtual scene in which the main control virtual character and/or the NPC are/is currently located to the second virtual scene, in other words, if the location of the main control virtual character and/or the NPC moves from the first virtual scene to the second virtual scene, the at least one second scene hot-word corresponding to the second virtual scene is obtained, to more flexibly analyze a condition of the moved-to virtual scene.

In some implementations, the natural language command is converted into the command analysis result in the text form based on the at least one second scene hot-word.

For example, after the at least one second scene hot-word is obtained, the natural language command is converted into the command analysis result in the text form through a pre-trained natural language analysis model by using the at least one second scene hot-word as a constraint.

In some examples, the natural language command and the at least one second scene hot-word are used as inputs for the model, an instruction feature representation of the natural language command and a hot-word feature representation of the at least one second scene hot-word are extracted by using the natural language analysis model, the instruction feature representation and the hot-word feature representation are fused to obtain a fusion feature representation, and the command analysis result in the text form is outputted based on the fusion feature representation.

In an example, the pre-trained natural language analysis model is obtained.

The pre-trained natural language analysis model includes an acoustic network, a language network, and a preset dictionary, and the preset dictionary includes the at least one first scene hot-word, another scene hot-word, and a general word.

In some implementations, the natural language analysis model may also be referred to as a natural language analysis system. In this case, the acoustic network, the language network, and the preset dictionary in the natural language analysis model may also be referred to as an acoustic model, a language model, and a preset dictionary in the natural language analysis system. Names of the natural language analysis model and related networks are not limited herein.

For example, the acoustic network may also be referred to as an acoustic model, and is configured to process an input in a speech form to convert a sound signal into a potential speech unit, for example, a phoneme or a segment. The phoneme is a smallest speech unit in speech and is a phoneme in language. The phoneme is related to an acoustic feature of a pronunciation. The segment is a specific sound unit in an actual speech signal, describes a sound pronunciation in actual speech, and describes acoustic details (such as duration, a frequency, and sound intensity) of the pronunciation and the like. The natural language command in the speech form is analyzed through the acoustic network, and a possible speech unit sequence may be recognized based on an acoustic feature (such as a spectrum, a tone, and a speed) of the natural language command. The acoustic network may learn a mapping from an acoustic feature to a speech unit through a machine learning technology such as a deep neural network (DNN) or a recurrent neural network (RNN).

For example, the language network may also be referred to as a language model, and is configured to increase a probability score of a language unit sequence with a high probability during understanding of a text input. The language network predicts appropriateness and fluency of a given word string or speech unit sequence based on grammatical rules and statistical information of language. The language network includes an n-gram model, a recurrent neural network language model (RNNLM), a transformer model, or the like, and is configured to perform modeling and generating a text sequence.

For example, the preset dictionary includes words that may be encountered during speech recognition or text understanding and corresponding pronunciation or linguistic feature information. The preset dictionary provides a manner of mapping a text word to a pronunciation form or a linguistic feature of the text word. During speech recognition, the preset dictionary helps reduce possible pronunciation ambiguity, to improve recognition accuracy of the system.

The preset dictionary includes the at least one first scene hot-word, another scene hot-word, and a general word.

For example, the first scene hot-word is a scene hot-word corresponding to the first virtual scene, the another scene hot-word is a scene hot-word corresponding to a virtual scene other than the first virtual scene, and the general word is a word frequently used in daily life, for example, “we”, “I”, “here”, “there”, “big”, or “small”. The preset dictionary is a set of a plurality of pre-collected words, including the first scene hot-word and the another scene hot-word, and further including the commonly used general word.

In an exemplary embodiment, a plurality of speech units corresponding to the natural language command are obtained through the acoustic network.

The speech unit is a basic constituent unit of a word pronunciation.

In some implementations, the instruction feature representation is extracted.

For example, a feature extraction process is configured for dividing a continuous sound signal, namely, the natural language command, into a plurality of short time periods and calculating acoustic features such as a spectrum, a pitch, and a speed in the plurality of time periods, each time period corresponding to one acoustic feature. The instruction feature representation may represent an acoustic feature sequence obtained by arranging a plurality of acoustic features based on time periods, or may represent a feature representation obtained by fusing a plurality of acoustic features. This is not limited herein.

In some implementations, the instruction feature representation is analyzed through the acoustic network.

For example, the instruction feature representation represents a plurality of acoustic features. An objective of the acoustic network is to map a continuous acoustic feature sequence to a speech unit sequence, for example, a phoneme or a segment. The acoustic network learns to predict a possible speech unit (phoneme or segment) sequence under a given acoustic feature.

In some implementations, the acoustic network outputs one or more possible speech unit sequences. The speech unit sequence includes a plurality of speech units. Different speech unit sequences may have different speech units, or may have only different orders of speech units. A plurality of speech unit sequences represent speech unit arrangements that are considered most probable by the language network during understanding of the inputted natural language command.

In some implementations, in a process of analyzing the instruction feature representation through the acoustic network, a context analysis network is additionally introduced. The context analysis network is configured to analyze a context. This helps obtain a more reliable speech unit sequence by considering time sequence dependency between a plurality of acoustic features.

In an example, a sequence matching relationship between the plurality of speech units and a selected word in the preset dictionary is analyzed through the language network to obtain the command analysis result in the text form.

For example, the preset dictionary includes a plurality of words, and each word corresponds to at least one speech unit. After at least one speech unit sequence is obtained, matching may be performed between the at least one speech unit sequence and a word in the preset dictionary, to analyze at least one word represented by the speech unit sequence.

In some implementations, because the first scene hot-word is configured to constrain the command analysis result in a previous process of obtaining the at least one first scene hot-word based on the first virtual scene, during matching between a speech unit sequence and a word, at least the at least one first scene hot-word may be used as a selected word to be applied during matching with the preset dictionary. In addition, because some commonly used general words are also involved in speech recognition, the general words may also be used as selected words during word matching. To be specific, matching is performed between the at least one speech unit sequence and the first scene hot-word and the general words among the selected words, to analyze the at least one word represented by the speech unit sequence. The at least one word is more likely to include the first scene hot-word, to avoid interference from other scene hot-words. That is, the selected word includes at least the at least one first scene hot-word and the general words.

The foregoing describes content of obtaining the command analysis result through the pre-trained natural language analysis model. The acoustic network, the language network, and the preset dictionary in the natural language analysis model can help greatly improve understanding accuracy and response efficiency for a natural speech command in the virtual environment. The acoustic network extracts a basic pronunciation unit by analyzing the natural speech command, to accurately recognize a speech input of the player and provide high-quality speech data support for subsequent language processing. The language network implements in-depth semantic analysis through sequence matching between a speech unit and a word in the preset dictionary. The preset dictionary not only includes a hot-word related to a current virtual scene, but also includes general words, so that the natural speech command of the player can be recognized and understood in a broader context. The hierarchical analysis method enables the natural speech command to be parsed in a more fine-grained and intelligent manner. Therefore, more natural and smoother human-computer interaction experience can be provided for the fields of VR, intelligent assistants, and the like based on an NLP technology, to enhance immersion and operation convenience for a user.

In an example, the selected word further includes the another scene hot-word.

For example, if the selected word is the first scene hot-word and the general word, matching may be performed between the at least one speech unit sequence and the first scene hot-word and the general word; or if the selected word is the first scene hot-word, the another scene hot-word, and the general word, matching may be performed between the at least one speech unit sequence and the first scene hot-word, the another scene hot-word, and the general word.

A word in the preset dictionary includes an analysis weight. A first analysis weight of the at least one first scene hot-word is higher than a second analysis weight of the another scene hot-word. The analysis weight is a degree of attention paid to a word when the word participates in sequence matching.

For example, each word in the preset dictionary corresponds to an analysis weight. A larger analysis weight indicates a higher degree of attention paid to a word when the word participates in sequence matching, that is, attention is more likely to be paid to the word. A smaller analysis weight indicates a lower degree of attention paid to a word when the word participates in sequence matching, that is, attention is less likely to be paid to the word. Degrees of attention paid to different words during sequence matching may be adjusted based on analysis weights, so that a word with a larger analysis weight is preferentially used for matching against a word sequence, and a word with a larger analysis weight is more likely to be selected as a word constituting the command analysis result.

In some implementations, the at least one first scene hot-word is obtained based on the first virtual scene in which the main control virtual character and/or the NPC are/is located. The first scene hot-word can better indicate a status of the first virtual scene, and is more likely to have an association relationship with the natural language command. Therefore, the first analysis weight of the first scene hot-word is set to be higher than the second analysis weight of the another scene hot-word, so that attention is more likely to be paid to the first scene hot-word when words participate in sequence matching, and the first scene hot-word is also more likely to be selected as a word constituting the command analysis result.

In some implementations, the general word corresponds to a third analysis weight. The third analysis weight is less than the first analysis weight, and the third analysis weight is greater than the second analysis weight. Alternatively, the third analysis weight is equal to the first analysis weight, and the third analysis weight is greater than the second analysis weight. Alternatively, the third analysis weight is less than the first analysis weight, and the third analysis weight is equal to the second analysis weight. Alternatively, the third analysis weight is less than the first analysis weight, and the third analysis weight is less than the second analysis weight. A value of the third analysis weight is not limited herein.

The first analysis weight, the second analysis weight, and the third analysis weight are usually values ranging from a value 0 to a value 1. When it is ensured that the first analysis weight is greater than the second analysis weight, specific values of the analysis weights are not limited herein.

The foregoing describes content of paying more attention to the first scene hot-word during speech analysis in a manner in which the first analysis weight of the first scene hot-word is higher than the second analysis weight of the another scene hot-word. The mechanism of word analysis weights is introduced, so that an NLP model can more accurately process scene hot-words respectively corresponding to different virtual scenes, to improve an intelligent level of speech recognition and semantic understanding. Different analysis weights are assigned to words in the preset dictionary, so that a degree of attention paid to a word during sequence matching can be automatically adjusted based on importance of the word, to optimize a speech recognition process and reduce a possibility of mis-recognition. In addition, the process also enables the system to better cope with scene changes and diversity of user requirements, to ensure smoothness and naturalness of speech interaction, drive continuous development of an intelligent speech technology, and improve efficiency of human-computer interaction.

In an example, a matching relationship between the plurality of speech units and the selected word in the preset dictionary is analyzed to obtain a plurality of candidate word sequences.

For example, a process of analyzing the matching relationship represents a process of analyzing a status of matching between the selected word and the speech units. For example, each selected word corresponds to at least one speech unit, and a conversion probability of converting the speech unit into the selected word is determined by analyzing the plurality of speech units and the selected word. The conversion probability represents a probability of matching between the selected word and the speech unit. A higher conversion probability indicates that the speech unit is closer to the selected word, in other words, indicates a higher probability that the speech unit may express the selected word, and therefore indicates a stronger matching relationship between the selected word and the speech unit.

In some implementations, the plurality of speech units form at least one speech unit sequence, and at least one candidate word sequence respectively corresponding to the at least one speech unit sequence is determined based on a matching analysis process between the speech units and the selected word, to obtain the plurality of candidate word sequences.

For example, a speech unit sequence 1 and a speech unit sequence 2 are obtained by analyzing the natural language command based on a sound network. The speech unit sequence 1 is as follows: speech unit a—speech unit b—speech unit c. The speech unit sequence 2 is as follows: speech unit a—speech unit d—speech unit c. Therefore, it can be considered that the plurality of speech units include the speech unit a, the speech unit b, the speech unit c, and the speech unit d. After matching analysis is performed on the plurality of speech units and the selected word in the preset dictionary, a candidate word sequence obtained based on the speech unit sequence 1 includes a candidate word sequence 11 and a candidate word sequence 12, where the candidate word sequence 11 is “help me attack this place”, and the candidate word sequence 12 is “help me attack the enemy”; and a candidate word sequence obtained based on the speech unit sequence 2 includes a candidate word sequence 21 and a candidate word sequence 22, where the candidate word sequence 21 is “help me provide this place”, and the candidate word sequence 22 is “help me attack this enemy”. That is, a plurality of candidate word sequences are obtained, including the candidate word sequence 11, the candidate word sequence 12, the candidate word sequence 21, and the candidate word sequence 22.

The plurality of candidate word sequences include at least one of a plurality of selected words, and the candidate word sequence is a word sequence obtained based on a change relationship between the plurality of speech units.

For example, because the candidate word sequence is a word sequence obtained based on the selected word in the preset dictionary, a word in the candidate word sequence is a word in the selected word. The candidate word sequence may be a sequence obtained based on a single word, or may be a sequence obtained by combining a plurality of words. This is not limited herein.

Because the candidate word sequence is a sequence obtained through matching analysis between the plurality of speech units and the selected word, speech unit transformation of at least one word in the candidate word sequence matches transformation between the plurality of speech units. That is, the candidate word sequence is a word combination sequence predicted based on a change between the plurality of speech units.

In an example, sequence semantics of the plurality of candidate word sequences are analyzed through the language network, and at least one candidate word sequence is obtained from the plurality of candidate word sequences as the command analysis result in the text form.

For example, the sequence semantics are configured to represent semantic information expressed by the candidate word sequence, and not only can indicate a semantic change of at least one word in the candidate word sequence, but also can indicate sentence semantics of the entire candidate word sequence.

For example, the language network separately evaluates the plurality of candidate word sequences, to use at least one candidate word sequence that better conforms to a current semantic situation as the command analysis result.

In some implementations, probability evaluation is performed on the plurality of candidate word sequences through the language network to obtain predicted probabilities respectively corresponding to the plurality of candidate word sequences, and at least one candidate word sequence with a highest predicted probability is used as the command analysis result.

For example, the predicted probability is configured for representing a probability estimation result indicating that the candidate word sequence is correct under a constraint of the plurality of speech units. For example, a predicted probability of the candidate word sequence 11 is 0.32, a predicted probability of the candidate word sequence 12 is 0.8, a predicted probability of the candidate word sequence is 0.69, and a predicted probability of the candidate word sequence 22 is 0.45. If a candidate word sequence with a highest predicted probability is used as the command analysis result, the candidate word sequence 12, namely, “help me attack the enemy”, is outputted as the command analysis result.

In some implementations, after the sequence semantics of the plurality of candidate word sequences are analyzed through the language network, probability distributions respectively corresponding to the plurality of candidate word sequences are generated, the plurality of probability distributions and the plurality of speech units are inputted to a decoding network, and the at least one candidate word sequence is outputted as the command analysis result based on the constraint of the plurality of speech units.

For example, the probability distribution is configured to describe naturalness between at least one word in the candidate word sequence. The decoding network (also referred to as a decoder) is configured to select an optimal candidate word sequence as the command analysis result based on the plurality of candidate word sequences, the corresponding probability distributions, and the plurality of language units.

In some implementations, the decoding network may search the plurality of candidate word sequences using a beam search or another optimization algorithm. The beam search can find a most possible candidate word sequence from potential sequence space as the command analysis result based on the probability distributions outputted by the language network and the constraint of the plurality of speech units (phoneme or segment sequences) outputted by the acoustic network, to improve accuracy of speech recognition.

The decoding network may be configured outside the sound network and the language network, or may be configured in the language network. The preset dictionary may be configured in the language network, or may be configured outside the language network as an independent neural network layer. A network structure of the natural language analysis model is not limited herein.

In some implementations, the language network includes language sub-networks respectively corresponding to at least two virtual scenes.

For example, the plurality of virtual scenes each correspond to a language sub-network, and different language sub-networks are configured for specially analyzing virtual scenes corresponding to the language sub-networks. For example, a virtual scene A corresponds to a language sub-network 1, and a virtual scene B corresponds to a language sub-network 2. When analysis needs to be performed based on the virtual scene A, language analysis is performed by using the language sub-network 1. When analysis needs to be performed based on the virtual scene B, language analysis is performed by using the language sub-network 2.

In some implementations, if the natural language analysis model is referred to as the natural language analysis system, language models respectively corresponding to at least two virtual scenes may be configured, and a plurality of language models are in a one-to-one correspondence with the plurality of virtual scenes. A model structure or a system architecture is not limited herein, and the foregoing content is merely exemplary descriptions of an analysis process.

In some implementations, a first language sub-network corresponding to the first virtual scene is determined from at least two language sub-networks based on the first virtual scene in which the main control virtual character and/or the NPC are/is located.

For example, the first virtual scene is a virtual scene of the at least two virtual scenes. In addition to determining the first scene hot-word based on the first virtual scene in which the main control virtual character and/or the NPC are/is located, the first language sub-network corresponding to the first virtual scene is further determined from the at least two language sub-networks based on the first virtual scene. The first language sub-network is a sub-network layer for analyzing the candidate word sequence based on the first virtual scene.

In some implementations, the sequence semantics of the plurality of candidate word sequences are analyzed through the first language sub-network, and the at least one candidate word sequence is obtained from the plurality of candidate word sequences as the command analysis result in the text form.

In some implementations, different language sub-networks are language sub-networks obtained through pre-training based on corresponding virtual scenes. The first language sub-network is a language sub-network obtained through training based on the first virtual scene.

For example, the first language sub-network is obtained through training based on the first virtual scene. The first scene hot-word corresponding to the first virtual scene is obtained, and the first scene hot-word and the general word are used as sample data to train the first language sub-network. Alternatively, a plurality of scene description words for describing the first virtual scene are obtained, and the scene description words are used as sample data to train the first language sub-network. The scene description words include a plurality of words for describing a virtual scene status and a virtual element therein, and the like. Other language sub-networks are also trained based on words (such as a scene hot-word, a general word, and a scene description word) related to corresponding virtual scenes. Details are not described herein again.

In some implementations, after the plurality of candidate word sequences are obtained under a constraint of the first scene hot-word, semantic analysis is performed on each of the plurality of candidate word sequences through the first language sub-network corresponding to the first virtual scene, to obtain the predicted probabilities respectively corresponding to the plurality of candidate word sequences, and the at least one candidate word sequence with the highest predicted probability is used as the command analysis result in the text form.

The foregoing process of determining the corresponding first language sub-network based on the first virtual scene in which the main control virtual character and/or the NPC are/is located is merely an example. The plurality of virtual scenes each may be further configured to correspond to a sound network (for example, the sound network is a network obtained through training based on a corresponding virtual scene). A corresponding first sound sub-network is selected based on the first virtual scene for analysis, or a corresponding first sound sub-network and the corresponding first language sub-network are selected based on the first virtual scene for analysis. This is not limited herein.

In an example, the command analysis result in the text form is displayed.

For example, after a speech-to-text conversion process is performed on the natural language command in the speech form, the command analysis result in the text form is obtained, and the terminal may display the command analysis result on the terminal interface, to notify the player that the terminal has successfully received and analyzed the natural language command.

In some implementations, the command analysis result is displayed in a preset area on the terminal interface, for example, displayed in a preset dialog box area, and the dialog box area is configured to represent a simulated conversation process between the main control virtual character and the NPC. Alternatively, the command analysis result is displayed in a center area of the terminal interface, for example, displayed at a center of the terminal interface in a preset font size and a preset color.

In an example, a reply statement of the NPC in reply to the command analysis result is displayed.

The reply statement is a text statement generated by performing semantic analysis based on the command analysis result. For example, after obtaining the command analysis result through analysis, the terminal invokes a pre-trained semantic analysis model to analyze the command analysis result, and generates the reply statement in reply to the command analysis result. For example, the command analysis result is “No. 1, go to check the location A”, and the reply statement generated for the command analysis result based on the semantic analysis model is “No. 1 got it”, “OK”, or the like. A form of the reply statement is not limited herein.

In some embodiments, the reply statement is displayed below the command analysis result, or the reply statement is displayed after displaying of the command analysis result is canceled, or the like.

The foregoing content describes content of displaying the command analysis result in the text form and displaying the reply statement. A text display process can greatly improve intelligence and transparency of interaction between a virtual character and the player, so that the player can intuitively understand a process of interpreting and processing the natural language command, to enhance understandability during interaction. In addition, the reply statement of the NPC is generated through semantic analysis. In this way, instead of simply responding based on a literal meaning, the NPC can understand an intention and context information behind the command analysis result to generate reply text that better conforms to an expectation of the player, to improve semantic relevance and quality of a conversation between a virtual object and the NPC, ensure immersive interaction and interaction experience of the player, improve abundance and diversity of interaction between the player and the virtual environment, and ensure efficiency of human-computer interaction and accuracy of conversation interaction.

Operation 420: Control, based on the behavioral intention, the NPC to perform the virtual activity.

For example, after the command analysis result in the text form is obtained through conversion, behavioral intention recognition is performed on the command analysis result to obtain the behavioral intention, and then the NPC is controlled, based on the behavioral intention, to perform the virtual activity indicated by the behavioral intention.

For example, the command analysis result is text content in the text form. Compared with the natural language command in the speech form, the command analysis result is more intuitive, and can be used to control the NPC in a more targeted manner.

In some implementations, a form of commanding, based on the behavioral intention, the NPC to perform an activity includes at least one of the following: (1) commanding the NPC to move in the virtual environment; (2) commanding the NPC to search for a specified item; (3) commanding the NPC to cooperate with the main control virtual character to defend against an attack from an enemy virtual character; (4) commanding the NPC to attack an enemy virtual character; or (5) commanding the NPC to replace a prop part, a clothing accessory, or the like. A form of the activity is not limited herein.

For example, the command analysis result obtained by analyzing the natural language command is “go to attack”. It is determined, based on the behavioral intention recognition, that the behavioral intention of the natural language command is to command the NPC to perform a virtual attack against an attackable virtual character in the virtual environment. Therefore, the NPC may be controlled, based on the behavioral intention, to perform a virtual attack against another virtual character.

The foregoing are merely examples. This is not limited in examples of this disclosure.

In examples of this disclosure, content of recognizing the behavioral intention from the command analysis result obtained through speech-to-text conversion to control the NPC to perform the virtual activity is described. The process can enable the player to seamlessly interact with the virtual environment through a speech instruction, to greatly simplify an input mode, reduce dependency on a conventional input device, and improve operation experience of the player. The natural language command is converted into the command analysis result in the text form, so that speech information can be quantized, and noise interference in a speech input can also be eliminated. The environmental perception information is further considered during obtaining of the command analysis result, to improve a capability of understanding a complex context, and ensure accuracy of obtaining the command analysis result. Then the command analysis result is further processed to recognize the behavioral intention in the command analysis result, to accurately understand a requirement or an instruction of a user, so that the NPC can autonomously perform the virtual activity in a targeted manner. This enhances interaction and intelligence of a virtual world, and improves efficiency of human-computer interaction while ensuring operation precision.

In examples of this disclosure, content of determining the first virtual scene based on the location of the main control virtual character and/or the NPC and then determining the object perception range from the first virtual scene based on the location and the rotation and obtaining the first scene hot-word is described. If a plurality of virtual characters perform activities in the virtual environment including the plurality of virtual scenes, the first virtual scene may be specially determined from the virtual environment based on the location of the main control virtual character and/or the NPC, to determine the object perception range in the first virtual scene based on the rotation of the main control virtual character and/or the NPC. This resolves a problem that only a command analysis result with a wide meaning can be obtained through a speech recognition system. A text word used during speech-to-text conversion is constrained by the environmental perception information represented by the object perception range (for example, a scene hot-word is preferentially used), to help improve text accuracy of the command analysis result.

In addition, even if no command analysis result is generated, the second scene hot-word may be obtained based on a process in which the main control virtual character and/or the NPC move/moves to the second virtual scene, to constrain an analysis process of the command analysis result. This not only improves flexibility of obtaining a scene hot-word for constraining the analysis process, but also helps further improve flexibility of obtaining the command analysis result, so that the NPC is more accurately and flexibly commanded by the command analysis result in the text form.

In examples of this disclosure, a process in which the corresponding first language sub-network may be further determined based on the first virtual scene in which the main control virtual character and/or the NPC are/is located to perform targeted analysis, in addition to determining the first scene hot-word based on the first virtual scene. Corresponding language sub-networks are respectively trained for the plurality of virtual scenes, so that the language sub-networks can perform more targeted analysis on candidate word sequences under a constraint of the virtual scenes, to avoid blindness in obtaining the command analysis result. A process of obtaining the candidate word sequences is constrained by the first scene hot-word, to improve accuracy of the candidate word sequences. Further, an analysis process of the candidate word sequences is constrained based on the first language sub-network, to help further improve an association between the command analysis result and the first virtual scene, improve accuracy of analyzing the natural language command, and improve accuracy of commanding the NPC based on a more accurate command analysis result.

In an example, an example in which the virtual character control method is performed by a terminal is used for description. An NPC has a plurality of behavioral capabilities in a virtual scene, and the plurality of behavioral capabilities correspond to a plurality of classification labels. After obtaining a command analysis result in a text form based on speech-to-text conversion, the terminal performs behavioral intention recognition on the command analysis result through a hierarchical prediction network to obtain a behavioral intention and control the NPC to perform a virtual activity. For example, as shown in FIG. 7, operation 420 shown in FIG. 4 may be further implemented as operation 710 to operation 720 below.

Operation 710: Invoke at least one hierarchical prediction network to perform behavioral intention recognition on the command analysis result to obtain, as the behavioral intention, a first classification label of an intention of the command analysis result to command the NPC.

For example, the behavioral intention recognition is a recognition process for recognizing the behavioral intention from the command analysis result. The behavioral intention is intention information expressed by the command analysis result. The behavioral intention includes at least one of subject information, semantic information, and behavior information. The subject information is configured to represent identity information of the NPC (for example, including a name or a nickname of the NPC) indicated by the command analysis result. The semantic information is configured to represent a meaning and a thought conveyed by the command analysis result (for example, analyzing whether the command analysis result commands the NPC to initiate a virtual attack). The behavior information is configured to represent a behavior mode of the virtual activity that the NPC indicated by the command analysis result needs to perform (for example, analyzing whether the command analysis result commands the NPC to move or jump in the virtual environment).

The hierarchical prediction network includes at least two layers of sub-networks, and the at least two layers of sub-networks are constructed based on a tree structure of a plurality of classification labels.

For example, the hierarchical prediction network has a capability of predicting a classification label corresponding to the command analysis result. For example, the hierarchical prediction network includes the at least two layers of sub-networks, an upper-layer network and a lower-layer network are cascaded, and the lower-layer network further performs prediction on the first classification label based on a prediction result outputted by the upper-layer network.

In this embodiment, the at least one hierarchical prediction network is invoked to perform behavioral intention recognition on a fusion feature of the command analysis result to obtain the first classification label of the intention of the command analysis result to command the NPC.

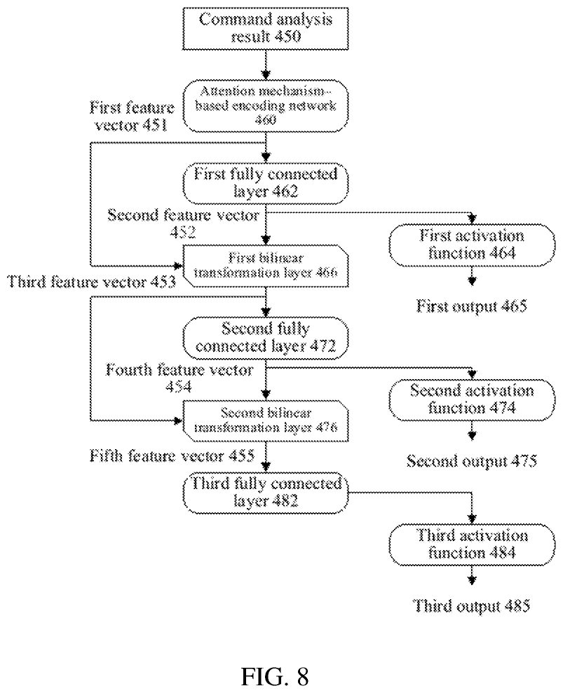

FIG. 8 is a diagram of performing behavioral intention recognition on a command analysis result according to an exemplary embodiment of this application. An attention mechanism-based encoding network 460 is invoked to perform feature encoding on a command analysis result 450 to obtain a first feature vector 451 of the command analysis result in hidden-layer space. The first feature vector 451 can indicate natural semantics of characters in the command analysis result 450.

In this embodiment, an information structure prediction network includes a first fully connected layer 462 and a first activation function 464. The first fully connected layer 462 is configured for performing dimension encoding on the first feature vector 451 to obtain a second feature vector 452 in a control dimension. The second feature vector 452 can describe natural semantics of the command analysis result 450 in an NPC command dimension. Activation is performed on the second feature vector 452 based on the first activation function 464 to obtain a first output 465. The first output 465 is configured for indicating whether the command analysis result 450 carries natural semantics for commanding the NPC.

If the first output 465 is configured for indicating that the command analysis result 450 carries natural semantics for commanding the NPC, a first bilinear transformation layer 466 is invoked to perform bilinear transformation on the first feature vector 451 and the second feature vector 452 to fuse natural language semantics of the command analysis result 450 in two dimensions, to obtain a third feature vector 453.

Next, behavioral intention recognition is performed on the command analysis result by invoking the hierarchical prediction network. The hierarchical prediction network includes two layers of sub-networks. First, for a higher-layer first-layer sub-network, the first-layer sub-network includes a second fully connected layer 472 and a second activation function 474. The second fully connected layer 472 encodes the third feature vector 453 in an intention feature dimension to obtain a fourth feature vector 454. An intention dimension corresponding to the fourth feature vector 454 includes any one of a subject dimension, a semantic dimension, and a behavior dimension. Activation is performed on the fourth feature vector 454 based on the second activation function 474 to obtain a second output 475. The second output 475 indicates a first-level behavior label of the command analysis result 450 in one intention dimension.

A second bilinear transformation layer 476 is invoked to perform bilinear transformation on the third feature vector 453 and the fourth feature vector 454 to fuse natural language semantics of the command analysis result 450 in two dimensions, to obtain a fifth feature vector 455.

Next, a second-level behavior label corresponding to the command analysis result 450 in the first-level behavior label is predicted through a lower-layer second-layer network of the hierarchical prediction network. For the lower-layer second-layer network, the second-layer network includes a third fully connected layer 482 and a third activation function 484. The third fully connected layer 482 encodes the fifth feature vector 455 in an intention feature dimension. Activation is performed on an encoding result based on the third activation function 484 to obtain a third output 485. The third output 485 indicates a second-level behavior label corresponding to the command analysis result 450 in the first-level behavior label.

In an exemplary embodiment, the behavioral intention includes at least one intention dimension. Each of the at least one hierarchical prediction network is configured for predicting a command intention of the command analysis result for the NPC in one intention dimension. The intention dimension includes at least one of a subject dimension, a semantic dimension, or a behavior dimension.

In an example, the at least one hierarchical prediction network includes a subject prediction network, a behavior prediction network, and a semantic prediction network, to implement parallel tactical instruction understanding on the command analysis result. The command intention for the NPC is described in three dimensions: the subject dimension, the semantic dimension, and the behavior dimension. Performing behavioral intention recognition on the command analysis result is also referred to as performing tactical instruction understanding on the command analysis result. The at least one hierarchical prediction network is invoked to perform tactical instruction understanding on the command analysis result to obtain the first classification label of the intention of the command analysis result to command the NPC. For example, natural language has abundant semantics, the command analysis result in a natural language form has abundant semantic elements, and each hierarchical prediction network predicts a command intention in the command analysis result separately from different dimensions. This reduces a quantity of label types that need to be classified in a prediction task of the hierarchical prediction network, and reduces complexity of the classification prediction task. In addition, the hierarchical prediction network needs to understand natural language semantics in the command analysis result only from one dimension, to reduce difficulty in extracting the natural language semantics from the command analysis result.

For example, an i^{th}-layer sub-network in each of the at least one hierarchical prediction network is configured for predicting a first-level behavior label of the command analysis result in one intention dimension, and an (i+1)^{th}-layer sub-network in the hierarchical prediction network is configured for predicting a second-level behavior label corresponding to the command analysis result in the first-level behavior label, where i is a positive integer. A higher-layer behavior label (for example, the first-level behavior label) obtained through prediction by a higher-layer sub-network (for example, the i^{th}-layer sub-network) in the hierarchical prediction network includes a plurality of sub-labels, also referred to as subordinate lower-layer labels. A corresponding lower-layer sub-network (for example, the (i+1)^{th}-layer sub-network) needs to be invoked to further perform classification prediction (for example, obtain the second-layer behavior label through prediction). A prediction task for a large variety of classification labels is split into prediction sub-tasks to be performed by at least two layers of sub-networks, to reduce complexity of classification prediction in each layer of sub-network.

In an exemplary embodiment, the behavioral intention includes at least one of the following intention dimensions: the subject dimension, the semantic dimension, and the behavior dimension. A subject-dimension analysis process is referred to as a subject prediction process. A semantic-dimension analysis process is referred to as a semantic prediction process. A behavior-dimension analysis process is referred to as a behavior prediction process. A prediction process in each dimension is described below.

### (1) Subject Prediction Process

In some embodiments, an i^{th}-layer sub-network in the subject prediction network is invoked to perform subject prediction on the command analysis result to learn, through prediction, that the command analysis result corresponds to a first-level behavior label among a plurality of first-level candidate labels.

In this embodiment, the intention dimension includes the subject dimension, the hierarchical prediction network includes the subject prediction network of a hierarchical structure, and the subject prediction network has a capability of predicting a subject type in the command analysis result. The subject type is configured for representing an identity of the NPC commanded by the command analysis result, that is, is configured for representing subject information in the command analysis result. For example, the subject prediction network is configured for predicting a specific role of the NPC commanded by the command analysis result among a plurality of NPCs, and there may be one or more NPCs commanded by the command analysis result.

For example, the i^{th}-layer sub-network is configured for predicting the first-level behavior label corresponding to the command analysis result from the plurality of first-level candidate labels. The plurality of first-level candidate labels are configured for indicating whether a subject exists in the command analysis result. The i^{th}-layer sub-network is configured for performing a binary classification task about whether a subject exists. In an example, the ith-layer sub-network includes an encoding layer, configured for extracting a feature representation of the command analysis result in the subject dimension and then performing classification prediction on the feature representation in the subject dimension to obtain the first-level behavior label corresponding to the command analysis result.

In some embodiments, an (i+1)^{th}-layer sub-network corresponding to the first-level behavior label in the subject prediction network is invoked to perform subject prediction on the command analysis result to obtain a second-level behavior label corresponding to the command analysis result among a plurality of second-level candidate labels.

For example, when the first-level behavior label is configured for indicating that a subject exists in the command analysis result, the plurality of second-level candidate labels are configured for indicating that the subject in the command analysis result is a main control virtual character controlled by a transmitter of the command analysis result, and/or one or more NPCs in a virtual camp to which the main control virtual character belongs. The plurality of second-level candidate labels are configured for indicating an identity of a virtual character commanded by the command analysis result. In an example, when the second-level behavior label indicates that the subject in the command analysis result is the main control virtual character, although natural semantics for controlling the virtual character exist in the command analysis result, the command analysis result is not a control command for an NPC, but is only self-talk of a user or text of communication between a plurality of users to notify each other of an activity status of the main control virtual character. However, when the second-level behavior label indicates that the subject in the command analysis result is the one or more NPCs, the second-level behavior label can be configured for determining, based on the command analysis result, an identity of an NPC that needs to perform a virtual activity.

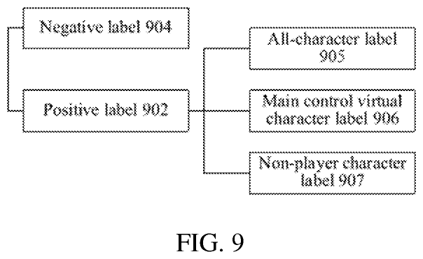

In an example, FIG. 9 is a diagram of first-level candidate labels according to an exemplary embodiment of this application. The i^{th}-layer sub-network in the subject prediction network is invoked to perform subject prediction on the command analysis result to learn, through prediction, that the command analysis result corresponds to the first-level behavior label among the plurality of first-level candidate labels. The plurality of first-level candidate labels include a positive label 902 and a negative label 904. The positive label 902 is configured for indicating that a subject exists in the command analysis result. The negative label 904 is configured for indicating that no subject exists in the command analysis result. The positive label 902 includes a plurality of second-level candidate labels: an all-character label 905, a main control virtual character label 906, and an NPC label 907. The all-character label 905 is configured for indicating that the subject in the command analysis result is all virtual characters in the virtual camp. The main control virtual character label 906 is configured for indicating that the subject in the command analysis result is a main control virtual character controlled by a user. The NPC label 907 is configured for indicating that the subject in the command analysis result is an NPC.

In some implementations, when the first-level behavior label is configured to indicate that no subject exists in the command analysis result, it is determined that the first classification label of the command analysis result is a first label.

For example, when the first-level behavior label is configured to indicate that no subject exists in the command analysis result, the command analysis result does not clearly indicate an identity of an NPC that needs to perform a virtual activity. The first classification label of the command analysis result is used as the first label. The first label is configured to indicate that the subject in the command analysis result is a historical subject in a historical command. The historical command is an adjacent command inputted before the command analysis result. The historical subject in the previously inputted historical command is used, so that continuous control on one or more NPCs can be implemented by using the historical subject as a reference.

In some implementations, when the first-level behavior label is configured to indicate that no subject exists in the command analysis result and an input time interval between the command analysis result and the historical command does not exceed a duration threshold, it is determined that the first classification label of the command analysis result is the first label. When the input time interval between the command analysis result and the historical command does not exceed the duration threshold, the command analysis result and the historical command have statement continuity, and are a continuous control command for one or more NPCs.

In some implementations, when the first-level behavior label is configured to indicate that no subject exists in the command analysis result, it is determined that the first classification label of the command analysis result is a second label.

Similarly, when the first-level behavior label is configured to indicate that no subject exists in the command analysis result, the command analysis result does not clearly indicate an identity of an NPC that needs to perform a virtual activity. The first classification label of the command analysis result is used as the second label. The second label is configured to indicate that the subject in the command analysis result is all NPCs in the virtual camp to which the main control virtual character belongs. During oral expression of natural language, a subject is usually omitted when oral expression is performed for a group object. Determining that the subject in the command analysis result is all the NPCs in the virtual camp to which the main control virtual character belongs conforms to the oral expression of the natural language.

In some implementations, when the first-level behavior label is configured to indicate that no subject exists in the command analysis result and no historical command exists within a duration threshold before input time of the command analysis result, it is determined that the first classification label of the command analysis result is the second label. Because no historical command exists within the duration threshold before the input time of the command analysis result, the command analysis result is isolated command information rather than a continuous expression of previous information. Based on an oral expression habit, it is determined that the subject in the command analysis result is all NPCs.

### (2) Semantic Prediction Process

In an exemplary embodiment, an i^{th}-layer sub-network in the semantic prediction network is invoked to perform semantic prediction on the command analysis result to learn, through prediction, that the command analysis result corresponds to a first-level behavior label among a plurality of first-level candidate labels.

In this example, the intention dimension includes the semantic dimension, the hierarchical prediction network includes the semantic prediction network of a hierarchical structure, and the semantic prediction network has a capability of predicting a semantic type in the command analysis result. The semantic type is configured to represent a control mode of the NPC for initiating a virtual attack, that is, is configured to represent semantic information in the command analysis result. For example, the semantic prediction network is configured to predict whether a virtual activity performed by the NPC commanded by the command analysis result is related to initiating a virtual attack. A virtual scene provides space for virtual competition between virtual characters. During the virtual competition, survival of a virtual character needs to be maintained. Initiating a virtual attack is highly related to maintaining survival of the virtual character. For example, when actively initiating a virtual attack, the virtual character can obtain (or pick up) additional virtual materials by defeating an enemy virtual character, but may be counterattacked by the enemy virtual character, causing a risk of a decrease in a virtual hit point value. Therefore, whether to initiate a virtual attack is highly related to maintaining survival of the virtual character. In this example, for a scenario in which virtual competition is performed in the virtual scene, a semantic dimension of whether to initiate a virtual attack is used as an independent dimension for prediction.

For example, the i^{th}-layer sub-network is configured for predicting the first-level behavior label corresponding to the command analysis result from the plurality of first-level candidate labels. The plurality of first-level candidate labels are configured for indicating whether semantics of initiating a virtual attack exist in the command analysis result. The i^{th}-layer sub-network is configured for performing a binary classification task about whether semantics for initiating a virtual attack exist. In an example, the i^{th}-layer sub-network includes an encoding layer, configured for extracting a feature representation of the command analysis result in the semantic dimension and then performing classification prediction on the feature representation in the semantic dimension to obtain the first-level behavior label corresponding to the command analysis result.

In an exemplary embodiment, an (i+1)^{th}-layer sub-network corresponding to the first-level behavior label in the semantic prediction network is invoked to perform semantic prediction on the command analysis result to obtain a second-level behavior label corresponding to the command analysis result among a plurality of second-level candidate labels.

For example, when the first-level behavior label is configured for indicating that no natural semantics for initiating a virtual attack exist in the command analysis result, the plurality of second-level candidate labels are configured for indicating that natural semantics in the command analysis result are to avoid initiating a virtual attack, or are other semantics irrelevant to a virtual attack.

For example, the first-level behavior label is configured for indicating that the command analysis result does not indicate to actively initiate a virtual attack, but a manner of facing a virtual attack is obtained through prediction by the (i+1)^{th}-layer sub-network. For example, the avoiding initiating a virtual attack is configured for indicating to avoid and evade a virtual attack, to intentionally reduce a quantity of virtual attacks; and the other semantics irrelevant to a virtual attack are configured for indicating to take neutral measures for a virtual attack, without indicating to actively initiate or intentionally avoid a virtual attack.

In an example, FIG. 9 is a diagram of first-level candidate labels according to an example of this disclosure. The i^{th}-layer sub-network in the semantic prediction network is invoked to perform semantic prediction on the command analysis result to learn, through prediction, that the command analysis result corresponds to the first-level behavior label among the plurality of first-level candidate labels. The plurality of first-level candidate labels include a positive semantic label 912 and a negative semantic label 914. The positive semantic label 912 is configured to indicate to actively initiate a virtual attack. The negative semantic label 914 is configured to indicate not to actively initiate a virtual attack. The negative semantic label 914 includes a plurality of second-level candidate labels: a stop label 915 and an others label 916. The stop label 915 is configured to indicate to avoid and evade a virtual attack, to intentionally reduce a quantity of virtual attacks. The others label 916 is configured to indicate to take neutral measures for a virtual attack, without indicating to actively initiate or intentionally avoid a virtual attack.

### (3) Behavior Prediction Process

In an exemplary embodiment, an i^{th}-layer sub-network in the behavior prediction network is invoked to perform behavior prediction on the command analysis result to learn, through prediction, that the command analysis result corresponds to a first-level behavior label among a plurality of first-level candidate labels.

In this example, the intention dimension includes the behavior dimension, the hierarchical prediction network includes the behavior prediction network of a hierarchical structure, and the behavior prediction network has a capability of predicting a behavior type in the command analysis result. The behavior type is configured to represent a behavior mode of the NPC for performing a virtual activity, that is, is configured to represent behavior information in the command analysis result. For example, the behavior prediction network is configured to predict a specific virtual activity to be performed by the NPC.

For example, the i^{th}-layer sub-network is configured for predicting the first-level behavior label corresponding to the command analysis result from the plurality of first-level candidate labels. The plurality of first-level candidate labels are configured for indicating virtual activity types. A virtual activity type obtained through prediction by the i^{th}-layer sub-network includes a plurality of sub-labels, also referred to as subordinate lower-layer labels. An (i+1)th-layer sub-network corresponding to the first-level behavior label needs to be invoked for further prediction.

In an exemplary embodiment, an (i+1)^{th}-layer sub-network corresponding to the first-level behavior label in the behavior prediction network is invoked to perform behavior prediction on the command analysis result to obtain a second-level behavior label corresponding to the command analysis result among a plurality of second-level candidate labels.

For example, the plurality of second-level candidate labels are a plurality of sub-labels, also referred to as subordinate lower-layer labels, of the first-level behavior label obtained through prediction by the i^{th}-layer sub-network. The plurality of second-level candidate labels are configured for indicating a plurality of behavior entries in the virtual activity type corresponding to the first-level behavior label, and the behavior entries are configured for indicating a mode in which the NPC performs a virtual activity.

In an exemplary implementation, the second-level candidate labels are described below.

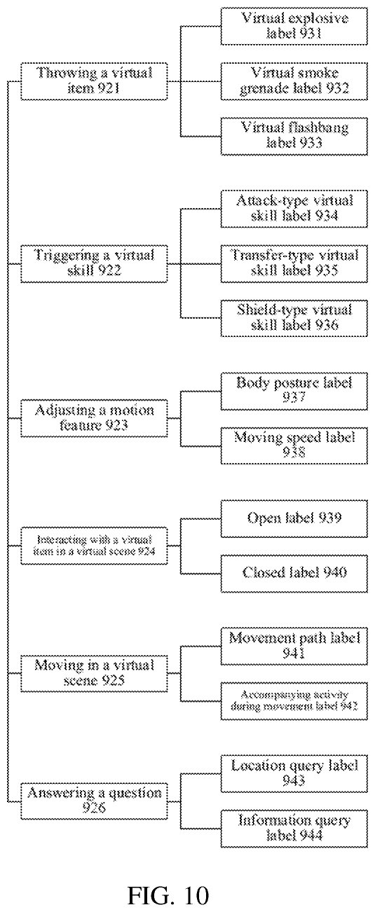

FIG. 10 is a diagram of first-level candidate labels according to an example of this disclosure. In an example, the i^{th}-layer sub-network in the behavior prediction network is invoked to perform behavior prediction on the command analysis result to learn, through prediction, that the command analysis result corresponds to the first-level behavior label among the plurality of first-level candidate labels. The plurality of first-level candidate labels include throwing a virtual item 921, triggering a virtual skill 922, adjusting a motion feature 923, interacting with a virtual item in a virtual scene 924, moving in a virtual scene 925, and answering a question 926.

When the first-level behavior label is configured for indicating that the virtual activity type is throwing a virtual item, the plurality of second-level candidate labels are configured for describing a type of a virtual item that needs to be thrown. For example, in a shooting game, the plurality of second-level candidate labels include, but are not limited to, at least one of a virtual explosive label 931, a virtual smoke grenade label 932, and a virtual flashbang label 933. The type of the virtual item to be thrown is not limited in this application. The virtual item may be a virtual item mounted before entry into a virtual scene, or may be a virtual item picked up in a virtual scene. A process pf taking out a virtual item from storage space (for example, a virtual backpack) of an NPC virtual character and triggering use of the virtual item by giving up holding the virtual item is throwing the virtual item. For example, a virtual turret in the virtual backpack is taken out, and the virtual turret is deployed in a virtual scene in a manner in which the virtual turret is no longer held. Correspondingly, throwing a virtual item is also referred to as deploying a virtual item.

Additionally/Alternatively, when the first-level behavior label is configured for indicating that the virtual activity type is triggering a virtual skill, the plurality of second-level candidate labels are configured for describing a type of a virtual skill that needs to be triggered. For example, in a multiplayer online battle arena (MOBA) game, the plurality of second-level candidate labels include at least one of an attack-type virtual skill label 934, a transfer-type virtual skill label 935, a shield-type virtual skill label 936, and the like. The virtual skill may be triggered for use by one or more virtual objects, or may be triggered for use in one effective range/effective direction. For example, an NPC has three types of virtual skills, for example, a skill 1, a skill 2, and a skill 3 (also referred to as an ultimate skill). A virtual skill type indicated by the second-level candidate label may be a name of a virtual skill, or may be a sequence number of the virtual skill among the three types of virtual skills owned by the NPC.

Additionally/Alternatively, when the first-level behavior label is configured for indicating that the virtual activity type is adjusting a motion feature, the plurality of second-level candidate labels include a body posture label 937 or a moving speed label 938 for adjusting an NPC. For example, a body posture includes, but is not limited to, at least one of jumping, standing, squatting, lying prone, aiming, or the like; and a moving speed includes, but is not limited to, at least one of a running speed, a walking speed, a slow walking speed, a crawling forward speed, or a crouch movement speed. The adjusting a motion feature is configured for indicating to adjust an appearance style (for example, different body postures have different projection observation areas) and/or a movement feature of an NPC.

Additionally/Alternatively, when the first-level behavior label is configured for indicating that the virtual activity type is interacting with a virtual item in a virtual scene, the plurality of second-level candidate labels include an open label 939 or a closed label 940. The virtual item in this embodiment is an item having different open/closed states, for example, is at least one of a virtual door, a virtual window, a virtual safe, a virtual box, a virtual computer, or a virtual mechanism. For example, the virtual item is a virtual door in a virtual scene. The virtual door has an open/closed state, and has different appearance styles (door panel angles in an open state and a closed state are different)/different human-computer interaction modes (door panel angles in an open state and a closed state are different) in different open/closed states.

Additionally/Alternatively, when the first-level behavior label is configured for indicating that the virtual activity type is moving in a virtual scene, the plurality of second-level candidate labels include a movement path label 941 or an accompanying activity during movement label 942. For example, a movement path described by the second-level candidate label includes, but is not limited to, at least one of the following: moving between two location points with a connection line between the two location points as a reference, moving around a virtual object in a virtual environment, or moving by a plurality of NPCs around a virtual object (to surround the virtual object). An accompanying activity described by the second-level candidate label includes, but is not limited to, at least one of the following: initiating a virtual attack in an accompanying manner, avoiding a virtual attack in an accompanying manner, or searching for a cover object in a virtual environment in an accompanying manner.

Additionally/Alternatively, when the first-level behavior label is configured for indicating that the virtual activity type is answering a question, the plurality of second-level candidate labels include a location query label 943 for which an answer statement includes location information in a virtual scene, or an information query label 944 for description information of a virtual scene. When the second-level candidate label is configured for describing that an answer statement includes location information in a virtual scene, an objective of a query statement is to query a location of an NPC in a virtual environment. When the second-level candidate label is configured for describing that an answer statement includes description information in a virtual scene, an objective of a query statement is to query an observation result of an NPC in a virtual environment.

The foregoing are merely examples. This is not limited in examples of this disclosure.

In an example, the natural language command is converted, based on the speech-to-text conversion technology, into a command analysis statement group including a plurality of command analysis statements. Each command analysis statement may be used as a command analysis result on which behavioral intention recognition is to be performed.

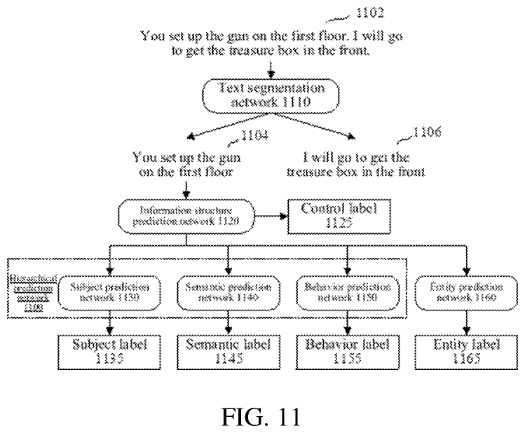

In some implementations, a process of performing intention analysis based on the command analysis statement group is described. FIG. 11 is a diagram of a method for processing a command analysis statement according to an example of this disclosure.

A command analysis statement group 1102 is obtained. Text content of the command analysis statement group 1102 includes: “You set up the gun on the first floor. I will go to get the treasure box in the front.” A text segmentation network 1110 is invoked to perform semantic segmentation on the command analysis statement group 1102 to obtain two command analysis statements included in the command analysis statement group 1102: a first command analysis statement 1104 and a second command analysis statement 1106. Text content of the first command analysis statement 1104 includes: “You set up the gun on the first floor.” Text content of the second command analysis statement 1106 includes: “I will go to get the treasure box in the front.”

A process of behavioral intention recognition and entity recognition on the first command analysis statement 1104 is described below. First, an information structure prediction network 1120 is invoked to perform classification prediction on the first command analysis statement 1104 to obtain a control label 1125. The control label 1125 is configured for indicating whether the first command analysis statement 1104 carries natural semantics for commanding an NPC. When the control label 1125 indicates that the first command analysis statement 1104 carries natural semantics for commanding an NPC, a hierarchical prediction network 1100 and an entity prediction network 1160 are invoked to perform behavioral intention recognition and entity recognition on the first command analysis statement 1104 respectively. The NPC is controlled by a server, a client, or AI, and the NPC has an autonomous behavioral capability. Commanding means that a player gives a command and the NPC understands and executes the command based on the autonomous behavioral capability of the NPC.

For the behavioral intention recognition on the first command analysis statement 1104, the hierarchical prediction network 1100 includes three parts for predicting a command intention for the NPC from three intention dimensions respectively. A subject prediction network 1130 is configured for predicting a subject label 1135 of the first command analysis statement 1104. The subject label 1135 is configured for indicating a subject type. The subject type is configured for representing an identity of the NPC commanded by the command analysis statement. In the first command analysis statement 1104, the subject label 1135 indicates that a teammate character is commanded by the command analysis statement. A semantic prediction network 1140 is configured for predicting a semantic label 1145 of the first command analysis statement 1104. The semantic label 1145 is configured for indicating a semantic type. The semantic type is configured for representing a control mode of the NPC for initiating a virtual attack. In the first command analysis statement 1104, the semantic label 1145 indicates that semantics for initiating a virtual attack exist. A behavior prediction network 1150 is configured for predicting a behavior label 1155 of the first command analysis statement 1104. The behavior label 1155 is configured for indicating an intention type. The intention type is a behavior mode of the NPC for performing a virtual activity. In the first command analysis statement 1104, the behavior label 1155 indicates to move in a virtual environment to go to a specified location.

For example, each of the subject prediction network 1130, the semantic prediction network 1140, and the behavior prediction network 1150 includes at least two layers of sub-networks, and the at least two layers of sub-networks are constructed based on a tree structure of a plurality of classification labels. The subject prediction network 1130 is used as an example. A higher-layer sub-network of the subject prediction network 1130 is configured for predicting whether a subject exists in the first command analysis statement 1104. When a subject exists in the first command analysis statement 1104, a lower-layer sub-network is configured for predicting that the subject in the first command analysis statement 1104 is a main control virtual character (also referred to as a player character) and/or one or more NPCs (also referred to as teammate characters) in a virtual camp to which the main control virtual character belongs.

For the entity recognition on the first command analysis statement 1104, the entity prediction network 1160 may be implemented as a CRF to predict an entity label 1165 of the first command analysis statement 1104. In the first command analysis statement 1104, the word “you” corresponds to a person entity label, the words “first floor” correspond to a building entity label, and no word corresponding to a modifier label exists.

Similarly, a process of behavioral intention recognition and entity recognition on the second statement 1106 is similar to that of the first statement. In the second statement 1106, a subject label 1135 indicates that a player character is commanded by the command analysis statement, a semantic label 1145 indicates that semantics for initiating a virtual attack exist, and a behavior label 1155 indicates to move in a virtual environment to go to a specified location. In the second statement 1106, the word “I” corresponds to a person entity label, no word corresponding to a building entity label exists, and the word “front” corresponds to an orientation label in a modifier.

During the behavioral intention recognition, two layers of sub-networks in each part of the hierarchical prediction network 1100 are sequentially invoked to predict classification labels of the command analysis statement in a subject dimension, a semantic dimension, and a behavior dimension, to determine a type of a control object carried in the command analysis statement. At least two layers of sub-networks in the hierarchical prediction network are constructed based on a tree structure of a plurality of classification labels, to reduce complexity of classification prediction in each layer of sub-network. During the entity recognition and prediction, words corresponding to the person entity label, the building entity label, and the modifier label are implemented based on the CRF, to improve accuracy of performing classification prediction on natural semantics in the command analysis statement.

The foregoing are merely examples. This is not limited in examples of this disclosure.

In an example, content of obtaining the command analysis statement from the command analysis statement group is described.

In some examples, an encoder is invoked to perform feature encoding on the command analysis statement group to obtain a first feature representation of the command analysis result in hidden-layer space.

For example, the encoder has a capability of extracting a feature representation of the command analysis result in the hidden-layer space, and encodes the command analysis result in the natural language form into at least one of a feature value, a feature vector, or a feature matrix. For example, the encoder may be implemented as a natural language model, for example, bidirectional encoder representations from transformers (BERT).

In some examples, a segmenter is invoked to perform semantic segmentation on the first feature representation to obtain at least two feature sub-representations.

For example, the segmenter determines, based on the first feature representation obtained through encoding, whether a character in the command analysis statement group is a start location of a statement, and then splits the first feature representation into the at least two feature sub-representations based on the character being a start location of a statement.

In some examples, a decoder is invoked to separately perform feature decoding on the at least two feature sub-representations to obtain at least two command analysis results, the at least two command analysis results being in a one-to-one correspondence with the at least two feature sub-representations.

For example, the decoder has a capability of decoding a hidden-layer feature of natural language into the natural language, and separately performs feature decoding on the at least two feature sub-representations to obtain the at least two command analysis results. The at least two command analysis results are in a one-to-one correspondence with the at least two feature sub-representations, to implement splitting of a command analysis result group.

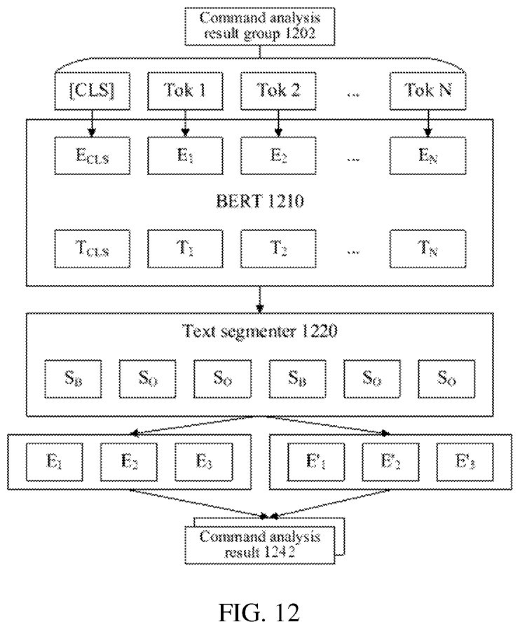

FIG. 12 is a diagram of segmenting a command analysis result according to an example of this application. A command analysis result group 1202 is configured for continuously commanding an NPC to perform a virtual activity. The command analysis result group 1202 includes a no-speech start symbol [CLS] and N tokens. A BERT 1210 is invoked to perform feature encoding on the command analysis result group 1202. The BERT 1210 performs linear transformation on the start symbol [CLS] and the N tokens to obtain a linear code: E_{CLS} and E₁ to E_{N}. The BERT 1210 performs feature encoding on the linear code to obtain a feature representation of a command analysis result in hidden-layer space: T_{CLS} and T₁ to T_{N}. A text segmenter 1220 is invoked to perform semantic segmentation on a first feature representation to obtain two feature sub-representations. The two feature sub-representations indicate E₁ to E₃, and E′₁ to E′₃. The two feature sub-representations are in a one-to-one correspondence with two command analysis statements. The text segmenter 1220 determines whether the N tokens of the command analysis result group 1202 are related to a start location of a sentence. For example, the text segmenter 1220 determines that the tokens are related to a start location of a sentence when a segmentation label of the tokens of the command analysis result group 1202 is S_{B}, and the tokens are irrelevant to a start location of a sentence when a segmentation label of the tokens is S_{O}. A decoder is invoked to separately perform feature decoding on at least two feature sub-representations to obtain at least two command analysis results 1242.

In some examples, a first command analysis result of the at least two command analysis results is determined as the command analysis result.

In this example, the following operations are described by using prediction of a first classification label of one command analysis result as an example. Behavioral intention recognition is repeatedly performed on each command analysis statement in the at least two command analysis results to obtain a first classification label of an intention of each command analysis statement to command an NPC.

The foregoing are merely examples. This is not limited in examples of this disclosure.

In some implementations, an attention mechanism-based encoding network is invoked to perform feature encoding on the command analysis result to obtain a hidden-layer feature representation of the command analysis result in hidden-layer space.

For example, a network structure of the encoding network in this operation may be the same as or different from that of the foregoing encoder. In the foregoing content, the hidden-layer feature extracted by the encoder can indicate whether the character in the command analysis result group is a start location of a statement. In this operation, the attention mechanism -based encoding network can indicate natural semantics of a character in the command analysis result. It can be learned that encoding objectives of the encoder and the encoding network are different. Correspondingly, network parameters of the encoder and the encoding network are also usually different. A difference between the network parameters is caused by using different loss functions during network training. For example, the hidden-layer feature representation includes at least one of a feature value, a feature vector, or a feature matrix.

In the foregoing new example, classification prediction performed by invoking the hierarchical prediction network is performed on the hidden-layer feature representation of the command analysis result.

In an example, an information structure prediction network is invoked to perform classification prediction on the command analysis result to learn, through prediction, that the command analysis result corresponds to a first control label.

The information structure prediction network has a capability of predicting whether the command analysis result carries natural semantics for commanding an NPC. The first control label is configured to indicate that the command analysis result carries natural semantics for commanding an NPC. When it is learned through prediction that the command analysis result corresponds to the first control label, the command analysis result is configured to control the NPC, rather than chat content. Then behavioral intention recognition needs to be performed to obtain a first classification label of an intention to command the NPC. Further, the information structure prediction network is configured to perform a binary classification task about whether the command analysis result is chat content.

In an example, a feature encoding network is invoked to perform dimension encoding on the command analysis result to obtain a dimension feature representation of the command analysis result.

For example, the dimension feature representation is configured to indicate a feature representation of the command analysis result in at least one of the following dimensions: a subject dimension, a semantic dimension, a behavior dimension, and a control dimension. The control dimension is configured to indicate whether the command analysis result carries natural semantics for commanding an NPC. In some examples, a dimension corresponding to dimension encoding performed by the feature encoding network is different from an intention dimension for performing behavioral intention recognition. Encoding is performed in different dimensions, so that feature information carrying a larger amount of information can be obtained, to increase a quantity of information sources and references for performing behavioral intention recognition.

In an example, linear transformation is performed on the hidden-layer feature representation and the dimension feature representation of the command analysis result to obtain the fusion feature of the command analysis result.

For example, linear transformation is performed on the hidden-layer feature representation and the dimension feature representation, to integrate a natural semantic dimension and a dimension feature (at least one of the subject dimension, the semantic dimension, the behavior dimension, or the control dimension described above), and provide more information sources and references for performing behavioral intention recognition. Correspondingly, in this example, classification prediction performed by invoking the hierarchical prediction network is performed on the fusion feature of the command analysis result.

In the foregoing new example, classification prediction performed by invoking the hierarchical prediction network is performed on the fusion feature of the command analysis result.

The foregoing are merely examples. This is not limited in examples of this disclosure.

In an example, a process of training the hierarchical prediction network is described.

In some implementations, a sample command and a sample label of the sample command are obtained, the sample label being a type label of the sample command; and at least one hierarchical prediction network is invoked to perform behavioral intention recognition on the sample command to obtain a predicted label of an intention of the sample command to command an NPC.

For example, the sample command is a command analysis result that has been marked with a sample label, and the sample label is a type label of the sample command. The sample command and the sample label may be obtained through manual marking, and are configured for training the hierarchical prediction network.

For example, the hierarchical prediction network has a capability of predicting a classification label corresponding to the command analysis result. For example, the hierarchical prediction network includes at least two layers of sub-networks, and the at least two layers of sub-networks are constructed based on a tree structure of a plurality of classification labels. In the hierarchical prediction network, the at least two layers of sub-networks of a corresponding hierarchical structure are constructed based on the tree structure of the classification labels. A prediction task for a large variety of classification labels is split into prediction sub-tasks to be performed by the at least two layers of sub-networks, to reduce complexity of classification prediction in each layer of sub-network.

In some implementations, error back propagation training is performed on the hierarchical prediction network based on a difference between the predicted label and the sample label to obtain a trained hierarchical prediction network.

For example, the difference between the predicted label and the sample label is configured for indicating a degree of accuracy of performing behavioral intention recognition by the hierarchical prediction network. Error back propagation training is performed on the hierarchical prediction network based on the difference between the predicted label and the sample label, to adjust a network parameter of the hierarchical prediction network with a training objective to minimize the difference between the predicted label and the sample label, to obtain the trained hierarchical prediction network.

The behavioral intention includes at least one intention dimension. Each of the at least one hierarchical prediction network in this example is configured to predict a command intention of the command analysis result for the NPC in one intention dimension. The intention dimension includes at least one of a subject dimension, a semantic dimension, or a behavior dimension. For descriptions of the subject dimension, the semantic dimension, and the behavior dimension, refer to the foregoing examples. Details are not described herein again.

For example, the performing error back propagation training on the hierarchical prediction network in this operation may be training only a hierarchical prediction network in one intention dimension, or may be jointly training a plurality of hierarchical prediction networks to simultaneously obtain a plurality of trained hierarchical prediction networks through training.

In some implementations, a difference loss between the predicted label and the sample label is obtained; a first quantity is obtained, and a weighting parameter is determined based on the first quantity, the first quantity being negatively correlated with the weighting parameter, the first quantity being a quantity of training commands, the training command and the sample command corresponding to a same sample label, and the training command being configured to train the hierarchical prediction network; and a product of the difference loss and the weighting parameter is obtained, and error back propagation training is performed on the hierarchical prediction network based on the product to obtain the trained hierarchical prediction network.

In some examples, when a first predicted label has no corresponding (i+1)^{th}-layer sub-network, error back propagation training is performed on the hierarchical prediction network based on a difference between the first predicted label and the sample label to obtain the trained hierarchical prediction network.

For example, when the first predicted label has no corresponding (i+1)^{th}-layer of sub-network, prediction on the predicted label is implemented only through one layer of sub-network in the hierarchical prediction network. A loss function for training the hierarchical prediction network is determined based on the difference between the first predicted label and the sample label.

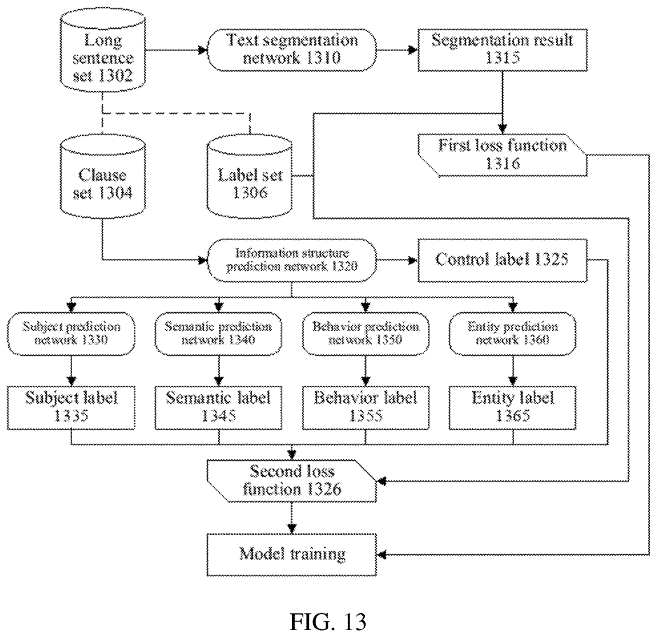

FIG. 13 is a diagram of a prediction network training method according to an example of this disclosure. A long sentence set 1302 includes long sentences for continuously commanding an NPC in a virtual scene, and is also referred to as a sample command group. The long sentence set 1302 corresponds to a clause set 1304 and a label set 1306. A long sentence in the long sentence set 1302 is used as an example. The clause set 1304 is configured to indicate clauses obtained by segmenting the long sentence. The label set 1306 is configured to indicate a classification label of each word in the long sentence. The classification label includes labels in a plurality of dimensions. Details are described below.

The long sentence in the long sentence set 1302 is inputted to a text segmentation network 1310 to obtain a long sentence segmentation result 1315. For example, for descriptions of the text segmentation network 1310, refer to the encoder, the segmenter, and the decoder in the foregoing descriptions. Details are not described herein again. The segmentation result 1315 may be a predicted segmentation label of each word in the long sentence, and indicates whether each word in the long sentence is a start location of a statement. The segmentation result 1315 is compared with a real segmentation label that is in the label set 1306 and that is marked for each word in the long sentence to obtain a first loss function 1316. For example, the first loss function 1316 is a cross-entropy loss function.

Next, a process of entity prediction and intention prediction on a clause are described. To implement entity prediction and intention prediction on the clauses of the long sentence, entity prediction and intention prediction only need to be repeatedly performed on each clause in the long sentence.

First, a clause in the clause set 1304 is inputted to an information structure prediction network 1320 to obtain a control label 1325. The control label 1325 is configured to indicate whether the clause carries natural semantics for commanding the NPC. When the control label 1325 is configured to indicate that the clause carries natural semantics for commanding the NPC, a subject prediction network 1330, a semantic prediction network 1340, a behavior prediction network 1350, and an entity prediction network 1360 are invoked to separately perform prediction on the clause. A subject label 1335 is obtained through prediction based on the subject prediction network 1330. A semantic label 1345 is obtained through prediction based on the semantic prediction network 1340. A behavior label 1355 is obtained through prediction based on the behavior prediction network 1350. The subject prediction network 1330, the semantic prediction network 1340, and the behavior prediction network 1350, that is, a total of three networks, perform behavioral intention recognition in different intention dimensions. Each of the foregoing three networks includes at least two layers of sub-networks. For descriptions of the foregoing three networks, refer to the examples of the method for processing a command analysis result in the foregoing descriptions. Details are not described again. An entity label 1365 is obtained through prediction based on the entity prediction network 1360. The entity label 1365 corresponds to an environmental element in the virtual scene. The entity label 1365 is configured to describe an environmental element, in a virtual environment, on which the clause intends to indicate the NPC to perform a virtual activity. For example, the entity prediction network 1360 is implemented as a CRF. For more descriptions of the entity prediction network 1360, refer to operation 330 above. Details are not described again.

The label set 1306 includes real labels of each word in the clause in a subject dimension, a semantic dimension, a behavior dimension, a control dimension, and an entity dimension. Differences between the real labels and predicted labels are obtained through comparison, to obtain a second loss function 1326. Overall error back propagation training is performed on the text segmentation network 1310, the information structure prediction network 1320, the subject prediction network 1330, the semantic prediction network 1340, the behavior prediction network 1350, and the entity prediction network 1360 based on a sum of the first loss function 1316 and the second loss function 1326 to implement model training.

The foregoing are merely examples. This is not limited in examples of this disclosure.

Operation 720: Control the NPC to perform the virtual activity based on a first intention corresponding to the first classification label.

For example, the first classification label is determined based on the foregoing process. Based on a correspondence between a classification label and an intention, when the first classification label is determined, the NPC may be controlled, using the corresponding first intention, to perform the virtual activity.

In some implementations, the first classification label is a classification label determined based on at least one of the subject dimension, the semantic dimension, or the behavior dimension, and therefore can comprehensively indicate intention information, so that the virtual activity performed by the NPC is controlled more accurately.

The foregoing are merely examples. This is not limited in examples of this disclosure.

In examples of this disclosure, if it is learned, through prediction by two layers of sub-networks in the subject prediction network, that the command analysis result corresponds to a subject label, an identity of the NPC commanded by the command analysis result is determined. At least two layers of sub-networks in the subject prediction network are constructed based on a tree structure of a plurality of subject labels, to reduce complexity of classification prediction in each layer of sub-network. Whether a subject exists in the command analysis result is predicted in an i^{th}-layer sub-network, and an identity of a specific character commanded by the command analysis result is predicted in an (i+1)^{th}-layer sub-network. In an NPC control scenario, the subject prediction network is specifically constructed based on classification labels of a tree structure of the subject labels, to improve accuracy of performing classification prediction on natural semantics in the command analysis result.

In examples of this disclosure, if it is learned, through prediction by two layers of sub-networks in the semantic prediction network, that the command analysis result corresponds to a semantic label, a control mode for initiating a virtual attack is determined. At least two layers of sub-networks in the semantic prediction network are constructed based on a tree structure of a plurality of semantic labels, to reduce complexity of classification prediction in each layer of sub-network. Whether semantics for initiating a virtual attack exist in the command analysis result is predicted in an i^{th}-layer sub-network, and whether the command analysis result specifically indicates to avoid initiating a virtual attack or is irrelevant to a virtual attack is predicted in an (i+1)^{th}-layer sub-network. In an NPC control scenario, the semantic prediction network is specifically constructed based on classification labels of a tree structure of the semantic labels, to improve accuracy of performing classification prediction on natural semantics in the command analysis result.

In examples of this disclosure, if it is learned, through prediction by two layers of sub-networks in the behavior prediction network, that the command analysis result corresponds to a behavior label, a virtual activity type is determined. At least two layers of sub-networks in the behavior prediction network are constructed based on a tree structure of a plurality of behavior labels, to reduce complexity of classification prediction in each layer of sub-network. The virtual activity type of the command analysis result is predicted in an i^{th}-layer sub-network, and a virtual activity entry of the command analysis result is predicted in an (i+1)^{th}-layer sub-network. In an NPC control scenario, the behavior prediction network is specifically constructed based on classification labels of a tree structure of the behavior labels, to improve accuracy of performing classification prediction on natural behavior in the command analysis result.

In addition, the at least two layers of sub-networks in the hierarchical prediction network are constructed based on a tree structure of a plurality of classification labels, to reduce complexity of classification prediction in each layer of sub-network. The classification label is used as label information for representing an NPC behavioral capability. Behavioral intention recognition is performed on the command analysis result based on the tree structure constructed by the plurality of classification labels, to efficiently organize a recognition process by well utilizing a hierarchical relationship, and help extract, from the command analysis result, a behavioral intention that better matches the NPC behavioral capability. This improves influence of the environmental perception information in the virtual environment on the behavioral intention recognition, overcomes a problem in the related art that a behavioral intention cannot be specifically extracted from text content, and helps fully improve accuracy of the behavioral intention recognition. In an NPC control scenario, the hierarchical prediction network is specifically constructed based on classification labels of a tree structure for controlling an NPC, to improve accuracy of performing classification prediction on natural semantics in the command analysis result, obtain a more accurate behavioral intention, and further help better control, based on the more accurate behavioral intention, the NPC to perform a virtual activity. In addition, a long sentence can be further segmented by the encoder, the segmenter, and the decoder, to adapt to a continuous NPC command mode.

In addition, the intention dimension is, for example, the subject dimension, the semantic dimension, or the behavior dimension. The hierarchical prediction network based on multi-dimensional intention analysis is introduced, to accurately understand and execute a more complex instruction, and significantly improve intelligent performance of a virtual character or an NPC under a complex command. Subject-dimension analysis determines a subject type in a command analysis result through the subject prediction network, to precisely recognize an NPC under command, and ensure that command execution is highly targeted. Semantic-dimension analysis predicts a semantic type in a command through the semantic prediction network, to represent an attack control mode of an NPC in a virtual environment, and improve appropriateness and accuracy of an attack. The behavior dimension is introduced to predict a behavior type of an NPC in a command through the behavior prediction network, to further enhance natural performance of a virtual character when performing a task. To sum up, the multi-dimensional analysis makes a speech instruction in a virtual environment more accurate and smoother, and can effectively improve a response capability of a virtual character and command execution efficiency, especially in complex interactions or scenes.

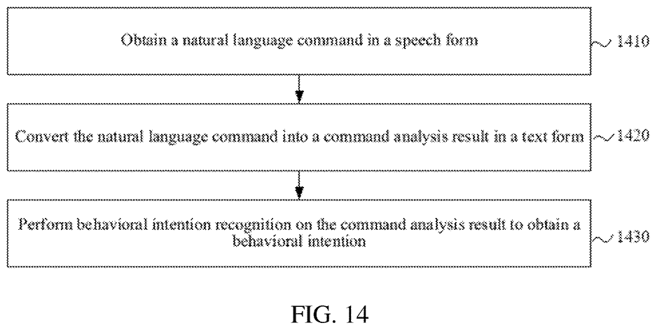

In an example, an example in which the virtual character control method is performed by a server is used for description. After receiving a natural language command in a speech form, a terminal transmits the natural language command to the server, and the server performs speech-to-text conversion on the natural language command to obtain a command analysis result in a text form. The command analysis result may be transmitted to the terminal and displayed on a terminal interface. In addition, the server may further perform behavioral intention recognition on the command analysis result in the text form to obtain a behavioral intention and control an NPC to perform a virtual activity. For example, as shown in FIG. 14, operation 330 shown in FIG. 3 may be further implemented as operation 1410 to operation 1430 below.

Operation 1410: Obtain the natural language command in the speech form.

For example, the natural language command, as a command in the speech form, is usually implemented as audio data. For example, the player utters speech when operating the terminal, and the terminal automatically captures the speech based on a deployed microphone array and obtains audio data as the natural language command in the speech form; or the player utters speech after performing a trigger operation on an audio capture control when operating the terminal, and the terminal receives the speech and obtains audio data as the natural language command in the speech form.

The natural language command includes natural semantics for controlling the NPC.

For example, the natural semantics are semantic information expressed by the natural language command for controlling the NPC, and the NPC may be specifically controlled, based on the natural semantics, to perform a virtual activity.

In some implementations, the natural semantics include identification semantics for indicating the NPC and intention semantics for indicating an NPC activity. For example, the identification semantics include at least one of a name (for example, “hero A”) of the NPC, a label (for example, “No. 1”) of the NPC, and location information (for example, “beside the house”) of the NPC.

Operation 1420: Convert the natural language command into the command analysis result in the text form.

The command analysis result is a result obtained by performing speech-to-text conversion on the natural language command based on the environmental perception information, and the environmental perception information includes information obtained by perceiving the virtual environment by at least one of the main control virtual character and the NPC.

In some implementations, the environmental perception information is configured to represent environmental information perceived and obtained by the main control virtual character and/or the NPC in an object perception range, and the object perception range is a three-dimensional space range in which the main control virtual character and/or the NPC have/has perception for another scene element.

In some implementations, behavioral intention recognition is performed on the natural language command under the constraint of the environmental perception information to obtain the behavioral intention, and the NPC is controlled, based on the behavioral intention, to perform the virtual activity.

In some implementations, a behavioral intention recognition process is performed by a pre-trained machine learning model. The environmental perception information and the natural language command are used as inputs of the machine learning model, and the machine learning model performs an encoding process and a decoding process to output the behavioral intention.

In an example, at least one first scene hot-word is obtained based on a first virtual scene in which the main control virtual character and/or the NPC are/is located.

The at least one first scene hot-word is a scene-associated word of the first virtual scene.

In some implementations, the first virtual scene is one of a plurality of virtual scenes in the virtual environment; and the first virtual scene in which the main control virtual character and/or the NPC are/is located is determined from the plurality of virtual scenes based on a location of the main control virtual character and/or the NPC in the virtual environment.

In some implementations, location coordinates of the main control virtual character and/or the NPC in the virtual environment are obtained, scene coordinate ranges respectively corresponding to the plurality of virtual scenes are obtained, and the first virtual scene in which the main control virtual character and/or the NPC are/is located is determined from the plurality of virtual scenes based on a relative location relationship between the location coordinates and the plurality of scene coordinate ranges.

The scene coordinate range is configured to represent a location range of the virtual scene in the virtual environment.

For example, the location coordinates of the main control virtual character and/or the NPC is content that represents location information by using coordinate data. In some embodiments, the location coordinates corresponding to the main control virtual character and/or the NPC are determined based on a world coordinate system corresponding to the virtual environment.

For example, the plurality of virtual scenes in the virtual environment each correspond to a scene coordinate range. The scene coordinate range is configured for defining, from three dimensions, a three-dimensional space range corresponding to the virtual scene, and the three dimensions represent a horizontal direction, a vertical direction, and a depth direction in three-dimensional space. Scene coordinate ranges respectively corresponding to different virtual scenes are independent of each other without overlapping. In some embodiments, the scene coordinate ranges respectively corresponding to the plurality of virtual scenes are determined based on the world coordinate system corresponding to the virtual environment.

For example, after the location coordinates are obtained, matching is performed between the location coordinates and the plurality of scene coordinate ranges, and a virtual scene corresponding to a scene coordinate range including the location coordinates is used as the first virtual scene in which the main control virtual character and/or the NPC are/is located. For example, the scene coordinate range including the location coordinates is referred to as a first scene coordinate range, the first virtual scene corresponds to the first scene coordinate range, and object coordinates are within the first scene coordinate range.

In some embodiments, if a main control virtual character is the main control virtual character and/or the NPC, first location coordinates of the main control virtual character in the virtual environment are obtained; and the first virtual scene in which the main control virtual character and/or the NPC are/is located is determined from the plurality of virtual scenes based on a relative location relationship between the first location coordinates and the plurality of scene coordinate ranges.

In some embodiments, if an NPC is the main control virtual character and/or the NPC, first location coordinates of the NPC in the virtual environment are obtained; and the first virtual scene in which the main control virtual character and/or the NPC are/is located is determined from the plurality of virtual scenes based on a relative location relationship between the first location coordinates and the plurality of scene coordinate ranges.

In some embodiments, when the command analysis result is not obtained, in response to that the main control virtual character and/or the NPC move/moves from the first virtual scene to a second virtual scene, at least one second scene hot-word corresponding to the second virtual scene is obtained; and the natural language command is converted into the command analysis result in the text form based on the at least one second scene hot-word.

In an exemplary embodiment, a first virtual scene corresponding to a first virtual battle is determined based on the first virtual battle in which the main control virtual character and/or the NPC participate/participates.

A plurality of virtual battles each correspond to a virtual scene, and the plurality of virtual battles are simulated battle environments provided for the main control virtual character and/or the NPC.

In some implementations, a first scene type corresponding to the first virtual scene in which the main control virtual character and/or the NPC are/is located is obtained.

For example, the first scene type is a scene type corresponding to the first virtual scene. The scene type is configured for representing a scene status of a virtual scene. For example, the scene type includes a plurality of types that describe a scene status, such as an office type, a battle type, a kitchen type, a bedroom type, a classroom type, a store type, and a factory type.

In some implementations, the first virtual scene corresponds to the first scene type, and the first scene type is configured to describe a scene status represented by the first virtual scene. For example, if the first virtual scene is a virtual office, the first scene type is the office type; or if the first virtual scene is a virtual battle area, the first scene type is the battle type; or if the first virtual scene is a virtual store, and the first scene type is the store type.

In some implementations, a hot-word set corresponding to the first scene type is obtained, a word in the hot-word set is used as the at least one first scene hot-word, and the hot-word set is a set of scene-associated words collected based on the first scene type.

For example, the plurality of scene types each correspond to a hot-word set. The hot-word set represents a set of scene-associated words collected based on the scene type, and also represents a set of scene-associated words collected based on at least one virtual scene of the scene type.

In some implementations, a plurality of scene hot-words are obtained, and the plurality of scene hot-words correspond to at least two virtual scenes.

For example, scene hot-words respectively corresponding to a plurality of virtual scenes in the virtual environment are pre-obtained. In some implementations, at least one scene hot-word corresponding to each of the plurality of virtual scenes is obtained based on a virtual element in each virtual scene, and is stored to obtain the plurality of scene hot-words. In some implementations, an element name of the virtual element in the virtual scene is obtained as the scene hot-word; or an action name of an interactive action for interacting with the virtual element in the virtual scene is obtained as the scene hot-word; or a state name for describing an element state of the virtual element in the virtual scene is obtained as the scene hot-word.

In some implementations, the at least one first scene hot-word corresponding to the first virtual scene is obtained from the plurality of scene hot-words based on the first virtual scene in which the main control virtual character and/or the NPC are/is located.

In some implementations, a plurality of candidate scene hot-words with a first scene identifier are obtained from the plurality of scene hot-words based on the first virtual scene in which the main control virtual character and/or the NPC are/is located, where the first scene identifier is a scene identifier corresponding to the first virtual scene; and at least two candidate scene hot-words are selected from the plurality of candidate scene hot-words as the first scene hot-word based on the object perception range of the main control virtual character and/or the NPC in the first virtual scene.

For example, if a scene hot-word 1 and a scene hot-word 2 are obtained based on a virtual scene A, the scene hot-word 1 is marked with a scene identifier a corresponding to the virtual scene A, and the scene hot-word 2 is also marked with the scene identifier a; and if a scene hot-word 3 is obtained based on a virtual scene B, the scene hot-word 3 is marked with a scene identifier b corresponding to the virtual scene B.

In some implementations, an object perception range of the main control virtual character and/or the NPC in the first virtual scene is obtained, where the object perception range is a three-dimensional space range in which the main control virtual character and/or the NPC have/has perception for another scene element; and the at least one first scene hot-word is obtained based on environmental perception information in the object perception range.

For example, after the object perception range is determined, the at least one first scene hot-word representing a status of the main control virtual character and/or the NPC is obtained based on a range of the object perception range in the first virtual scene and the environmental perception information that is determined by the main control virtual character and/or the NPC in the object perception range based on perception.

In some implementations, the object perception range includes at least one of the following: a visual perception range of the main control virtual character and/or the NPC; an auditory perception range of the main control virtual character and/or the NPC; an olfactory perception range of the main control virtual character and/or the NPC; or a range perceived by a perceptual skill or a perceptual item that is owned by the main control virtual character and/or the NPC.

In some embodiments, when the object perception range includes the visual perception range, a preset frustum is generated as the visual perception range by using the location of the main control virtual character and/or NPC as a start point and using a rotation of the main control virtual character and/or NPC as a center line of the frustum. The preset frustum is a three-dimensional area for measuring the visual perception range.

For example, when the object perception range includes the visual perception range, the location of the main control virtual character and/or the NPC and the rotation of the main control virtual character and/or the NPC are determined, and with the location as the start point and the rotation as the center line of the frustum, the preset frustum is used as the visual perception range determined based on the visual perception capability.

In some embodiments, a first scene type corresponding to the first virtual scene is obtained; a hot-word set corresponding to the first scene type is obtained; an object perception range of the main control virtual character and/or the NPC in the first virtual scene is obtained; and at least one word is obtained from the hot-word set as the at least one first scene hot-word based on environmental perception information in the object perception range.

In some embodiments, the environmental perception information includes a virtual element; a virtual element within the object perception range in the first virtual scene is determined; and an element name of the virtual element is used as the first scene hot-word; or an action name of an interactive action corresponding to the virtual element is used as the first scene hot-word.

For example, the element association relationship is configured to represent a relationship indicating a status of the virtual element. For example, a word including an element name of the virtual element is obtained from the hot-word set as the first scene hot-word, or a word for triggering the virtual element is obtained from the hot-word set as the first scene hot-word, or an interaction word for interacting with the virtual element is obtained from the hot-word set as the first scene hot-word.

In an exemplary embodiment, the natural language command is converted into the command analysis result in the text form based on the at least one first scene hot-word.

In some implementations, a pre-trained natural language analysis model is obtained. The pre-trained natural language analysis model includes an acoustic network, a language network, and a preset dictionary, and the preset dictionary includes the at least one first scene hot-word, another scene hot-word, and a general word.

In some embodiments, a plurality of speech units corresponding to the natural language command are obtained through the acoustic network. The speech unit is a basic constituent unit of a word pronunciation. A sequence matching relationship between the plurality of speech units and a selected word in the preset dictionary is analyzed through the language network to obtain the command analysis result in the text form.

The selected word includes at least the at least one first scene hot-word and the general word.

In some embodiments, the selected word further includes the another scene hot-word.

For example, if the selected word is the first scene hot-word and the general word, matching may be performed between the at least one speech unit sequence and the first scene hot-word and the general word; or If the selected word is the first scene hot-word, the another scene hot-word, and the general word, matching may be performed between the at least one speech unit sequence and the first scene hot-word, the another scene hot-word, and the general word.

A word in the preset dictionary includes an analysis weight. A first analysis weight of the at least one first scene hot-word is higher than a second analysis weight of the another scene hot-word. The analysis weight is a degree of attention paid to a word when the word participates in sequence matching.

For example, a larger analysis weight indicates a higher degree of attention paid to a word when the word participates in sequence matching, that is, attention is more likely to be paid to the word. A smaller analysis weight indicates a lower degree of attention paid to a word when the word participates in sequence matching, that is, attention is less likely to be paid to the word. Degrees of attention paid to different words during sequence matching may be adjusted based on analysis weights, so that a word with a larger analysis weight is preferentially used for matching against a word sequence, and a word with a larger analysis weight is more likely to be selected as a word constituting the command analysis result.

In some embodiments, a matching relationship between the plurality of speech units and the selected word in the preset dictionary is analyzed to obtain a plurality of candidate word sequences. The plurality of candidate word sequences include at least one of a plurality of selected words, and the candidate word sequence is a word sequence obtained based on a change relationship between the plurality of speech units.

For example, a process of analyzing the matching relationship represents a process of analyzing a status of matching between the selected word and the speech units.

In some embodiments, sequence semantics of the plurality of candidate word sequences are analyzed through the language network, and at least one candidate word sequence is obtained from the plurality of candidate word sequences as the command analysis result in the text form.

For example, the sequence semantics are configured for representing semantic information expressed by the candidate word sequence, and not only can indicate a semantic change of at least one word in the candidate word sequence, but also can indicate sentence semantics of the entire candidate word sequence. In some embodiments, probability evaluation is performed on the plurality of candidate word sequences through the language network to obtain predicted probabilities respectively corresponding to the plurality of candidate word sequences, and at least one candidate word sequence with a highest predicted probability is used as the command analysis result.

The foregoing describes content of analyzing the sequence semantics of the candidate word sequences to obtain the command analysis result from the plurality of candidate word sequences. The sequence matching relationship between the plurality of speech units and the selected word in the preset dictionary is analyzed, to significantly improve accuracy and flexibility of a speech recognition process. The language network may analyze a change relationship between the speech units and the selected word in depth, to effectively reduce noise in speech. Providing the plurality of candidate word sequences helps select a most appropriate word sequence in different scenes, to understand an overall meaning and context information of a statement, improve intelligence of speech recognition, and protect naturalness and efficiency of an interaction process.

In some implementations, the language network includes language sub-networks respectively corresponding to at least two virtual scenes.

For example, the plurality of virtual scenes each correspond to a language sub-network, and different language sub-networks are configured for specially analyzing virtual scenes corresponding to the language sub-networks. For example, a virtual scene A corresponds to a language sub-network 1, and a virtual scene B corresponds to a language sub-network 2. When analysis needs to be performed based on the virtual scene A, language analysis is performed by using the language sub-network 1. When analysis needs to be performed based on the virtual scene B, language analysis is performed by using the language sub-network 2.

For example, a first language sub-network corresponding to the first virtual scene is determined from at least two language sub-networks based on the first virtual scene in which the main control virtual character and/or the NPC are/is located; and the sequence semantics of the plurality of candidate word sequences are analyzed through the first language sub-network, and the at least one candidate word sequence is obtained from the plurality of candidate word sequences as the command analysis result in the text form.

In some implementations, different language sub-networks are language sub-networks obtained through pre-training based on corresponding virtual scenes. The first language sub-network is a language sub-network obtained through training based on the first virtual scene.

In some implementations, after the plurality of candidate word sequences are obtained under a constraint of the first scene hot-word, semantic analysis is performed on each of the plurality of candidate word sequences through the first language sub-network corresponding to the first virtual scene, to obtain the predicted probabilities respectively corresponding to the plurality of candidate word sequences, and the at least one candidate word sequence with the highest predicted probability is used as the command analysis result in the text form.

The foregoing describes content of analyzing the sequence semantics of the candidate word sequences through the language sub-networks corresponding to the virtual scenes, to obtain the command analysis result. Each virtual scene corresponds to a dedicated language sub-network, to optimize language understanding based on context features of different virtual scenes, ensure high matching between a speech input and a virtual scene, and reduce a possibility of ambiguity and incorrect parsing. The candidate word sequences are analyzed through the first language sub-network in the first virtual scene, to perform in-depth semantic understanding based on a scene-specific language rule and context, and select a more accurate command analysis result from the plurality of candidate sequences. This improves accuracy and immersion of speech interaction between a virtual character and the player, and provides smoother and personalized user experience. Precise selection of a speech sub-network also helps implement more accurate analysis with fewer computing resources, to improve data processing efficiency.

Operation 1430: Perform behavioral intention recognition on the command analysis result to obtain the behavioral intention.

In some implementations, at least one hierarchical prediction network is invoked to perform behavioral intention recognition on the command analysis result to obtain, as the behavioral intention, a first classification label of an intention of the command analysis result to command the NPC.

The hierarchical prediction network includes at least two layers of sub-networks, and the at least two layers of sub-networks are constructed based on a tree structure of a plurality of classification labels.

In some implementations, the behavioral intention includes at least one intention dimension. Each of the at least one hierarchical prediction network is configured to predict a command intention of the command analysis result for the NPC in one intention dimension. An i^{th}-layer sub-network in each hierarchical prediction network is configured to predict a first-level behavior label of the command analysis result in one intention dimension, and an (i+1)^{th}-layer sub-network in the hierarchical prediction network is configured to predict a second-level behavior label corresponding to the command analysis result in the first-level behavior label, where i is a positive integer. The intention dimension includes at least one of a subject dimension, a semantic dimension, or a behavior dimension.

In some implementations, the intention dimension includes the subject dimension, the hierarchical prediction network includes a subject prediction network of a hierarchical structure, and the subject prediction network has a capability of predicting a subject type in the command analysis result. The subject type is configured to represent an identity of the NPC commanded by the command analysis result. Additionally/Alternatively, the intention dimension includes the semantic dimension, the hierarchical prediction network includes a semantic prediction network of a hierarchical structure, and the semantic prediction network has a capability of predicting a semantic type in the command analysis result. The semantic type is configured to represent a control mode of the NPC for initiating a virtual attack. Additionally/Alternatively, the intention dimension includes the behavior dimension, the hierarchical prediction network includes a behavior prediction network of a hierarchical structure, and the behavior prediction network has a capability of predicting a behavior type in the command analysis result. The behavior type is configured to represent a behavior mode of the NPC for performing a virtual activity.

For content of performing behavioral intention recognition in operation 1430, refer to operation 710 above. Details are not described herein again.

The behavioral intention is configured to control the NPC to perform the virtual activity. For example, the behavior mode in which the NPC performs the virtual activity is indicated based on the behavior type. For example, the NPC is instructed to perform a throwing action, or the NPC is instructed to adjust a motion feature, or the NPC is instructed to interact with a virtual item.

In some implementations, after controlling, based on the behavioral intention, the NPC to perform the virtual activity, the server transmits activity animation data to the terminal, to render and display, on the terminal, an activity animation of the NPC performing the virtual activity. Alternatively, the server transmits the behavioral intention to the terminal, and after controlling, based on the behavioral intention, the NPC to perform the virtual activity, the terminal renders and displays a corresponding activity animation.

The foregoing are merely examples. This is not limited in examples of this disclosure.

In examples of this disclosure, a process of performing speech-to-text conversion on the natural language command by the server is described, and a process of performing behavioral intention recognition by the server is described. The server analyzes the natural language command to obtain the behavioral intention for controlling the NPC to perform the virtual activity. A powerful computing capability of the server is utilized. This not only reduces data analysis load of the terminal, but also helps continuously improve an analysis process and analysis efficiency based on an algorithm integration capability of the server, to improve privacy of data analysis.

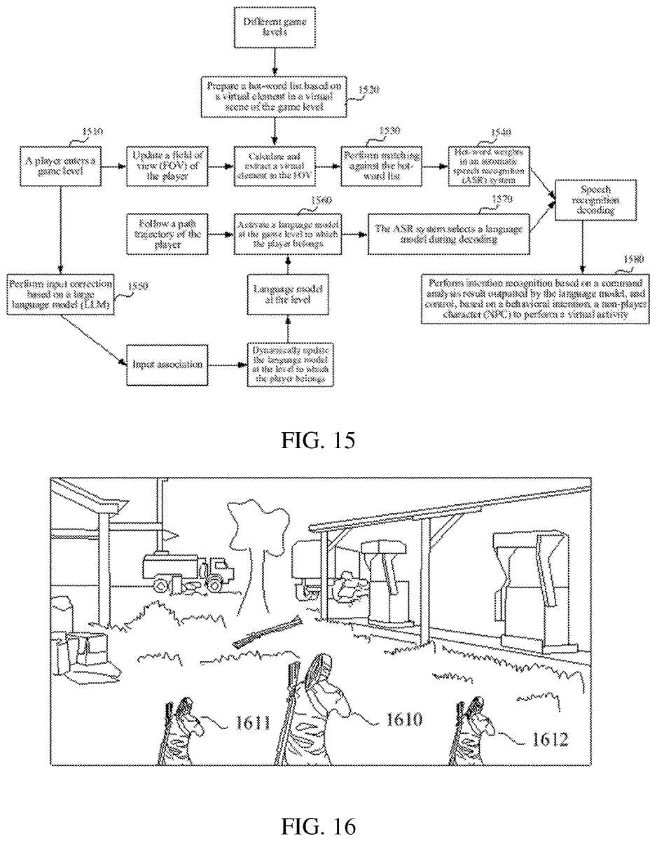

In an example, the virtual character control method may be applied to a game scene. A player initiates a natural language command in a speech form during a game, so that a terminal controls an NPC through speech based on a behavioral intention in the natural language command. For example, FIG. 15 is a technical flowchart of a virtual scene-based speech conversion method. The method includes operation 1510 to operation 1590 below.

Operation 1510: A player enters a game level.

For example, the game level is a specific part or stage in a video game. The player needs to complete a specific objective or task in this part before continuing to go to a next level. Levels are usually designed to gradually increase in difficulty, to challenge a skill and a strategy of the player. Each level may include different environments, enemies, puzzles, and rewards, to provide diverse game experience.

In some examples, the player may control a main control virtual character to participate in a virtual battle during the game. The player may further command another NPC to participate in the virtual battle in coordination with the main control virtual character. The NPC is a virtual character other than the main control virtual character, for example, a virtual soldier or a virtual hero that is deployed in the virtual battle by a system by default. For example, the player may manually control the main control virtual character to perform the virtual battle during the game, or may command, through speech, the NPC to perform the virtual battle.

Operation 1520: Prepare a hot-word list based on a virtual element in a virtual scene of the game level.

For example, a plurality of different game levels are usually provided in a game, one game level corresponds to one virtual environment, one virtual environment includes a plurality of virtual scenes, and a game scene is a three-dimensional space range in which the main control virtual character and/or the NPC are/is located at a specific game level. The virtual scene is not only visually displayed, but also includes virtual elements, game sound effects, and other details, which constitute game experience of the player. A carefully designed virtual scene can greatly improve immersion and fun of the game. A plurality of virtual scenes each correspond to one scene type. Scene types of the plurality of virtual scenes may be the same or different. This is not limited herein.

In some examples, each scene type has unique virtual elements and atmosphere, and a story line and interaction of the game can be enhanced by the virtual elements. For example, in a forest scene, the player may need to evade a wild animal or find a hidden path; and in a future city scene, the player may need to use high-tech equipment to complete a task.

In some examples, each game level may have some specific virtual elements, for example, a key for unlocking a specific door or a treasure box. To be specific, a door leading to a new area or game level can be opened only by a specific key or by completing a specific task. A virtual item obtained at a specific game level may have a unique attack effect or capability, for example, provide additional defense or special resistance, to help the player deal with a specific enemy virtual character or the like. Specific virtual items and consumables, collectors, and gemstones/gold coins exist at the game level. In addition, the game level further includes a puzzle item, a specific vehicle, a specific capability (for example, a magic or a skill), and items for interacting with an environment, for example, a virtual explosive, a virtual obstacle, and a virtual building. Each specific level of the game levels has unique virtual elements, and these virtual elements usually have unique functions or effects that can affect game experience of the player.

In some examples, a hot-word list corresponding to each of the plurality of virtual scenes is prepared based on respective virtual elements in the plurality of virtual scenes; or a hot-word list corresponding to the plurality of virtual scenes is prepared, and the hot-word list includes scene hot-words respectively corresponding to the plurality of virtual scenes.

In some examples, a hot-word management system may be designed to obtain more abundant scene hot-words. The hot-word management system has preprocessed all game assets, and may calculate a location and an orientation of the main control virtual character and/or the NPC during real-time interaction of the player. A hot-word library (also referred to as a hot-word list) is generated based on asset preprocessing, and includes scene hot-words of various virtual scenes.

In some examples, a virtual element existing in an object perception range is determined, based on the object perception range, from a first virtual scene in which the main control virtual character and/or the NPC are/is located. That is, the virtual element within the object perception range is determined.

For example, when a virtual scene changes, the hot-word management system may automatically adjust a needed scene hot-word; and first select a candidate scene hot-word from the predefined hot-word library based on a current scene, and then perform secondary selection based on an FOV (object perception range) of the player.

In some examples, for example, an FOV is the object perception range. During determining of an FOV of the main control virtual character and/or the NPC, the FOV is determined based on a frustum of a camera. The frustum is a spatial area defined by a location and an FOV of the camera. To improve efficiency, virtual elements in a virtual scene may be organized by using a space division technology, for example, a quadtree, an octree, or a grid. These data structures can help quickly determine virtual elements within the FOV. After a space range is determined, frustum culling is performed, and virtual elements that need to be rendered are determined by calculating virtual elements within the frustum.

For example, six planes (upper, lower, left, right, front, and rear) are extracted from the frustum of the camera, to extract frustum planes. Each virtual element is tested by using a bounding box of the virtual element and the frustum planes. If the bounding box is completely outside the frustum, an element name, an action name, or the like of the virtual element does not need to be loaded to the first scene hot-word.

For example, virtual elements corresponding to element names, action names, or the like that need to be loaded to the first scene hot-word to be used, and virtual elements corresponding to hot-words that may be unloaded from a memory are determined based on a frustum culling result. In some examples, thresholds of hot-word loading and hot-word unloading may be further set, to avoid frequent hot-word loading and hot-word unloading operations.

Hierarchical frustum culling: Based on the space division technology, an element name, an action name, and the like of a virtual element in a large area are first unloaded, and then an element name, an action name, and the like of a virtual element in a small area are unloaded.

Scene hot-words are frequently used words in a specific application scenario. The scene hot-words are set, so that the system can recognize these words more accurately, to improve overall recognition accuracy. These hot-words either appear only at a specific game level of a game, or are words frequently used by a player at a specific game level. It is difficult to perform speech-to-text translation for these words only based on pronunciations, or these words are very frequently used, affecting user experience.

In some implementations, an initial hot-word list is collected. The hot-word list includes the following content:
(1) scene-specific item words, such as “region A”, “virtual stable”, “virtual crash site”, and “virtual oil tank truck”;
(2) scene-specific character words, such as “virtual hero 1”, “virtual soldier 2”, and “virtual monster”;
(3) common instructions, such as “attack”, “defend”, “jump”, and “run”;
(4) specific task words, such as “open the door”, “unlock the treasure box”, and “conversation”; and
(5) environmental interaction words, such as “view the map”, “use the prop”, and “save the game”.

Operation 1530: Perform matching against the hot-word list.

For example, after the virtual element in the object perception range is determined, matching is performed against the hot-word list, to determine a scene hot-word corresponding to the virtual element as the first scene hot-word.

In some examples, for example, the plurality of virtual scenes each correspond to a hot-word list. A first hot-word list corresponding to the first virtual scene is determined based on the first virtual scene, and at least one first scene hot-word is determined from the first hot-word list based on the virtual element in the object perception range. For example, an element name for describing the virtual element is used as the first scene hot-word, or an action name of an interactive action for interacting with the virtual element is used as the first scene hot-word.

In some examples, for example, the plurality of virtual scenes correspond to one hot-word list. At least one first scene hot-word is determined from the hot-word list based on the virtual element in the object perception range. For example, an element name for describing the virtual element is used as the first scene hot-word, or an action name of an interactive action for interacting with the virtual element is used as the first scene hot-word.

Operation 1540: hot-word weights in an automatic speech recognition (ASR) system.

For example, the ASR system is a system commonly used in a speech recognition technology, and is intended to convert an instruction in a human speech form into an instruction in a text form. The ASR system relates to processes of processing, analyzing, and understanding a sound signal, to enable a computer to “understand” and perform a corresponding operation.

The ASR system is the foregoing pre-trained natural language analysis model. The ASR system includes the following several key components:

(1) Speech recognition acoustic model (the acoustic network in the foregoing natural language analysis model):

The acoustic model is configured for mapping a feature vector of an audio signal to a basic speech unit (for example, a phoneme). The acoustic model is usually trained by using a machine learning technology (for example, a DNN), to learn a relationship between a speech signal and a phoneme by using a large amount of annotated speech data.

(2) Speech recognition language model (the language network in the foregoing natural language analysis model):

The language model is configured for predicting a probability of a word sequence, to help the system select a most possible word sequence from a plurality of possible word sequences. Usually, an end-to-end network already includes specific language model information, and a decoding constraint is applied based on a statistical method (an n-gram model) to improve accuracy.

(3) Speech recognition hot-word (the first scene hot-word in the preset dictionary in the foregoing natural language analysis model, or a selected word including a general word):

The hot-word is a word or a phrase that requires particular attention and that needs to be preferentially recognized in a specific virtual scene. For example, in a game scene, “virtual stable” or “virtual crash site” is a hot-word. The hot-word usually needs higher recognition accuracy, and therefore may be processed by a dedicated model or algorithm. These hot-words usually have a scene association relationship with a virtual scene in a game, and text corresponding to the hot-words cannot be written only based on pronunciations.

(5) Speech recognition decoder (the foregoing decoding network):

The decoder is one of core components of a speech recognition system. The decoder finds a most possible word sequence by using a search algorithm (for example, a Viterbi algorithm) based on outputs of the acoustic model and the language model. A task of the decoder is to convert a feature vector sequence into a final text output.

In an example, a relationship between a state and a conversion is processed by using a weighted finite-state transducer (WFST). During speech recognition, a state may represent different meanings based on different inputs, and a conversion represents a transformation between states. For example, during processing of a plurality of speech units, each speech unit may be considered as a state, and a transformation between speech units (for example, a pronunciation transition from a speech unit 1 to a speech unit 2) is a conversion between states; and during analysis of a candidate word sequence, each word in the candidate word sequence may be considered as a state, and a transformation between words (for example, a transition from a word 1 to a word 2) is a conversion between states.

For example, the WFST may allocate a weight to each conversion. The weight usually indicates a cost or a probability of a conversion, for example, a weight of a transformation from the speech unit 1 to the speech unit 2, or a weight of a transformation from the word 1 to the word 2.

In some examples, the WFST is configured to indicate relationships between conversions and various models such as the acoustic model, the language model, and the preset dictionary. In the speech recognition system, the WFST is configured to combine different models (such as the acoustic model, the language model, and the preset dictionary) into a unified decoding network during speech recognition. The decoding network can efficiently search for a most possible word sequence.

For example, the acoustic model represents a probability of a phoneme or another basic speech unit as a WFST, the language model represents a probability of a candidate word sequence as a WFST, and the preset dictionary represents a mapping between a word and a phoneme sequence (a speech unit sequence) corresponding to the word as a WFST. A relationship between the acoustic model, the language model, and the WFST is as follows: In the speech recognition system, the acoustic model, the language model, and the dictionary each are usually represented as an independent WFST, and then the WFSTs are combined into a comprehensive WFST through a specific combination and optimization algorithm. The comprehensive WFST is used for decoding and recognition.

In some examples, the acoustic model (H) maps, to phonemes or other basic speech units, a plurality of acoustic features corresponding to a natural language command in a speech form, to obtain a plurality of speech unit sequences. The mapping may be represented as a WFST, denoted as H. A context dependency model (C) is usually used in the acoustic model to obtain a speech unit sequence that is more closely associated with a context.

The preset dictionary (L) maps a word to a speech unit sequence to obtain a plurality of candidate word sequences. The mapping may also be represented as a WFST, denoted as L.

The language model (G) represents a probability of a candidate word sequence as a WFST, denoted as G.

An HCLG corresponding to the speech recognition system is obtained by combining H, C, L, and G. That is, a comprehensive WFST is generated, and is denoted as HCLG. The comprehensive WFST represents a complete mapping from a feature vector to a word sequence. During decoding, the ASR system searches for a most possible candidate word sequence as a command analysis result through the comprehensive WFST, namely, the HCLG.

For example, the natural language command in the speech form is converted into the plurality of acoustic features, and the plurality of acoustic features are scored by using the acoustic model (H) and the context dependency model (C) in the HCLG, to generate phoneme probabilities. Then the phoneme probabilities are mapped to word sequences by using the preset dictionary (L) in the HCLG. Finally, a command analysis result is obtained through analysis by the language model (G). For example, a most possible word sequence is found by the decoder through a search algorithm (for example, the Viterbi algorithm) as the command analysis result.

In an example, speech data and text data that are related to a game level need to be prepared. The data is configured for training the acoustic model and the language model. The speech data includes recorded and collected audio data that is in a speech form and that may be used by a player in a game. The text data includes text that is previously inputted by a player and text that is related to a game level and that is inputted by an LLM through association, such as a level name and an action instruction.

In some examples, the acoustic model is trained by extracting a Mel frequency cepstral coefficient (MFCC) feature and a filter bank (fbank) feature from the natural language command in the speech form. A model probability at a connectionist temporal classification (CTC) level is obtained after the acoustic model is trained by using the extracted features during acoustic model training. The language model is trained by using the data described above. Common tools include an SRI language modeling toolkit, a Ken language model toolkit (KenLM), and the like. A pronunciation dictionary is constructed, including all possible words and corresponding phoneme sequences. The pronunciation dictionary is in a format in which each line includes a word and a phoneme representation of the word. Then a speech recognition decoding word graph is constructed by using an image composition tool, for example, arpa2fst, fstcompose, or fstreduced.

Operation 1550: Perform input correction based on the LLM.

In an example, sample data for training the ASR system is generated by using the LLM, so that the ASR system is trained by using the sample data before the ASR system is applied; or the ASR system is periodically trained by using sample data during application of the ASR system; or the ASR system is trained in real time by using sample data during application of the ASR system.

For example, the LLM is an NLP model that is trained by using large-scale text data and that has high complexity and high performance. The LLM understands and generates a natural language command by using a deep learning technology, especially a transformer architecture. The LLM has excellent performance in various NLP tasks, such as text generation, translation, question-answering, and abstracting. Large-scale data training: The LLM is usually trained by using a large amount of text data, and the data may include billions or even trillions of words. Large-scale data enables the model to learn more abundant linguistic features and patterns. Complex model architecture: These models usually have a complex architecture, including a multi-layer transformer, an attention mechanism, and the like, to capture nuances in language. High performance: Because a large amount of data and a complex model architecture are used, the LLM usually has a high understanding and generation capability, and can perform well in various language tasks.

The LLM has a prompt. The prompt is initial input text provided for the LLM when the model is used to perform an NLP task. Design and selection of the prompt have important impact on output quality and accuracy of the model. Carefully designing the prompt can guide the model to generate text that better conforms to an expectation. To be specific, the prompt provides context information for the model, to help the model understand an intention of a user and generate related text. For example, given a prompt “Write an article about climate change”, the model generates an article related to climate change. An output style and format may be further controlled by using the prompt. For example, the prompt may include a specific instruction or format requirement, to help control the output style and format of the model. For example, the prompt is “Explain quantum mechanics in brief language”, to guide the model to generate concise and straightforward explanations.

In addition, the prompt may further include content of a previous conversation, to help the model understand a context of a current conversation and generate a more coherent reply. To design an effective prompt, the following several aspects need to be considered: Give an explicit instruction: The prompt is to include an explicit instruction to inform the model of a task that needs to be completed. For example, a prompt “Summarize main opinions of the following article” is clearer than a prompt “Summarize”. The prompt may further provide sufficient context information to help the model understand a task. For example, in a conversation system, the prompt may include content of a previous conversation. In addition, if there is a specific format requirement for an output, the requirement may be explicitly specified in the prompt. For example, the prompt is “List answers to the following questions in a form of a list”.

Provide a context based on an instruction, a conversation, a description, and the like of a player in a game: Sufficient context information is to be provided for the model, so that the model can generate a proper speech input. Use examples: Some examples are to be provided to guide the model to generate a similar output. Provide an explicit format: This is to ensure explicit descriptions in the prompt.

In some examples, a process of generating sample data based on the LLM is described below.

For example, it is assumed that a player may command an NPC in an adventure game through a natural language command in a speech form. Therefore, the LLM is expected to generate some possible sample data for more targeted training on a natural language analysis model.

In some examples, an instruction template may be preset to generate a text corpus through concatenation. For example, it is assumed that the template is a character string including a placeholder for inserting a specific player instruction parameter. The placeholder may be denoted as {}. For example, “{player_name} goes to {direction} {location} {action}” indicates that the player name (for example, a name of an NPC) is to go to a specific direction and a specific location to perform an action. It is assumed that the following player instruction parameters exist: player_name=“Teammate No. 1 goes to”; direction=“the front”; location=“forest”; and action=“to throw a grenade”. The instructions are concatenated to obtain template=“Teammate No. 1 {player_name} {location} {action}”: Teammate No. 1 goes to the front forest to throw a virtual grenade.

In some examples, it is assumed that the player is a player in an adventure game and may command a virtual character through a natural language command. Exemplary instructions are as follows: 1. Go north. 2. Attack the enemy in front. 3. Use the healing potion. 4. Open the backpack. 5. View the map. The instructions may command a virtual character.

Based on the instructions, some possible sample data in a speech form may be generated based on the LLM as data for training the natural language analysis model.

For example, if a to-be-generated speech input is expected to be more specific, more context information may be provided. For example, the following prompt is provided for the LLM: “You are a player in an adventure game. Your character is a soldier currently in a forest. You may command your character through a speech input instruction. The following are some exemplary instructions: 1. Go north. 2. Attack the enemy in front. 3. Use the healing potion. 4. Open the backpack. 5. View the map. Current game state: Character: soldier. Location: forest. Task: find hidden treasure. Now, generate some possible player speech inputs.”

For example, if a to-be-generated speech input is expected to be more diverse, more examples and different scenes may be added to the prompt. For example, the following prompt is provided for the LLM: “You are a player in an adventure game. Your character is a soldier currently in a forest. You may command your character through a speech input instruction. The following are some exemplary instructions: 1. Go north. 2. Attack the enemy in front. 3. Use the healing potion. 4. Open the backpack. 5. View the map. 6. “Pick up the gemstone on the ground.” 7. “Talk to the villager.” 8. “Enter the cave.” Current game state: soldier. Location: forest. Task: find hidden treasure. Now, generate some possible player speech inputs.”

In some examples, based on the prompt, the LLM may generate the following text: 1. Go east. 2. Attack the enemy with a fireball. 3. View the task log. 4. Drink a bottle of magic potion. 5. Search the nearby region. 6. “Trade with the merchant.” 7. “Enter the castle.” 8. “Wear a new sword”, and the like.

Through the foregoing process, text that simulates speaking of a player in a large quantity of scenes may be generated based on built-in human speaking habits of the LLM, and the text is used as sample data; and/or speech conversion is performed on text to obtain an input in a speech form as sample data, to train the natural language analysis model by using more abundant sample data.

In an example, text generated by the LLM is used as sample data, and the language model in the ASR system is updated by using the sample data before the ASR system is applied.

Operation 1560: Activate a language model at the game level to which the player belongs.

In an example, the HCLG includes a plurality of language models (G). The plurality of language models respectively correspond to the plurality of virtual scenes. Based on the first virtual scene in which the main control virtual character and/or the NPC are/is located, a first language model corresponding to the first virtual scene is determined from the plurality of language models (as described above, the first language sub-network corresponding to the first virtual scene is determined from the language network).

In some examples, the plurality of language models are models obtained through training based on corresponding virtual scenes. In a process of training the language models by using text generated by the LLM as sample data, text respectively corresponding to the plurality of virtual scenes is obtained, and language models corresponding to the virtual scenes are trained by using the text.

Operation 1570: The ASR system selects a language model during decoding.

For example, when performing decoding, the ASR system selects the first language model corresponding to the first virtual scene, to analyze, through the first language model, content inputted by a sound model.

In some examples, a plurality of speech units corresponding to a natural language command are obtained through the acoustic model in the ASR system. The speech unit is a basic constituent unit of a word pronunciation. A sequence matching relationship between the plurality of speech units and a selected word in the preset dictionary is analyzed through the language model in the ASR system to obtain a command analysis result in a text form, that is, a decoding result. The selected word includes at least the at least one first scene hot-word and a general word.

In an example, when a main control virtual character and/or an NPC controlled by a player move/moves between different buildings, spatial query logic provides complete location information, to help the player quickly determine a location of an enemy virtual character. For example, the main control virtual character and/or the NPC are/is outside a motel and hear/hears a virtual gunshot from the second floor of the motel, and a system prompts that “the virtual gunshot is on the second floor of the motel”. The player moves in a same building: When the player moves in a same building, the spatial query logic simplifies feedback information, and provides only information of a sub-area. For example, the main control virtual character and/or the NPC are/is on the first floor of the motel, an enemy virtual character is on the second floor, and the system prompts that “the enemy is on the second floor”. The player is in a same room: When the main control virtual character and/or the NPC and an enemy virtual character are in a same room, the spatial query logic provides more precise orientation information, to help the player make a quick response. For example, both the player and an enemy are on the second floor of the motel, and the system prompts that “the enemy is at the right front location”. Hierarchical feedback information helps the player understand a location of the enemy virtual character more intuitively, and provides most relevant location information based on different locations of the player.

In an example, during speech recognition in a game, different language models and scene hot-words are loaded based on different virtual scenes, to significantly improve accuracy and a response speed of speech recognition. The following describes operations and methods for achieving this objective.

First, a virtual scene in a current game needs to be recognized. A language model decoding word graph is loaded in the following several manners: (1) Game state detection: The first virtual scene in which the main control virtual character and/or the NPC are/is currently located is determined by detecting a state variable (for example, a player location, a task progress, or a current activity) of the game. (2) Event triggering: A scene is switched based on a specific event (for example, entering a specific area or starting a specific task), to determine the first virtual scene in which the main control virtual character and/or the NPC are/is located. (3) Player input: The player may actively indicate the current first virtual scene through speech or in another input mode.

Different language models are trained or selected for different virtual scenes. For example, a language model in a battle scene may pay more attention to words and phrases related to a virtual battle, and a language model in an exploration scene may pay more attention to words related to navigation and interaction.

A group of scene hot-words is generated based on a virtual element (for example, a virtual item or a virtual character) included in a line of sight, and these scene hot-words are most frequently triggered or most important words in a current player scene. For example, in a battle scene, hot-words may include “enemy”, “attack”, and “withdraw”; and in a transaction scene, hot-words may include “buy”, “sell”, and “item”.

For example, a corresponding language model and scene hot-word are dynamically loaded based on a recognized virtual scene.

When a scene change is detected, switching is performed to a language model for a corresponding virtual scene. This may be implemented by invoking an application programming interface (API) of a speech recognition engine. In addition, when the scene change is detected, a currently used hot-word list is updated, so that the speech recognition engine can recognize these words more accurately.

In an example, a decoding policy of the speech recognition system may be further dynamically adjusted based on a virtual scene in which the main control virtual character and/or the NPC are/is located in the game, to improve accuracy of speech recognition and user experience. The following describes some methods and operations.

For example, a scene in which the player is currently located is recognized and classified based on information such as a game state, a player location, and a current task.

In some examples, different decoding policies are defined based on different virtual scenes. These policies include: (1) Glossary adjustment: A glossary of speech recognition, namely, the selected word in the preset dictionary, is adjusted based on a virtual scene. (2) Language model adjustment: Different virtual scenes are processed by using different language models. (3) Confidence threshold adjustment: A confidence threshold of speech recognition is adjusted based on a virtual scene. For example, the confidence threshold is manually increased, and a candidate word sequence corresponding to a highest preset probability is used as an instruction output result only when a predicted probability is higher than the confidence threshold.

During running of the game, the decoder is dynamically adjusted, to dynamically adjust a decoding policy of a speech recognizer based on the virtual scene in which the main control virtual character and/or the NPC are/is located, to improve flexibility of decoding.

In an example, after the ASR system goes online, the language model in the ASR system may be continuously optimized and adjusted (or the sound model or the like may be adjusted) based on an actual use status of the player, to enable the ASR system to better adapt to requirements of different virtual scenes. Operations of optimizing the language model include: (1) Hot-word adjustment: Text recognized by ASR system is collected based on feedbacks and usage data of the player, and the text is automatically rewritten by a correction engine. The hot-word list is dynamically adjusted based on rewritten player text, to ensure that the hot-word list covers most commonly used and most important words, so that the first scene hot-word can be more accurately obtained subsequently. (2) Model update: The language model and/or the voice model are/is re-trained, and a model parameter is adjusted. (3) Testing and deployment: An updated model undergoes sufficient control testing to ensure performance and stability of the model. When the testing succeeds, a trained model may be deployed in the game. (4) Continuous iteration: Speech recognition is a continuous improvement process of periodically collecting and analyzing feedbacks and then updating the model to adapt to behavior of the player and a change in the game. Testing is performed in an actual game environment to collect data and feedbacks and continuously iterate and improve the speech recognition system, to improve accuracy of a command analysis result.

In an example, the method for adjusting the language model for speech recognition based on a virtual scene helps better understand and parse the natural language command in the speech form and select an appropriate language model from a pre-defined language model library. When a scene changes, the language model for analysis may be automatically adjusted. The process may be implemented by a preset language model management system. In addition, an effective feedback mechanism may be further established in the system. The player may provide feedbacks and correct a recognition error or add a new scene hot-word through a cloud LLM. These feedbacks are configured for updating and improving the natural language analysis model online, to adjust and update the hot-words and the language model in a timely manner. In addition, to ensure reliability and stability of the system, offline testing and evaluation may be further performed by using an existing LLM. Automatic system testing and player data feedback are performed in different scenes, and the hot-words and the language model are further optimized based on testing feedback data to meet requirements of different scenes. For example, when the player enters a city room, “turn on the light”, “turn off the light”, and “increase the temperature” may be scene hot-words of the virtual indoor scene.

The foregoing are merely examples. This is not limited in examples of this disclosure.

Operation 1580: Perform behavioral intention recognition based on the command analysis result outputted by the language model, and control, based on a behavioral intention, the NPC to perform a virtual activity.

For example, behavioral intention recognition is performed on the command analysis result in the text form through a hierarchical prediction network to determine a behavioral intention corresponding to the command analysis result, and the NPC is controlled, based on the behavioral intention, to perform a virtual activity that conforms to the behavioral intention.

In an example, for example, a virtual environment includes a main control virtual character and an NPC, that is, a virtual soldier. A process of obtaining the command analysis result in the text form based on the natural language command in the speech form is described below.

For example, as shown in FIG. 16, a virtual environment includes a main control virtual character 1610 manually controlled by a player, and a virtual soldier 1611 (referred to as No. 1) and a virtual soldier 1612 (referred to as No. 2) that are controlled through speech.

In some examples, after a natural language command is received, it is determined that a first virtual scene in which the main control virtual character 1610 is located is a “virtual outdoor scene”, and at least one first scene hot-word corresponding to the first virtual scene is obtained, including “truck”, “virtual grass”, “virtual house”, “enter”, “open the truck”, “defense”, “desert”, “attack”, “oak tree”, “stable”, and the like.

Without a constraint of the first scene hot-word, the natural language command is likely to be recognized as “No. 1, go to the front to make a sound”. However, the natural language command is converted into a command analysis result in a text form based on the at least one first scene hot-word, and the obtained command analysis result is “No. 1, go to the front for defense”. Intention recognition is performed on the command analysis result to obtain the behavioral intention “go to the front for defense”, so that the virtual soldier 1611 can be specially commanded to move to the front for defense, to prevent an enemy virtual character from attacking the main control virtual character first.

Alternatively, without a constraint of the first scene hot-word, the natural language command is likely to be recognized as “No. 2, go to explore the mountain”. However, the natural language command is converted into a command analysis result in a text form based on the at least one first scene hot-word, and the obtained command analysis result is “No. 2, go to explore the desert”. Intention recognition is performed on the command analysis result to obtain the behavioral intention “explore the desert”, so that the virtual soldier 1612 can be specially commanded to move to a location of the desert to check whether a virtual element such as an enemy virtual character or a virtual treasure box exists.

Alternatively, without a constraint of the first scene hot-word, the natural language command is likely to be recognized as “No. 1 and No. 2, go to provide” . However, the natural language command is converted into a command analysis result in a text form based on the at least one first scene hot-word, and the obtained command analysis result is “No. 1 and No. 2, go to attack”. Intention recognition is performed on the command analysis result to obtain the behavioral intention “attack”, so that the virtual soldier 1611 and the virtual soldier 1612 can be specially commanded to perform virtual attacks against a nearby attackable virtual character.

Alternatively, without a constraint of the first scene hot-word, the natural language command is likely to be recognized as “No. 1, go to find an item book nearby” . However, the natural language command is converted into a command analysis result in a text form based on the at least one first scene hot-word, and the obtained command analysis result is “No. 1, go to find an oak tree nearby”. Intention recognition is performed on the command analysis result to obtain the behavioral intention “find an oak tree”, so that the virtual soldier 1611 can be specially commanded to find an oak tree in a nearby area, to complete a game task or find an oak tree for evading an attack.

Alternatively, without a constraint of the first scene hot-word, the natural language command is likely to be recognized as “No. 1 and No. 2, go there. It'll be done soon.” However, the natural language command is converted into a command analysis result in a text form based on the at least one first scene hot-word, and the obtained command analysis result is “No. 1 and No. 2, go to the stable there”. Intention recognition is performed on the command analysis result to obtain the behavioral intention “search for a stable”, so that the virtual soldier 1611 and the virtual soldier 1612 can be specially commanded to search for a nearby stable and specially move to a location of the stable.

The foregoing are merely examples. This is not limited in examples of this disclosure.

An example of this disclosure provides a virtual character control method. The method includes the following operations:
Display at least one of a main control virtual character and an NPC that are located in a virtual environment.

For example, the main control virtual character is a virtual character directly controlled by a user in the virtual environment. One or more NPCs further exist in the virtual environment. The NPC and the main control virtual character belong to a same virtual camp. The NPC is a teammate of the main control virtual character, and the NPC follows the main control virtual character in the virtual environment for movement. In addition, the NPC may alternatively be a follower character, a pet character, or the like controlled by the main control virtual character. In addition, the NPC may alternatively be a neutral character, and perform a cooperative action with the main control virtual character only when a specific condition is met.
Obtain a natural language command.

For example, the natural language command includes natural semantics for commanding the NPC. The NPC is commanded by the natural language command in a virtual scene. The natural language command may be directly inputted by the user, or may be extracted from speech information inputted by the user. A manner of obtaining the natural language command is not limited in this application.

The natural language command includes at least one of a behavioral intention and a scene entity. The behavioral intention is configured for indicating a type of a virtual activity to be performed by the NPC, for example, configured for indicating a specific type of a virtual activity to be performed in the virtual environment. The scene entity includes a first scene object, for example, is configured for indicating a specific scene object on which the virtual activity is to be performed in the virtual environment. The behavioral intention and the scene entity included in the natural language command are a part of words in the natural language command.

In an example, the natural language command controls the NPC from two aspects: a specific type of a virtual activity to be performed, and a specific scene object on which the virtual activity is to be performed in the virtual environment. The natural language command is a complex instruction for controlling the NPC.
In response to the natural language command, control the NPC to perform a virtual activity.

For example, controlling the NPC to perform the virtual activity is determined based on environmental perception information of the main control virtual character and/or the NPC. In some examples, the main control virtual character and/or the NPC obtain/obtains the environmental perception information within a perception range of a visual perception mode, an auditory perception mode, a motion trajectory perception mode, or the like. For example, the virtual activity is in line with a current perception status of the main control virtual character and/or the NPC for the virtual environment, and the NPC is controlled based on the current perception status of the main control virtual character and/or the NPC for the virtual environment. For example, the NPC has an autonomous behavioral capability, and the user only commands the NPC. The user provides a command, and the NPC understands and executes the command based on the autonomous behavioral capability of the NPC.

To sum up, in the method provided in this example, a virtual activity to be performed is determined with reference to the environmental perception information of the main control virtual character and/or the NPC based on a complex instruction for controlling the NPC from two aspects: a specific type of the virtual activity to be performed, and a specific scene object on which the virtual activity is to be performed in the virtual environment. Using the environmental perception information of the main control virtual character and/or the NPC as reference ensures that the NPC and the main control virtual character cooperatively perform the virtual activity.

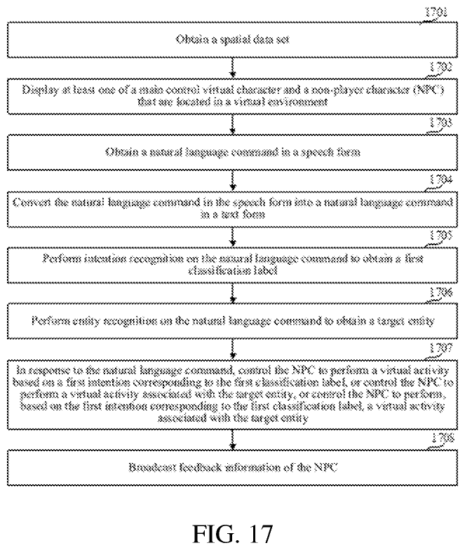

FIG. 17 is a flowchart of a virtual character control method according to an example of this application. The method includes the following operations:

Operation 1701: Obtain a spatial data set.

The spatial data set of a virtual environment includes a visual label of a scene object. The visual label is configured for describing a visual feature of the scene object in at least one dimension, for example, describing the scene object in material, transparency, color, and shape dimensions.

Operation 1702: Display at least one of a main control virtual character and an NPC that are located in the virtual environment.

For example, the main control virtual character is a virtual character directly controlled by a user in the virtual environment. One or more NPCs further exist in the virtual environment. The NPC and the main control virtual character belong to a same virtual camp. The NPC is a teammate of the main control virtual character.

Operation 1703: Obtain a natural language command in a speech form.

The natural language command includes natural semantics for commanding the NPC, and command information includes a behavioral intention and a scene entity. The behavioral intention is configured for indicating a type of a virtual activity to be performed by the NPC, and the scene entity is configured for indicating a target entity targeted by the virtual activity.

Operation 1704: Convert the natural language command in the speech form into a natural language command in a text form.

For example, speech-to-text conversion (ASR) is performed on the natural language command in the speech form to determine the natural language command in the text form. The speech-to-text conversion usually includes invoking components such as an acoustic model and a language model to recognize a pronunciation, a vocabulary, a grammatical structure, and other information of the natural language command in the speech form, and converting the natural language command in the speech form into the natural language command in the text form.

Operation 1705: Perform intention recognition on the natural language command to obtain a first classification label.

For example, a first intention corresponding to the first classification label indicates a command intention for the NPC in one intention dimension, for example, including at least one of the following: indicating a specific role of an NPC commanded by command text among a plurality of NPCs, indicating whether a virtual activity performed by the NPC is related to initiating a virtual attack, or indicating a specific virtual activity performed by the NPC.

Operation 1706: Perform entity recognition on the natural language command to obtain the target entity.

The target entity is determined from the virtual environment based on environmental perception information, and the environmental perception information includes information perceived by at least one of the main control virtual character and the NPC from the virtual environment. The target entity may be an entity currently seen by a player, or may be an entity historically seen by the player.

Operation 1707: In response to the natural language command, control the NPC to perform a virtual activity based on the first intention corresponding to the first classification label, or control the NPC to perform a virtual activity associated with the target entity, or control the NPC to perform, based on the first intention corresponding to the first classification label, a virtual activity associated with the target entity.

For example, the NPC is controlled, based on the indication of the first classification label and/or the target entity, to perform the virtual activity.

Operation 1708: Broadcast feedback information of the NPC.

For example, a game application may generate corresponding feedback information in real time based on environmental perception information of the NPC, and broadcast the feedback information. For example, when the environmental perception information of the NPC triggers a broadcast condition, the game application may generate the corresponding feedback information in real time based on the environmental perception information that triggers the broadcast condition; or when the NPC or the main control virtual character trigger a broadcast condition, the game application may generate the corresponding feedback information in real time based on the environmental perception information of the NPC.

A preprocessing stage in operation 1701 may be implemented as follows:

Sub-operation 1: Obtain attribute text of a scene object in a virtual scene.

For example, the attribute text is configured for describing an inherent attribute of the scene object in the virtual scene. In one aspect, the attribute text implements description of the scene object in a literal modality, and provides semantic information for prediction of a visual label of the scene object while describing the scene object. In another aspect, the attribute text is a description of the scene object in the virtual scene. When a large quantity of scene objects exist in the virtual scene and an object model is reused, the inherent attribute of the scene object in the virtual scene can be more accurately described.

In an exemplary implementation, the attribute text includes at least one of the following: a name of the scene object in the virtual scene or a size of the scene object in the virtual scene.

Sub-operation 2: Obtain an appearance image of the scene object in the virtual scene.

For example, the appearance image is configured for describing a style of the scene object. The appearance image carries, in a picture modality, an appearance style such as a color, a texture, and a shape of the scene object, and a mutual location relationship between subparts, so that the scene object can be comprehensively described in the picture modality (also referred to as a visual modality). In an exemplary implementation, the appearance image of the scene object includes images obtained by observing the scene object from at least two angles of view.

Sub-operation 3: Invoke a multi-modal model to perform prediction on the attribute text and the appearance image of the scene object to obtain the visual label of the scene object.

For example, the multi-modal model has a capability of performing model prediction on text information and picture information in different modalities. In this example, input parameters of the multi-modal model are the attribute text and the appearance image of the scene object. The multi-modal model predicts the visual label of the scene object in two modalities: a text modality and the picture modality. The visual label is configured for describing a visual feature of the scene object in at least one dimension.

In some examples, the multi-modal model includes a visual question-answering model. A question statement carries the attribute text of the scene object. The question statement is configured for guiding the visual question-answering model to convert the appearance image into the visual label of the scene object. In addition, the question statement provides supplementary information of the scene object in a text form while guiding conversion of the visual label of the scene object.

Obtain expected information of the scene object.

For example, the expected information is configured for indicating an expected description dimension of the scene object in the visual label and/or an expected format of the visual label. In an example, the expected information is configured for indicating that the expected description dimension of the scene object in the visual label includes, but is not limited to, at least one of a type description, a material, transparency, a color, a surface feature, or a shape of the scene object. In another example, the expected information is configured for indicating that the expected format of the visual label is at least one of the following: a comma separated value (CSV) file, JavaScript object notation (JSON), or extensible markup language (XML).

Construct a question statement about the appearance image based on the expected information and the attribute text.

For example, a first subpart in the question statement is supplementary introduction information of the scene object and carries the attribute text of the scene object, and a second subpart in the question statement is an answer guiding statement for the visual question-answering model and carries the expected information.

In some examples, the spatial data set includes a matching label of the scene object in the virtual scene. Correspondingly, quasi-colloquial rewriting is performed on the visual label of the scene object to obtain a matching label that conforms to oral expression of natural language.

For example, as described above, the visual label is configured for describing a visual feature of the scene object in at least one dimension, and the appearance image of the scene object shows abundant visual features of the scene object. However, in the oral expression of the natural languages, descriptions of the scene object cannot cover visual features of the scene object in all dimensions. An objective of performing quasi-colloquial rewriting on the visual label of the scene object is to obtain a matching label closer to the oral expression. Performing quasi-colloquial rewriting may be deleting a part of content in the visual label, or changing the visual label into a label that has same semantics but has a different text expression.

In an exemplary implementation, quasi-colloquial rewriting is performed by invoking a natural language model. The visual label of the scene object is input to the natural language model, to perform prediction to obtain the matching label that conforms to the oral expression of the natural language. Performing quasi-colloquial rewriting on the visual label is implemented based on the invocation of the natural language model. For example, the natural language model carries priori knowledge about the oral expression of the natural language. For example, the natural language model is implemented as an LLM.

In some examples, the spatial data set further includes spatial information of the scene object. Correspondingly, the following operations are further included:

Obtain a spatial location of the scene object in the virtual scene, and determine the spatial location of the scene object as assistance information of the visual label of the scene object.

For example, the spatial location of the scene object in the virtual scene is configured for indicating a deployment status of the scene object in the virtual scene, and the spatial information is configured for indicating a location, a size, or other information of the scene object in the virtual scene after the scene object is deployed in the virtual scene.

Further, obtain at least one of a coordinate location, rotation information, bounding box information, and cover point information of the scene object in the virtual scene. The coordinate location is configured for indicating a location of the scene object in the virtual scene, for example, coordinate information of a center point or a preset point of the scene object in the virtual scene. The rotation is configured for indicating a direction that the scene object faces in the virtual scene, for example, a direction that a front side of the scene object faces in the virtual scene. The bounding box is configured for indicating a size of the scene object in the virtual scene. The cover point is configured for indicating a virtual character location point recommended when a virtual character approaches the scene object, to enable the scene object to cover the virtual character.

An intention recognition stage in operation 1705 may be implemented as follows:

Sub-operation 4: Invoke at least one hierarchical prediction network to perform intention recognition on the natural language command to obtain the first classification label of an intention of the natural language command to command the NPC.

For example, the hierarchical prediction network has a capability of predicting a classification label corresponding to the command text. For example, the hierarchical prediction network includes at least two layers of sub-networks, an upper-layer network and a lower-layer network are cascaded, and the lower-layer network further performs prediction on the classification label based on a prediction result outputted by the upper-layer network. The at least two layers of sub-networks are constructed based on a tree structure of a plurality of classification labels. In the hierarchical prediction network, the at least two layers of sub-networks of a corresponding hierarchical structure are constructed based on the tree structure of the classification labels. A prediction task for a large variety of classification labels is split into prediction sub-tasks to be performed by the at least two layers of sub-networks, to reduce complexity of classification prediction in each layer of sub-network.

In an exemplary implementation, each of the at least one hierarchical prediction network is configured for predicting a command intention of the command text for the NPC in one intention dimension. The intention dimension includes at least one of a subject dimension, a semantic dimension, or a behavior dimension. For example, an i^{th}-layer sub-network in each of the at least one hierarchical prediction network is configured for predicting a first-level behavior label of the command text in one intention dimension, and an (i+1)^{th}-layer sub-network in the hierarchical prediction network is configured for predicting a second-level behavior label corresponding to the command text in the first-level behavior label, where i is a positive integer. A higher-layer behavior label (for example, the first-level behavior label) obtained through prediction by a higher-layer sub-network (for example, the i^{th}-layer sub-network) in the hierarchical prediction network includes a plurality of sub-labels, also referred to as subordinate lower-layer labels. A corresponding lower-layer sub-network (for example, the (i+1)^{th}-layer sub-network) needs to be invoked to further perform classification prediction (for example, obtain the second-layer behavior label through prediction). A prediction task for a large variety of classification labels is split into prediction sub-tasks to be performed by at least two layers of sub-networks, to reduce complexity of classification prediction in each layer of sub-network.

Further, the intention dimension includes the subject dimension, the hierarchical prediction network includes a subject prediction network of a hierarchical structure, and the subject prediction network has a capability of predicting a subject type in the natural language command. The subject type is configured for representing an identity of the NPC commanded by the natural language command. For example, the subject prediction network is configured for predicting a specific role of the NPC commanded by the command text among a plurality of NPCs, and there may be one or more NPCs commanded by the command text.

Additionally/Alternatively, the intention dimension includes the semantic dimension, the hierarchical prediction network includes a semantic prediction network of a hierarchical structure, and the semantic prediction network has a capability of predicting a semantic type in the natural language command. The semantic type is configured to represent a control mode of the NPC for initiating a virtual attack. For example, the semantic prediction network is configured to predict whether a virtual activity performed by the NPC commanded by the command text is related to initiating a virtual attack.

Additionally/Alternatively, the intention dimension includes the behavior dimension, the hierarchical prediction network includes a behavior prediction network of a hierarchical structure, and the behavior prediction network has a capability of predicting a behavior type in the natural language command. The behavior type is configured for representing a behavior mode of the NPC for performing a virtual activity. For example, the behavior prediction network is configured for predicting a specific virtual activity to be performed by the NPC.

Correspondingly, in operation 1707, in response to the natural language command, the NPC is controlled to perform the virtual activity based on the first intention corresponding to the first classification label.

For example, the first intention corresponding to the first classification label indicates a command intention for the NPC in one intention dimension, for example, including at least one of the following: indicating a specific role of the NPC commanded by the command text among a plurality of NPCs, indicating whether a virtual activity performed by the NPC is related to initiating a virtual attack, or indicating a specific virtual activity performed by the NPC. The NPC is controlled, based on the indication of the first classification label, to perform the virtual activity.

A target entity recognition process in operation 1706 may be implemented as follows:

Sub-operation 5: Query the target entity from an entity set of the virtual environment based on the environmental perception information and target entity information of the target entity that is expressed by the natural language command.

The target entity is determined from the virtual environment based on the environmental perception information, and the environmental perception information includes information perceived by the main control virtual character and/or the NPC from the virtual environment.

The target entity information in the natural language command is usually vague. For example, the natural language command may be “Move to the red truck”, and the target entity information in the natural language command is “red truck”. However, there may be many red trucks in the virtual environment, and the target entity cannot be accurately determined from the virtual environment only based on the target entity information in the natural language command.

Therefore, this example of this disclosure provides a method for determining the target entity based on the target entity information and the environmental perception information. For the foregoing example, the “red truck” expressed by the player in the natural language command is a red truck visible to the player. Therefore, a red truck located within an FOV of the main control virtual character may be selected from a plurality of red trucks in the virtual environment based on the FOV of the main control virtual character, and the red truck is the target entity specified by the player in the natural language command.

Because the natural language command is delivered by the player based on perception for the virtual environment, to accurately recognize the target entity indicated in the natural language command, the game application recognizes the target entity in the natural language command based on the environmental perception information obtained when the player delivers the natural language command. Based on the perception of the player for the virtual environment, an entity in the virtual environment that is most approximate to the target entity information and that can be perceived by the player is obtained through inference, and is the target entity.

For example, the virtual environment includes a plurality of candidate entities matching the natural language command, and the target entity is an entity selected from the plurality of candidate entities based on environmental perception information of the main control virtual character or the NPC. For example, the game application first selects a plurality of candidate entities matching the target entity information in the natural language command from the entity set, and then selects, based on the environmental perception information, an entity that can be perceived by the main control virtual character or the NPC from the plurality of candidate entities as the target entity.

For example, the environmental perception information of the main control virtual character may include: a picture or an entity that the main control virtual character can see when observing the virtual environment, an environmental sound effect that the main control virtual character can hear, a source direction of the environmental sound effect, a type and a sound volume of the environmental sound effect, perception information (for example, visual information, auditory information, sound wave information, or light reflection information) obtained by the main control virtual character by using a perceptual skill, and perception information (for example, a sensing signal of a sensor and a positioning signal of a positioning prop) obtained by the main control virtual character by using a perceptual item.

The environmental perception information of the NPC may include: a picture or an entity that the NPC can see when observing the virtual environment, an environmental sound effect that the NPC can hear, a source direction of the environmental sound effect, a type and a sound volume of the environmental sound effect, perception information (for example, visual information, auditory information, sound wave information, or light reflection information) obtained by the NPC by using a perceptual skill, and perception information (for example, a sensing signal of a sensor and a positioning signal of a positioning prop) obtained by the NPC by using a perceptual item.

The environmental perception information may include information perceived by the main control virtual character and the NPC in real time when the natural language command is received, or may include information historically perceived by the main control virtual character and the NPC before the natural language command is received. That is, the target entity may be an entity currently seen by the player, or may be an entity historically seen by the player. Therefore, the game application needs to recognize the target entity based on real-time environmental perception information and historical environmental perception information of the main control virtual character and/or the NPC.

For example, when the natural language command is “Let's go back to the hotel that we just passed by”, the game application needs to query, based on historical environmental perception information of the main control virtual character, a hotel that the main control virtual character passed by.

In an example, a client queries the target entity from the entity set of the virtual environment based on the environmental perception information and the target entity information expressed by the natural language command. In another example, a client reports the natural language command to a server, and the server queries the target entity from the entity set of the virtual environment based on the environmental perception information and the target entity information expressed by the natural language command.

In some examples, the game application obtains the target entity through inference based on the target entity information, the environmental perception information, and preprocessed virtual environment data. The preprocessed virtual environment data includes the entity set of the virtual environment.

The entity set includes entity information of each entity in the virtual environment. The entity information includes at least one of the following: a name, a type, a location, a feature, a text label, an embedding vector of a text label, an image, or an embedding vector of an image.

The text label may be at least one word obtained through word segmentation on a feature (for example, description text of an entity appearance), and an embedding model is invoked to obtain an embedding vector corresponding to each text label.

The image may include an image obtained by observing a three-dimensional model of an entity from at least one direction. For example, the image may include a three-view diagram of the entity. The embedding vector of the image is an embedding vector of an image feature label. The image feature label is obtained by invoking the multi-modal model to perform feature recognition based on an image and a text label of an entity.

For example, the entity set includes a first type of entity and a second type of entity, the first type of entity includes at least one of an area and a building, and the second type of entity includes an entity object. A text label of the first type of entity is manually marked. For example, a text label of a room of a building is manually marked as an area, a building, a floor, or a room. A text label of the second type of entity is automatically generated by invoking the LLM.

A method for generating the text label of the second type of entity may include: obtaining at least one image of an entity, and inputting the at least one image to the LLM to obtain description text of the entity; performing word segmentation on the description text to obtain at least one text label of the entity, each text label including one word obtained through word segmentation; and performing a vectorization operation on the text label to obtain an embedding vector corresponding to the text label.

The embedding vector is high-dimensional vector data of the text label. The embedding vector of the text label is pre-generated. When the target entity is determined from the entity set through matching based on the target entity information, vector generation does not need to be repeatedly performed on a text label of each entity, to improve efficiency of matching between the target entity information and entity information.

In this method, the description text is not directly used as the text label but a word segmentation result of the description text is used as the text label because the description text usually has different lengths. For long description text, an embedding vector of the description text has poor effect in similarity comparison during an actual search. For example, when “a blue pickup truck with a rusty body” is searched for by using “truck”, “a blue pickup truck with a rusty body” is probably ranked behind “a car” in a recall result. However, for the “truck” that is searched for, regardless of how complex an additional description is, the “truck” actually needs to be preferentially searched for. Therefore, feature words, rather than description text, are to be used for comparison during a similarity search.

In addition, to further extract an image feature of the entity, in the method provided in this application, a hidden visual feature in the image of the entity may be further extracted based on the text label and the image of the entity. A first entity is used as an example. The method includes: obtaining at least one perspective image of the first entity; obtaining at least one text label of the first entity; and invoking the multi-modal model to extract an image feature of the first entity based on the at least one perspective image and the at least one text label of the first entity, to obtain an image embedding vector of the first entity.

The text label is manually marked or generated by the LLM based on characteristics of human language. However, some features of an entity may be ignored in a text label extracted based on human language habits. For example, when a text label is manually marked for an oil drum, only more attention-getting text labels such as “metal” and “rusty” may be marked, and detailed features such as “rusty”, “blue”, “yellow”, and “painting peeling off in the lower right corner” are ignored. Therefore, in the method provided in this application, the multi-modal model is further used. The multi-modal model extracts more image features based on the text label of the entity and the entity image. Image similarity matching between the image features and the target entity is performed, to improve recognition accuracy of the target entity.

A method for training the multi-modal model may be: inputting a sample entity image and a sample label to a pre-trained multi-modal model; and fine-tuning the pre-trained multi-modal model based on a loss between a predicted label outputted by the pre-trained multi-modal model and the sample label, to obtain a multi-modal model that can output an image feature label based on an inputted text label and image, where the image feature label includes more detailed description text extracted from the image. For example, a text description of “a metal oil drum” can be associated only with two text labels: “metal” and “oil drum”. However, a clip (multi-modal) model can further recognize, from an image of an oil drum, hidden visual information in the image, for example, image feature labels “rusty”, “blue”, and “yellow”. These image features are features absent in the text labels. Therefore, performing an image feature search based on the clip model can further improve accuracy of an entity search.

In an example, the game application may query the target entity by using the following method:

(1) Parse the natural language command to obtain the target entity information. The target entity information includes at least one of the following: an entity type, an entity name, an entity orientation, or an entity feature.

In some examples, the game application invokes the LLM to parse the natural language command to obtain the target entity information of the target entity. The embedding model is invoked to vectorize the target entity information to obtain a target embedding vector of the target entity information.

For example, the natural language command is “Come here to the blue truck in the front”. In this case, the target entity information that can be parsed out by the LLM includes orientation information “front” and an entity name “blue truck”.

For example, a named entity recognition technology in the NLP field may alternatively be invoked to extract the target entity information from the natural language command. The named entity recognition technology is configured for recognizing an entity with a specific meaning in text, for example, recognizing a person name, a location name, an orientation word, or an adjective.

For example, the natural language command is “Go to the back of the red sofa on the first floor of the motel to find a cardboard box”, and the following may be recognized by using the named entity recognition technology: a building name “the first floor of the motel”, item names “sofa” and “cardboard box”, an orientation word “back”, and an adjective “red”. A hierarchical scene query invocation form with a search type, content, an orientation word, and constraint information may be formed through logical construction. The search type is configured for narrowing a data retrieval range based on similarity matching. The search content is a specific entity description. The adjective is combined into the description text for querying. The orientation word is configured for forming a constraint on a search range. A floor constraint is determined by a location of the player. In an indoor scene, an up-down range needs to be narrowed, to avoid finding an invisible entity across floors.

(2) Calculate a similarity between the target entity information and each piece of entity information in the entity set.

For example, the entity set includes entity information of at least one entity, and entity information of each entity may include at least one of a text embedding vector of a text label or an embedding vector of an image feature. In this case, a similarity between the target entity information and the text embedding vector and a similarity between the target entity information and the image embedding vector may be separately calculated, and an entity with a high similarity is determined as the target entity.

A method for similarity matching against the text embedding vector and a method for similarity matching against the image embedding vector are separately provided below.

1. The similarity includes a text similarity between the target entity information and the text embedding vector.

The first entity in the entity set is used as an example. The game application (the client or the server) performs word segmentation on the target entity information to obtain at least one target entity label; converts the at least one target entity label into at least one target embedding vector; obtains entity information of the first entity, the entity information including a text embedding vector, and the text embedding vector being an embedding vector obtained based on conversion of a text label of the first entity; separately calculates a text parent-similarity between the at least one target embedding vector and the text embedding vector to obtain at least one text parent-similarity respectively corresponding to the at least one target embedding vector; and determines a sum of the at least one text parent-similarity as a text similarity between the target entity information and the entity information of the first entity.

For example, there are two target entity labels: a target entity label 1 and a target entity label 2; there are also two entities in the entity set: an entity 1 and an entity 2; the entity 1 corresponds to a text embedding vector 1; and the entity 2 corresponds to a text embedding vector 2. In this case, a similarity 1 between the target entity label 1 and the text embedding vector 1 is calculated, a similarity 2 between the target entity label 2 and the text embedding vector 1 is calculated, and a sum of the similarity 1 and the similarity 2 is determined as a text similarity between the target entity information and the entity 1. A similarity 3 between the target entity label 1 and the text embedding vector 2 is calculated, a similarity 4 between the target entity label 2 and the text embedding vector 2 is calculated, and a sum of the similarity 3 and the similarity 4 is determined as a text similarity between the target entity information and the entity 2.

For example, the entity information of the first entity includes at least one text embedding vector, and the at least one target embedding vector includes a first target embedding vector. In this case, the game application separately calculates a text sub-similarity between the first target embedding vector and the at least one text embedding vector to obtain at least one text sub-similarity, and determines a largest one of the at least one text sub-similarity as a text parent-similarity corresponding to the first target embedding vector.

For example, there is one target entity label: a target entity label 1; there is also one entity in the entity set: an entity 1; and the entity 1 corresponds to a text embedding vector 1 and a text embedding vector 3. In this case, a similarity 1 between the target entity label 1 and the text embedding vector 1 is calculated, a similarity 5 between the target entity label 1 and the text embedding vector 3 is calculated, and a larger one of the similarity 1 and the similarity 5 is determined as a similarity between the target entity information (the target entity label 1) and the entity 1.

For example, for inputted target entity information “blue vehicle”, word segmentation is first performed on the target entity information to decompose the target entity information into target entity labels “blue” and “vehicle”, indicating that a queried target entity has two features. Then a similarity between each feature and each entity in the entity set is separately calculated, and a largest one of similarities is selected for each feature. Finally, a sum of similarity scores corresponding to all query features is obtained, to represent a text similarity between the target entity information and the queried entity.

For example, the target entity information includes two target entity labels: “blue” and “vehicle”. The two target entity labels are converted into two target embedding vectors. Then entity information in the entity set is obtained. For example, the entity set includes an entity 1 and an entity 2, text labels of the entity 1 include “metal”, “old”, “vehicle”, “truck”, “blue”, and “damaged”, and text labels of the entity 2 include “metal”, “scratch”, “vehicle”, “damaged”, “cash-in-transit vehicle”, and “black”.

A text similarity between the target entity information and the entity 1 is calculated: First, a similarity between the target entity label “blue” and each text label of the entity 1 is separately calculated, and a maximum value is obtained. For example, a similarity value between the target entity label “blue” and the text label “blue” of the entity 1 is 1 (1 is the maximum value). Then a similarity between the target entity label “vehicle” and each text label of the entity 1 is separately calculated, and a maximum value is obtained. For example, a similarity value between the target entity label “vehicle” and the text label “vehicle” of the entity 1 is 1. Then a sum of the two similarities of the target entity labels “vehicle” and “blue” is obtained, to learn that a final similarity between the target entity information and the entity 1 is 2.

Similarly, a text similarity between the target entity information and the entity 2 is calculated: First, a similarity between the target entity label “blue” and each text label of the entity 2 is separately calculated, and a maximum value is obtained. For example, a similarity value between the target entity label “blue” and the text label “black” of the entity 2 is 0.91. Then a similarity between the target entity label “vehicle” and each text label of the entity 2 is separately calculated, and a maximum value is obtained. For example, a similarity value between the target entity label “vehicle” and the text label “vehicle” of the entity 2 is 1 (1 is the maximum value). Then a sum of the two similarities of the target entity labels “vehicle” and “blue” is obtained, to learn that a final similarity between the target entity information and the entity 2 is 1.91.

It can be learned that the similarity 2 between the target entity information and the entity 1 is higher than the similarity 1.91 between the target entity information and the entity 2. 2. The similarity includes an image similarity between the target entity information and the image embedding vector.

The first entity in the entity set is used as an example. The game application (the client or the server) performs word segmentation on the target entity information to obtain at least one target entity label; converts the at least one target entity label into at least one target embedding vector; obtains entity information of the first entity, the entity information including an image embedding vector, and the image embedding vector being an embedding vector extracted based on an image of the first entity; separately calculates an image parent-similarity between the at least one target embedding vector and the image embedding vector to obtain at least one image parent-similarity respectively corresponding to the at least one target embedding vector; and determines a sum of the at least one image parent-similarity as an image similarity between the target entity information and the entity information of the first entity.

For example, there are two target entity labels: a target entity label 1 and a target entity label 2; there are also two entities in the entity set: an entity 1 and an entity 2; the entity 1 corresponds to an image embedding vector 1; and the entity 2 corresponds to an image embedding vector 2. In this case, a similarity 1 between the target entity label 1 and the image embedding vector 1 is calculated, a similarity 2 between the target entity label 2 and the image embedding vector 1 is calculated, and a sum of the similarity 1 and the similarity 2 is determined as an image similarity between the target entity information and the entity 1. A similarity 3 between the target entity label 1 and the image embedding vector 2 is calculated, a similarity 4 between the target entity label 2 and the image embedding vector 2 is calculated, and a sum of the similarity 3 and the similarity 4 is determined as an image similarity between the target entity information and the entity 2.

For example, the entity information of the first entity includes at least one image embedding vector, and the at least one target embedding vector includes a first target embedding vector. In this case, the game application separately calculates an image sub-similarity between the first target embedding vector and the at least one image embedding vector to obtain at least one image sub-similarity, and determines a largest one of the at least one image sub-similarity as an image parent-similarity corresponding to the first target embedding vector.

For example, there is one target entity label: a target entity label 1; there is also one entity in the entity set: an entity 1; and the entity 1 corresponds to an image embedding vector 1 and an image embedding vector 3. In this case, a similarity 1 between the target entity label 1 and the image embedding vector 1 is calculated, a similarity 5 between the target entity label 1 and the image embedding vector 3 is calculated, and a larger one of the similarity 1 and the similarity 5 is determined as a similarity between the target entity information (the target entity label 1) and the entity 1.

In an example, the image similarity may be calculated by using a target image embedding vector. To be specific, the target embedding vector in the foregoing method is replaced with the target image embedding vector. The target image embedding vector may be obtained by using the following method: performing word segmentation on the target entity information to obtain at least one target entity label, and inputting the at least one target entity label to the multi-modal model to obtain the target image embedding vector.

3. The similarity includes a text similarity and an image similarity.

When the first entity and the target entity correspond to a text similarity and an image similarity, the game application determines an average value of the text similarity and the image similarity as a similarity between the first entity and the target entity.

Alternatively, when the first entity and the target entity correspond to a text similarity and an image similarity, a larger one of the text similarity and the image similarity is determined as a similarity between the first entity and the target entity.

Alternatively, when the first entity and the target entity correspond to a text similarity and an image similarity, a sum of the text similarity and the image similarity is determined as a similarity between the first entity and the target entity.

(3) Determine the target entity from the entity set based on the similarity and the environmental perception information.

In an example, the game application first performs similarity search based on the target entity information to obtain at least one candidate entity with a high similarity, and sorts the at least one candidate entity by similarity; and then performs perceptual filtering and sorting based on a location, an orientation, a rotation, or other information of the main control virtual character and/or the NPC, to finally select the target entity.

For example, the game application determines a target perception range based on the target entity information and the environmental perception information, and selects, based on the similarity, the target entity from entities perceived in the target perception range.

Alternatively, the game application determines x entities with highest similarities from the entity set based on the similarity, to form a candidate entity list, determines a target perception range based on the target entity information and the environmental perception information, and determines an entity, among the x entities, that is within the target perception range as the target entity, where x is a positive integer.

For example, the game application determines an entity with a highest similarity in the perception range as the target entity.

When there are a plurality of entities with equal similarities in the target perception range, the plurality of entities may be sorted based on distances between the entities and the main control virtual character. For example, when there are at least two entities with highest similarities in the perception range, an entity, in the perception range, that has a highest similarity and that is closest to the main control virtual character is determined as the target entity.

In an example, the game application determines an entity, in the perception range, whose similarity is the highest and is higher than a threshold as the target entity. For example, there is at least one perception range. For example, the perception range includes at least one of the following: an FOV of the main control virtual character, an auditory range of the main control virtual character, a perception range of a perceptual virtual item of the main control virtual character, an FOV of the NPC, an auditory range of the NPC, or a perception range of a perceptual virtual item of the NPC.

For example, the game application may sequentially traverse the foregoing at least one perception range, or the game application may sequentially traverse at least one perception range determined based on the natural language command. For example, the natural language command is as follows: “Can you see the truck ahead? Move to the truck.” In this case, the game application may preferentially traverse the FOV of the main control virtual character and then traverse the FOV of the NPC, to determine, through matching, an entity whose similarity is the highest and is higher than the threshold.

For example, when there are at least two perception ranges, a traversal sequence of the at least two perception ranges may be preset, or a traversal sequence of the at least two perception ranges may be determined based on an intention indicated by the natural language command. For example, when the intention is to search for an object, the FOV is preferentially traversed; or when the intention is to search for a battle scene, the auditory range is preferentially traversed.

If a multi-layer nested instruction appears in the natural language command, a first target entity is first found, and then a next target entity is further found based on a location of a previous target entity. When the natural language command includes a second target entity determined based on a location of the first target entity, the first target entity is queried from the entity set of the virtual environment based on the environmental perception information and first target entity information of the first target entity that is expressed by the natural language command; and then the second target entity is queried from the entity set of the virtual environment based on second target entity information of the second target entity, the first target entity, and the environmental perception information.

In response to the natural language command, the NPC is controlled to perform a virtual activity associated with the target entity.

For example, the LLM is invoked to recognize the behavioral intention of the natural language command, a control instruction or a control instruction sequence is generated based on the behavioral intention, and the NPC is controlled, based on the control instruction or the control instruction sequence, to complete an activity based on the target entity.

The broadcasting of the feedback information of the NPC in operation 1708 may be implemented as follows:

Sub-operation 6: Broadcast the feedback information of the NPC, feedback text corresponding to the feedback information being non-fixed text generated based on the environmental perception information of the NPC.

For example, the game application may generate corresponding feedback information in real time based on the environmental perception information of the NPC, and broadcast the feedback information. For example, when the environmental perception information of the NPC triggers the broadcast condition, the game application may generate the corresponding feedback information in real time based on the environmental perception information that triggers the broadcast condition; or when the NPC or the main control virtual character trigger the broadcast condition, the game application may generate the corresponding feedback information in real time based on the environmental perception information of the NPC.

For example, the feedback text is obtained by invoking the LLM to perform inference based on static entity data of a three-dimensional virtual environment and dynamic environmental perception information of the NPC. The LLM generates different feedback text for different perception statuses of the NPC.

For example, the feedback text may alternatively be feedback text that conforms to personality characteristics of the NPC and that is obtained by the LLM through inference based on the static entity data of the three-dimensional virtual environment and the dynamic environmental perception information of the NPC. For example, when the NPC is a burly middle-aged man, the feedback text may be in a bold and heroic tone; or when the NPC is a journalist, the feedback text may be in a news report tone.

Due to randomness of results generated by the LLM, generated feedback text may vary in a same scene when the environmental perception information of the NPC remains the same.

The environmental perception information may include information perceived by the NPC in real time, or may include information historically perceived by the NPC.

For example, the feedback information is obtained by the game application through inference based on the environmental perception information of the NPC and the static entity data of the three-dimensional virtual environment. The feedback information may be broadcast in a speech form, or may be broadcast in a text form. The static entity data includes data of a relatively unchanged entity in the three-dimensional virtual environment, for example, includes model information of buildings, terrains, and vehicles in the three-dimensional virtual environment.

For example, the feedback information may include at least one of the following: an instant feedback, an execution feedback, and a dynamic feedback. Both the instant feedback and the execution feedback are feedback information generated for the natural language command. The dynamic feedback is feedback information spontaneously generated by the NPC.

1. The instant feedback is feedback information instantly generated when the natural language command is received. The instant feedback may include a reply broadcast and an instant broadcast. The reply broadcast is configured for recovering a query in the natural language command. The instant broadcast is configured for feeding back a reception status of the natural language command.

For example, the client may command, based on the intention of the natural language command, the NPC to perform an activity in the three-dimensional virtual environment. In this case, when receiving the natural language command, the client may generate an instant feedback corresponding to the natural language command. The instant feedback is configured for indicating that the natural language command is received, or the instant feedback is configured for instantly replying to the natural language command.

In an example, the feedback information includes a reply broadcast. The reply broadcast includes a reply, to a query natural language command initiated by the player, that is generated for the query natural language command. For example, when the query natural language command includes querying the location of the target entity, a corresponding reply broadcast is to include a query result for the location of the target entity.

A terminal broadcasts a reply broadcast of the NPC when a behavioral intention of a received natural language command is querying. The reply broadcast includes reply content, for the natural language command, that is generated based on environmental perception information of the NPC for the three-dimensional virtual environment.

The natural language command is configured for querying information from the NPC. The natural language command may be referred to as a query natural language command. The query natural language command is a natural language command with an intention of querying. The query natural language command includes at least one question.

The natural language command is a command instruction delivered through natural language of human beings. The terminal receives the natural language command initiated by the player, and commands the NPC based on an intention corresponding to the natural language command. For example, the terminal receives speech audio of the player, and converts the speech audio into text to obtain the natural language command; or the terminal receives text of the natural language command that is inputted by the player.

The player may deliver the natural language command in oral language, written language, or other expression modes. The game application invokes the LLM to understand the natural language command, extract an intention expressed by the natural language command, and generate a control instruction based on the intention, to command the NPC to perform an activity.

For example, the natural language command may be “Come to me”. In this case, the game application may parse out an intention of the natural language command from the natural language command: “control the NPC to move to the location of the main control virtual character”. Therefore, the game application obtains the location of the main control virtual character, generates a navigation route for the NPC to move to the location of the main control virtual character, and controls the NPC to move to the location of the main control virtual character based on the navigation route.

For another example, the natural language command may be “Go to pick up the treasure box”. In this case, the game application may parse out an intention of the natural language command from the natural language command: “control the NPC to move to the location of the treasure box and pick up the treasure box”. Therefore, the game application may obtain the location of the treasure box, and control the NPC to move toward the location of the treasure box and perform an operation of picking up the treasure box after reaching the location of the treasure box.

For example, when the query natural language command includes an intelligence query for the target entity, a first reply broadcast is broadcast based on perception of the NPC for the target entity, the first reply broadcast including an intelligence perception result of the NPC for the target entity.

Alternatively, when the query natural language command includes a location query for the target entity, a second reply broadcast is broadcast based on perception of the NPC for the target entity, the second reply broadcast including a location description of the target entity.

For example, the LLM is invoked to parse a received natural language command to obtain an intention of the natural language command. When the intention is of a query type, it can be determined that the natural language command is a query natural language command. When the natural language command is a query natural language command, the LLM may perform inference based on static entity data and environmental perception information based on the intention of the natural language command, to obtain reply text. That is, the LLM is invoked to parse the received natural language command, output the intention of the natural language command as querying, and output the reply text of the natural language command. The game application invokes a text-to-speech conversion service based on query intention processing logic to convert the reply text into a reply broadcast, the reply broadcast being a broadcast in an audio form; and transmits reply audio to the client for broadcast.

For example, when the LLM recognizes the intention of the natural language command as querying, because a user may ask thousands of types of questions and replies to all questions cannot be locally stored on the client, the game application invokes the text-to-speech conversion service to generate a reply broadcast in real time based on a reply text returned by the LLM, so that the game application can instantly generate a corresponding reply broadcast to reply to a question of the player.

For example, the game application (the client or the server) invokes the LLM to parse the query natural language command, perform inference based on static environment data and environmental perception information of the three-dimensional virtual environment to obtain reply text, and generate human voice audio based on the reply text to obtain a reply broadcast.

For example, the client reports a received query natural language command to the server; the server invokes the LLM to parse the query natural language command, perform inference based on static environment data and environmental perception information of the three-dimensional virtual environment to obtain reply text, and generate human voice audio based on the reply text to obtain a reply broadcast; the server transmits the reply broadcast to the client; and the client broadcasts the reply broadcast.

2. The execution feedback is a feedback generated when a task is performed based on an intention expressed by a natural language command after the natural language command is received. The execution feedback may also be referred to as an execution broadcast.

For example, when the natural language command is configured for commanding the NPC to perform a target task, the client may generate an execution feedback when the NPC is performing the target task, and the execution feedback is configured for indicating an execution status of the target task; or the client may generate an execution feedback after the NPC completes the target task, and the execution feedback is configured for indicating an execution result of the target task.

In an example, the feedback information includes a feedback broadcast (which may also be referred to as an execution feedback). The feedback broadcast includes a broadcast of a task execution status and a task execution result that are generated for a task natural language command initiated by the player. For example, when the task natural language command includes moving to the target entity, a corresponding feedback broadcast may include: moving to the target entity, or arrived at the target entity.

The terminal broadcasts a feedback broadcast when a behavioral intention of a received natural language command is to perform a task. The feedback broadcast includes an execution status obtained after the natural language command is executed based on environmental perception information of the NPC for the three-dimensional virtual environment.

The natural language command is configured for commanding the NPC to perform the task. The natural language command may be referred to as a task natural language command. The task natural language command includes description text of the task. For example, the description text of the task may include at least one of the following: a task name, an action that the NPC needs to perform, a method for performing the task, a task objective, or a location of the task objective.

For example, when the intention of the task natural language command includes searching for the target entity, a first feedback broadcast is broadcast, the first feedback broadcast including a search result of the NPC for the target entity.

Alternatively, when the intention of the task natural language command includes using a virtual item, a second feedback broadcast is broadcast, the second feedback broadcast being configured for indicating that the virtual item is ready.

Alternatively, when the intention of the task natural language command includes using a virtual item, a third feedback broadcast is broadcast, the third feedback broadcast being configured for indicating a use result of the virtual item.

Alternatively, when the intention of the task natural language command includes controlling the NPC to move, a fourth feedback broadcast is broadcast, the fourth feedback broadcast being configured for indicating a movement result of the movement.

Alternatively, when the intention of the task natural language command includes interacting with the target entity, a fifth feedback broadcast is broadcast, the fifth feedback broadcast being configured for indicating at least one of the following: a search result of the NPC for the target entity, or an interaction result of the NPC and the target entity.

Alternatively, when the intention of the task natural language command includes item interaction, a sixth feedback broadcast is broadcast, the sixth feedback broadcast being configured for indicating an item interaction result of item interaction performed by the NPC.

For example, the LLM is invoked to parse a received natural language command to obtain an intention of the natural language command. When the intention is a task, it can be determined that the natural language command is a task natural language command. When the natural language command is a task natural language command, the LLM may perform inference based on static entity data and environmental perception information based on the intention of the natural language command, to obtain a task instruction sequence. The task instruction sequence is configured for controlling the NPC to perform the task. When receiving the task instruction sequence, the game application controls, based on a task instruction in the task instruction sequence, the NPC to move to perform the task. During control on the NPC based on the task instruction, a corresponding execution status may be obtained based on feedback broadcast logic corresponding to different task instructions, to perform feedback broadcasting.

For example, because the NPC can execute instructions in the three-dimensional virtual environment in a limited traversable manner, the client may locally store feedback broadcasts corresponding to character instructions. When the NPC executes a corresponding instruction, the client may read a local feedback broadcast to perform speech broadcasting.

Alternatively, when a feedback broadcast corresponding to a task instruction includes variable content, for example, a target entity in the feedback broadcast is variable or location information in the feedback broadcast is variable, the client may alternatively generate variable-content broadcast speech based on a target entity or location information returned by the LLM, and concatenate the variable-content broadcast speech to a locally stored invariable-content broadcast speech to obtain a final feedback broadcast.

For example, when the task natural language command is “Search for a treasure box nearby”, the LLM may be invoked to parse the task natural language command to learn that an intention of the task natural language command is a task, a task objective is to search for a target entity, and the target entity is a treasure box; and inference is performed based on static entity data and environmental perception information to learn that a treasure box exists in the left front of the main control virtual character. When the target entity can be found, a feedback broadcast corresponding to the task objective is “aaa is found at xxx”, where xxx is a location of the target entity, and aaa is a name of the target entity. In this case, the game application may invoke an online text-to-speech conversion technology to generate location speech based on the location information “left front” in the inference result; invoke the online text-to-speech conversion technology to generate name speech based on the name “treasure box” of the target entity; and then concatenate the location speech and the name speech to the feedback broadcast to obtain a final feedback broadcast.

For example, the game application (the client or the server) invokes the LLM to parse the task natural language command, perform inference based on static environment data and environmental perception information of the three-dimensional virtual environment to obtain a task execution instruction, control, based on the task execution instruction, the NPC to perform a task, generate feedback text based on an execution status of the NPC performing the task, and generate human voice audio based on the feedback text to obtain a feedback broadcast.

For example, the client reports a task natural language command to the server; the server parses the task natural language command, performs inference based on static environment data and environmental perception information of the three-dimensional virtual environment to obtain a task execution instruction, controls, based on the task execution instruction, the NPC to perform a task, generates feedback text based on an execution status of the NPC performing the task, and generates human voice audio based on the feedback text to obtain a feedback broadcast; the server transmits the feedback broadcast to the client; and the client receives and broadcasts the feedback broadcast.

3. The dynamic feedback is feedback information spontaneously generated based on the environmental perception information of the NPC. The dynamic feedback may also be referred to as a dynamic broadcast.

For example, the client may spontaneously generate a dynamic feedback based on perception for the three-dimensional virtual environment when the client receives no natural language command. The dynamic feedback is configured for indicating an abnormal case that the NPC finds in the three-dimensional virtual environment. For example, the abnormal case may include: finding an enemy virtual character, finding a status change of a friend virtual character, finding a dangerous situation, or finding a battle trace or a search trace.

In an example, the feedback information includes a dynamic broadcast (which may also be referred to as a “dynamic feedback”). The dynamic broadcast includes broadcasting an abnormal case perceived by the NPC. For example, when the NPC perceives an attack, the NPC being under attack is broadcast; or when the NPC perceives a dangerous situation ahead, a danger being ahead is broadcast.

The terminal broadcasts a dynamic broadcast when environmental perception information of the NPC for the three-dimensional virtual environment meets a dynamic broadcast condition.

The dynamic broadcast is a broadcast generated based on an abnormal case when the game application determines, based on the environmental perception information of the NPC, that there is an abnormal case to be broadcast. The dynamic broadcast includes prompt information about the abnormal case. For example, the abnormal case may include at least one of the following: finding an enemy virtual character, finding a status change of a friend virtual character, or finding a new trace.

For example, when the NPC perceives an enemy virtual character, a first dynamic broadcast is broadcast, the first dynamic broadcast including a location of the enemy virtual character perceived by the NPC.

Alternatively, when the NPC perceives a dangerous situation, a second dynamic broadcast is broadcast, the second dynamic broadcast being configured for indicating the dangerous situation.

Alternatively, when the NPC perceives a status change of a friend virtual character, a third dynamic broadcast is broadcast, the third dynamic broadcast being configured for indicating the status change of the friend virtual character.

Alternatively, when the NPC finds a new trace in the three-dimensional virtual environment, a fourth dynamic broadcast is broadcast, the fourth dynamic broadcast being configured for indicating the new trace. The new trace may be a battle trace and/or a search trace.

For example, because a quantity of dynamic broadcasts that the NPC can trigger in the three-dimensional virtual environment is traversable in a limited manner, the client may locally store dynamic broadcast speech. When corresponding dynamic broadcast speech is triggered, the client may locally read the dynamic broadcast speech for broadcasting. Similarly, some dynamic broadcast speech may include variable content, and the client may generate variable content in real time through a text-to-speech conversion technology, and concatenate the variable content to a dynamic broadcast template to obtain a final dynamic broadcast.

In an example, during generation of the feedback information, a location of the target entity in the three-dimensional virtual environment may need to be queried, or the target entity indicated by the natural language command may be determined from the three-dimensional virtual environment. In this case, the target entity needs to be queried by using an entity query method.

Before the target entity is queried, the static entity data of the three-dimensional virtual environment needs to be pre-constructed. The construction of the static entity data not only can serve inference of the LLM, but also can serve real-time feedback text generation performed on the game application side after an inference result is returned.

In an example, entities in the three-dimensional virtual environment are traversed, and entity information of each entity is exported from a game engine to obtain the static entity data.

For example, for an in-game scene, an editor tool is developed to perform full-scene static mesh traversal, special actor traversal (for example, an interactive door, which does not belong to the scope of static meshes), and plant traversal. A location, a rotation, and a bounding box size of an entity are exported as static entity data to be subsequently provided for the LLM for labeling and inference.

A static mesh is a static geometric resource type in an Unreal Engine 4 (UE4) game engine, and is configured for representing an invariable three-dimensional model, for example, a building or a prop. An actor is a basic object class in the UE4 game engine, and represents an entity in a game world, for example, a character, an object, or a light source. The actor may include a plurality of components to implement different functions.

For example, the static entity data may further include spatial data, and the spatial data is manually marked. The spatial data is more complex than a static entity because there are a plurality of floors in space and a plurality of layers within a floor are nested (for example, a motel area includes a second floor, and an area on the second floor includes a room 201). This type of data is constructed through manual marking. In the editor, a volume is added to a scene, to obtain needed areas of an entire image through division and add corresponding labels. The volume is a special actor class in the UE4 game engine, and represents a three-dimensional area with a specific function, for example, a trigger area or an audio area.

After the static entity data is obtained, an entity or spatial query may be performed based on the static entity data during running of the game.

For example, when the player delivers a natural language command, the natural language command initiates an inference request to the LLM along with the constructed static entity data and runtime data (including environmental perception information of the NPC and/or the main control virtual character) captured in real time. In addition, when the NPC needs to perform dynamic feedback based on the runtime data, an entity query also needs to be performed to generate feedback text based on a current state.

When the natural language command includes a target entity, the game application queries for the target entity based on a current location and rotation of the main control virtual character and a current location and rotation of a teammate or an enemy; and selects, based on target entity information of the target entity that is described in the natural language command and the environmental perception information of the main control virtual character and/or the NPC, the target entity matching the target entity information from at least one candidate entity within a perception range of the main control virtual character and/or the NPC.

In some examples, the natural language command is configured for commanding the NPC to perform an activity related to the target entity. For example, the target entity may be a destination of movement of the NPC, the target entity may be an object that the NPC needs to observe, the target entity may be a target that the NPC needs to attack, or the target entity is an object that the NPC needs to interact with.

The target entity is a virtual object existing in the three-dimensional virtual environment. The target entity is an entity described in the natural language command. The entity may be a stationary virtual object in the three-dimensional virtual environment. For example, the target entity may be a virtual building, a virtual terrain, a virtual vehicle, a virtual plant, a virtual prop, or a virtual item. The entity may alternatively be a virtual object that can interact with a virtual character in the three-dimensional virtual environment. For example, the target entity may be an interaction point (for example, a door, a window, a cabinet, or a cellar), a virtual prop, a virtual character, or a virtual light source in the three-dimensional virtual environment.

For example, the natural language command may be “Open the door for me”. In this case, the target entity may be the “door”, and the NPC needs to perform a door-related activity: “open the door”. Alternatively, the natural language command may be “Is it safe in the kitchen?” In this case, the target entity may be the “kitchen”, and the NPC needs to perform a kitchen-related activity: “check for an enemy virtual character or other dangerous situations in the kitchen”.

In some examples, the natural language command includes target entity information of the target entity. The target entity information may be description text of the target entity. For example, the target entity information may include at least one of the following content: a name, a type, a location, or a feature of the target entity. The game application may find the target entity from a plurality of entities in the three-dimensional virtual environment based on the target entity information in the natural language.

The game application parses the natural language command, extracts the target entity information from the natural language command, determines the target entity from an entity set of the three-dimensional virtual environment based on the target entity information, and then controls the NPC to perform, based on an intention of the natural language command, an activity related to the target entity.

The target entity is determined from the three-dimensional virtual environment based on environmental perception information, and the environmental perception information includes information perceived by at least one of the main control virtual character and the NPC from the three-dimensional virtual environment.

The target entity information in the natural language command is usually vague. For example, the natural language command may be “Move to the red truck”, and the target entity information in the natural language command is “red truck”. However, there may be many red trucks in the three-dimensional virtual environment, and the target entity cannot be accurately determined from the three-dimensional virtual environment only based on the target entity information in the natural language command.

Therefore, this example of this application provides a method for determining the target entity based on the target entity information and the environmental perception information. For the foregoing example, the “red truck” expressed by the player in the natural language command is a red truck visible to the player. Therefore, a red truck located within an FOV of the main control virtual character may be selected from a plurality of red trucks in the three-dimensional virtual environment based on the FOV of the main control virtual character, and the red truck is the target entity specified by the player in the natural language command.

Because the natural language command is delivered by the player based on perception for the three-dimensional virtual environment, to accurately recognize the target entity indicated in the natural language command, the game application recognizes the target entity in the natural language command based on the environmental perception information obtained when the player delivers the natural language command. Based on the perception of the player for the three-dimensional virtual environment, an entity in the three-dimensional virtual environment that is most approximate to the target entity information and that can be perceived by the player is obtained through inference, and is the target entity.

For example, the three-dimensional virtual environment includes a plurality of candidate entities matching the natural language command, and the target entity is an entity selected from the plurality of candidate entities based on environmental perception information of the main control virtual character or the NPC. For example, the game application first selects a plurality of candidate entities matching the target entity information in the natural language command from the entity set, and then selects, based on the environmental perception information, an entity that can be perceived by the main control virtual character or the NPC from the plurality of candidate entities as the target entity.

For example, a perception range of the main control virtual character is determined based on a location and a rotation of the main control virtual character. For example, the perception range is a fan-shaped area with a specific FOV size in front of the main control virtual character. An entity outside the fan-shaped range is filtered out. Then sorting is performed based on similarities between the target entity information and entity information of candidate entities, and an entity with a high similarity is selected as the target entity. When two entities in the perception range have highest similarity scores that are equal, for example, similarity scores of both an entity 2 and an entity 3 are 2, the entity 2 closer to the main control virtual character is selected as the target entity.

When feedback information needs to be generated based on a location description of the target entity, the game application may perform a spatial query based on a location relationship between the main control virtual character and the target entity, to generate the location description.

A main application scenario of the spatial query is as follows: A location of the main control virtual character, the NPC, an enemy virtual character, a gunshot, or the like needs to be obtained. For example, a broadcast including spatial information may be performed: “An enemy is found on the second floor of the motel”.

Spatial query logic defines concepts of a parent area and a sub-area. The parent area is a large area covering a plurality of buildings or a plurality of isolated spaces in the three-dimensional virtual environment, for example, a motel having front and back yards and including a plurality of rooms and basements. The sub-area is an independent space in the parent area, and may be a closed space or a special functional space, for example, a guest room or a kitchen of the motel.

To make the location description returned by the spatial query closer to human expression, when the main control virtual character and the queried location are in different parent areas, complete text information is returned in a query result (for example, if the main control virtual character is outside the motel and the queried location is on the second floor of the motel, the following is returned: “The enemy is on the second floor of the motel”). When the main control virtual character and the queried location are in a same parent area and different sub-areas, only sub-area information is returned in a query result (for example, if the main control virtual character is on the first floor of the motel and the queried location is on the second floor, the following is returned: “The enemy is on the second floor”). When the main control virtual character and the queried location are in a same parent area and a same sub-area, only an orientation relative to a primary perspective of the player is returned in a query result (for example, if both the main control virtual character and the queried location are on the second floor of the motel, the following is returned: “The enemy is at the right front location”).

For example, when the main control virtual character and the target entity are located in different parent spaces, the location description includes a parent space and a sub-space in which the target entity is located. When the main control virtual character and the target entity are located in different sub-spaces of a same parent space, the location description includes a sub-space in which the target entity is located. When the main control virtual character and the target entity are located in a same sub-space of a same parent space, the location description includes a relative orientation between the target entity and the main control virtual character. One parent space includes at least one sub-space.

For the broadcasting of the feedback information of the NPC in operation 1708, the feedback information is implemented as spatial human voice audio obtained through spatial sound effect processing. A process of the spatial sound effect processing may be implemented as follows:

Sub-operation 7: Obtain human voice audio corresponding to feedback text.

In this application, a process of generating the feedback text is shown in the content of the foregoing sub-operation 6, and details are not described herein again.

In some examples, a process of obtaining corresponding human voice audio based on the feedback text may be implemented as follows: obtaining feedback text and character feature information that correspond to the NPC; and generating, based on the feedback text, human voice audio matching the character feature information.

For example, the character feature information is configured for describing an attribute of the NPC. To be specific, the character feature information is information for describing a current state and feature of the NPC. In some examples, the attribute of the NPC includes at least one of a basic attribute and a scene performance attribute of the NPC. The basic attribute is an attribute preconfigured for the NPC, that is, an attribute of the NPC that does not change due to the three-dimensional virtual environment or a current scene, for example, age information of the NPC, male/female information of the NPC, or sect information of the NPC. The scene performance attribute is an attribute determined for the NPC in real time in a scene of the three-dimensional virtual environment, that is, an attribute associated with a current scene, for example, emotion information or behavior information of the NPC in the current scene.

In some examples, the character feature information includes at least one of basic character information, character emotion information, or character behavior information. The basic character information is configured for indicating a basic character status of the NPC. The basic character information is information about the basic attribute of the NPC, for example, the age information of the NPC, the male/female information of the NPC, or the sect information of the NPC. The character emotion information is configured for indicating an emotional state of the NPC in a conversation scene corresponding to the feedback text. The character emotion information is a scene performance attribute of the NPC. For example, the character emotion information indicates that the NPC is in an excited state, an angry state, or a sad state. The character behavior information is configured for indicating an action performed by the NPC in a conversation scene. The character behavior information is a scene performance attribute of the NPC. For example, the NPC is in a running state, an attacking state, or an injury treatment state.

In some examples, the human voice audio is generated through a pre-trained speech generation model, and the speech generation model is configured for generating speech matching the character feature information of the NPC. For example, the feedback text and the character feature information are inputted to the pre-trained speech generation model to obtain human voice audio as the human voice audio.

In some examples, the speech generation model may be implemented by a neural network model such as a CNN, a feedforward neural network, a residual network, a transformer, or a multi-modal large language model (MLLM). This is not specifically limited herein.

In some examples, the speech generation model includes a text encoder, a character encoder, and a decoder. The text encoder is configured to perform text encoding on the inputted feedback text. To be specific, the feedback text is inputted to the text encoder to obtain a text coded representation. The character encoder is configured to perform feature encoding on the inputted character feature information. To be specific, the character feature information is inputted to the character encoder to obtain a character coded representation.

For example, after the text coded representation and the character coded representation are obtained, the text coded representation and the character coded representation are fused to obtain a coded representation to be inputted to the decoder. To be specific, the text coded representation and the character coded representation are fused to obtain a joint coded representation, and the joint coded representation is inputted to the decoder to generate human voice audio.

In some examples, the character encoder includes at least one of a first sub-encoder, a second sub-encoder, and a third sub-encoder. The first sub-encoder is configured to perform feature encoding based on the basic attribute of the NPC. To be specific, when the character feature information includes the basic character information, the basic character information is inputted to the first sub-encoder to obtain a first character coded representation. The second sub-encoder is configured to perform feature encoding based on an emotional state of the NPC. To be specific, when the character feature information includes the character emotion information, the character emotion information is inputted to the second sub-encoder to obtain a second character coded representation. The third sub-encoder is configured to perform feature encoding based on a behavioral state of the NPC. To be specific, when the character feature information includes the character behavior information, the character behavior information is inputted to the third sub-encoder to obtain a third character coded representation.

Sub-operation 8: Obtain a sound effect parameter corresponding to the NPC based on a relative orientation relationship between the NPC and the main control virtual character in the three-dimensional virtual environment.

For example, the relative orientation relationship between the NPC and the main control virtual character in the three-dimensional virtual environment is configured for indicating a relative relationship between a first location corresponding to the NPC and a second location corresponding to the main control virtual character in the three-dimensional virtual environment.

In some examples, the relative orientation relationship includes at least one of a location distance, a location direction, and a spatial surrounding status between the NPC and the main control virtual character. The location distance is configured for indicating a distance relationship between the NPC and the main control virtual character. The location direction is configured for indicating an angular relationship between the first location of the NPC and an orientation direction of the main control virtual character. The spatial surrounding status is configured for indicating a surrounding status of a spatial element, which forms a virtual space in the three-dimensional virtual environment, for the main control virtual character, and impact on spatial propagation of audio when the NPC produces the audio in the virtual space.

In some examples, the relative orientation relationship between the NPC and the main control virtual character may be determined as follows: obtaining first location information of the NPC in the three-dimensional virtual environment, obtaining second location information of the main control virtual character in the three-dimensional virtual environment, and determining the relative orientation relationship between the NPC and the main control virtual character based on the first location information and the second location information.

In some examples, the first location information of the NPC and the second location information of the main control virtual character are location information determined based on a same preset coordinate system. In some examples, the preset coordinate system may be implemented as a world coordinate system corresponding to the three-dimensional virtual environment, or the preset coordinate system may be implemented as a coordinate system established with the main control virtual character as an origin.

In some examples, when the sound effect parameter corresponding to the NPC is pre-generated and stored in a database, the sound effect parameter corresponding to the NPC is obtained from the database. In some examples, the sound effect parameter corresponding to the NPC may alternatively be generated in real time. To be specific, the sound effect parameter corresponding to the NPC is generated based on the relative orientation relationship.

In some examples, the sound effect parameter corresponding to the NPC may include at least one of the following types:

Type 1: a distance type

For example, a sound effect parameter of the distance type is configured for indicating to adjust a sound effect of human voice audio based on a distance between the NPC and the main control virtual character. In some examples, the sound effect parameter of the distance type may be configured for adjusting an audio volume of the human voice audio to simulate impact of a distance on loudness of sound; and/or the sound effect parameter of the distance type may be configured for adjusting an audio delay of the human voice audio to simulate impact of a distance on propagation time of sound.

Type 2: a direction type

For example, a sound effect parameter of the direction type is configured for indicating to adjust a sound effect of human voice audio based on a direction of the NPC relative to the main control virtual character. In some examples, the sound effect parameter of the direction type may be configured for adjusting an audio volume of the human voice audio, to simulate a case of whether the main control virtual character faces an audio element in a scene; and/or the sound effect parameter of the direction type may be configured for adjusting volume parameters of the human voice audio in different channels, to simulate a direction in which a sound source element in a scene produces audio.

Type 3: a spatial special-effect type

For example, a sound effect parameter of the spatial special-effect type is configured for indicating to adjust, based on a virtual space formed by a spatial element, a sound effect in the virtual space. To be specific, the sound effect parameter of the spatial special-effect type indicates impact of the virtual space on a sound effect representation of audio produced by the NPC. In some examples, the sound effect parameter of the spatial special-effect type may be configured for adding an echo sound effect or a reverberation sound effect, to simulate an effect of sound in space.

In some examples, the sound effect parameter of the spatial special-effect type includes at least one of a reverberation time parameter, a pre-delay parameter, a humidity (Wet/Dry Mix) parameter, a spatial width parameter, or a distance effect parameter. The reverberation time parameter is configured for indicating a speed at which audio attenuates in the virtual space. The pre-delay parameter is configured for indicating a difference between time at which audio directly arrives at the main control virtual character and time at which the first reflection arrives at the main control virtual character. The humidity parameter is configured for indicating a ratio of directly propagated audio to audio propagated through reflection. The spatial width parameter is configured for indicating a degree of diffusion of audio on a horizontal plane in the virtual space. The distance effect parameter is configured for indicating an attenuation status of audio over a propagation distance during propagation.

Type 4: a user-defined type

For example, a sound effect parameter of the user-defined type is a user-defined parameter configured for adjusting a sound effect. In some examples, the user may define an overall volume of scene audio and whether to add background music, define volumes of different types of audio, or the like.

In some examples, the client provides the user with a user-defined interface for a sound effect parameter, and the user configures a user-defined sound effect parameter on the user-defined interface.

In some examples, for the user-defined sound effect parameter, a parameter prediction model for performing personalized learning on the user-defined sound effect parameter is configured on the server. For example, user-defined sound effect parameters of a plurality of candidate accounts are obtained, the plurality of user-defined sound effect parameters are inputted to a to-be-trained parameter prediction model, iterative training is performed on the to-be-trained parameter prediction model to obtain a parameter prediction model, and a sound effect parameter (for example, the sound effect parameter of the distance type, the direction type, or the spatial special-effect type) generated by a system is optimized through the parameter prediction model.

Sub-operation 9: Adjust the human voice audio based on the sound effect parameter, to generate and broadcast spatial human voice audio corresponding to the NPC.

The spatial human voice audio is configured for representing a perception effect of the main control virtual character for audio generated by the NPC in the relative orientation relationship.

In this example of this application, the human voice audio is adjusted based on the sound effect parameter corresponding to the NPC, to generate the spatial human voice audio corresponding to the NPC. To be specific, the spatial human voice audio is audio data that corresponds to the NPC and that is obtained by adjusting the human voice audio based on the sound effect parameter. In some examples, the spatial human voice audio includes audio obtained through adjustment based on the sound effect parameter, and at least one of the following types of data: audio duration information, a playback start timestamp of the audio, a playback end timestamp of the audio, playback condition information of the audio, and element identification information corresponding to the audio.

In some examples, when the sound effect parameter indicates to adjust a volume of the human voice audio of the NPC, a volume of the human voice audio of the NPC in at least one channel is adjusted based on the sound effect parameter. In some examples, when the sound effect parameter indicates to adjust a playback delay of the human voice audio of the NPC, audio playback start time corresponding to the human voice audio of the NPC is adjusted based on the sound effect parameter. In some examples, when the sound effect parameter indicates to adjust a sound speed of the human voice audio of the NPC, a playback speed of the human voice audio of the NPC is adjusted based on the sound effect parameter. In some examples, when the sound effect parameter indicates a tone of the human voice audio of the NPC, a frequency in a spectrum of the human voice audio of the NPC is adjusted based on the sound effect parameter. When the sound effect parameter indicates to adjust a timbre of the human voice audio of the NPC, a filter corresponding to the NPC is determined based on the sound effect parameter, and the timbre corresponding to the human voice audio is adjusted through the filter.

For example, the client plays the spatial human voice audio to broadcast the feedback information of the NPC.

A speech-to-text conversion stage in operation 1704 may be implemented as follows:

Sub-operation 10: Obtain at least one first scene hot-word corresponding to a first virtual scene in which a target virtual character is located.

The target virtual character includes at least one of an NPC and a main control virtual character.

For example, the main control virtual character is a virtual character commanded by the player, and the NPC is a virtual character assisting the main control virtual character in a virtual battle in a game. Usually, the virtual battle includes one main control virtual character and at least one NPC. There is a particular difference between the main control virtual character and the NPC.

In some examples, the main control virtual character is a virtual character mainly controlled by the player, and the NPC is a virtual character selectively commanded by the player. For example, the main control virtual character is a virtual character manually controlled by the player during the game, and a manual operation performed by the player on a terminal interface is configured for controlling the main control virtual character; and the NPC is a virtual character commanded by the player in a speech form, and the player occasionally initiates a natural language command in a speech form to command the NPC.

In some examples, the first virtual scene is determined based on the target virtual character, and the target virtual character is at least one of the NPC and the main control virtual character. That is, a process of determining the first virtual scene is implemented as at least one of the following cases:
(1) If the main control virtual character is selected as the target virtual character, a virtual scene in which the main control virtual character is located is used as the first virtual scene.
(2) If the NPC is selected as the target virtual character, a virtual scene in which the NPC is located is used as the first virtual scene. If there are a plurality of NPCs, a virtual scene including a largest quantity of NPCs may be used as the first virtual scene; or an NPC closest to the main control virtual character may be used as the target virtual character, and a virtual scene in which the NPC is located is used as the first virtual scene; or an NPC with a highest attribute value (for example, at least one of a virtual health point, a virtual magic point value, or a virtual defense value) may be used as the target virtual character, and a virtual scene in which the NPC is located is used as the first virtual scene.
(3) If both the main control virtual character and the NPC are selected as the target virtual character, a virtual scene in which both the main control virtual character and the NPC are located may be used as the first virtual scene.

In some embodiments, the target virtual character is determined based on selection by the player, or the target virtual character is set in the system by default.

In some examples, the at least one first scene hot-word is determined based on the first virtual scene.

The at least one first scene hot-word is a scene-associated word of the first virtual scene. To be specific, there is an association relationship between the first scene hot-word and the first virtual scene, and the first scene hot-word is a word for describing the first virtual scene.

In some examples, the first scene hot-word includes a scene status of the first virtual scene. For example, the first virtual scene is a virtual restaurant, and the first scene hot-word includes an open state, a break state, a closed state, or the like.

In some examples, the first scene hot-word includes an element name of a virtual element in the first virtual scene. For example, the first virtual scene is a virtual restaurant, and the first scene hot-word includes a virtual table, a virtual chair, virtual kitchenware, a virtual plate, or the like.

In some examples, the first scene hot-word includes an interaction word for interaction between virtual elements in the first virtual scene. For example, the first virtual scene is a virtual battlefield, and the first scene hot-word includes attacking, attacking a virtual character, defense, building a barrier, or the like.

In some examples, after the natural language command is received, the at least one first scene hot-word is collected based on the first virtual scene; or after the natural language command is received, the at least one first scene hot-word corresponding to the first virtual scene is selected from a plurality of pre-obtained scene hot-words based on the first virtual scene; or the like.

In an example, an object perception range of the target virtual character in the first virtual scene is obtained.

The object perception range is a three-dimensional space range in which the target virtual character has perception for another scene element.

In some examples, when the target virtual character is the main control virtual character, an object perception range of the main control virtual character in the first virtual scene is obtained; when the target virtual character is the NPC, an object perception range of the NPC in the first virtual scene is obtained; or when the target virtual character is the main control virtual character and the NPC, an object perception range of the main control virtual character in the first virtual scene is obtained, and an object perception range of the NPC in the first virtual scene is obtained.

In some implementations, the object perception range includes at least one of the following:

(1) Visual perception range of the target virtual character

For example, the visual perception range is a space range that can be visually perceived or understood by an observer, and is usually configured for describing a size of an area that a living body or a technical device can visually cover or perceive. The visual perception range of the target virtual character is a three-dimensional space range perceived through observation by the target virtual character with the target virtual character as an observer.

In some examples, the visual perception range of the target virtual character is obtained based on a location and a visual observation capability of the target virtual character in the first virtual scene.

(2) Auditory perception range of the target virtual character

For example, the auditory perception range is a space range that can be audibly perceived or understood by a listener, and is usually configured for describing a size of a range of sound that a living body or a technical device can audibly cover or perceive. The auditory perception range of the target virtual character is a three-dimensional space range perceived based on an auditory perception capability of the target virtual character with the target virtual character as a listener.

In some examples, the auditory perception range of the target virtual character is obtained based on a location and an auditory perception capability of the target virtual character in the first virtual scene.

(3) Olfactory perception range of the target virtual character

For example, the olfactory perception range is a space range in which a smell is olfactorily perceived or recognized. The olfactory perception range of the target virtual character is a three-dimensional space range that can be olfactorily perceived by the target virtual character.

In some examples, the olfactory perception range of the target virtual character is obtained based on a location and an olfactory perception capability of the target virtual character in the first virtual scene.

(4) Range perceived by a perceptual skill or a perceptual item that is owned by the target virtual character

For example, the perceptual skill is a capability of the target virtual character to perform scene perception on the first virtual scene, and the perceptual skill includes at least one of a perception obtaining form and a perception enhancement form.

In some examples, the perception obtaining form is configured for representing a process of obtaining a non-owned perceptual skill. After the perceptual skill is obtained in the perception obtaining form, the target virtual character may perform targeted scene perception on the first virtual scene by using the perceptual skill. In some examples, the perception enhancement form is configured for representing a process of enhancing a perception capability by owning a perceptual skill when the perception capability is owned.

For example, the perceptual item is a virtual item for perceiving the first virtual scene, and the perceptual item includes at least one of a perception obtaining form and a perception enhancement form.

In some examples, different perceptual skills or perceptual items each correspond to a preset effective range representing a range that can be perceived when the perceptual skill or the perceptual item is applied. In this case, the preset effective range represents the object perception range.

In some examples, the object perception range is a spherical range, an annular range, an irregular three-dimensional space range, or the like. A shape of the object perception range is not limited herein.

In an example, the at least one first scene hot-word is obtained based on environmental perception information in the object perception range.

For example, the environmental perception information is configured for indicating environmental information perceived and obtained by the target virtual character in the object perception range. In some examples, the environmental perception information includes a virtual element determined by transmitting a ray, and may further include area structure information determined by analyzing a geometric structure and layout information of the virtual environment, and the like.

For example, after the object perception range corresponding to the target virtual character is determined, the at least one first scene hot-word representing a status of the target virtual character is obtained based on a range of the object perception range in the first virtual scene and the environmental perception information that is determined by the target virtual character in the object perception range based on perception.

In an example, the environmental perception information includes a virtual element, and a virtual element within the object perception range in the first virtual scene is determined.

For example, the object perception range is a part of a three-dimensional space range in the first virtual scene. The first virtual scene includes a large quantity of virtual elements. The virtual elements are elements constituting a virtual scene. For example, the virtual elements include a virtual ground, a virtual building, a virtual tree, a virtual character, and a virtual stone.

In some implementations, when the object perception range is determined, the virtual element within the object perception range is determined from a plurality of virtual elements corresponding to the first virtual scene.

In some embodiments, an element name of the virtual element is used as the first scene hot-word, or an action name of an interactive action corresponding to the virtual element is used as the first scene hot-word.

Sub-operation 11: Convert the natural language command in the speech form into a text form based on the at least one first scene hot-word.

For example, the first scene hot-word is a word highly associated with the first virtual scene. Therefore, when the natural language command is expected to command the NPC to better cooperate with the main control virtual character in an activity, the first scene hot-word may be used as a constraint condition based on the first virtual scene. In this way, in a process of converting the natural language command into the text form, text content of a command analysis result is more consistent with the first virtual scene, to avoid obtaining a command analysis result that does not match the first virtual scene.

In an example, when the natural language command is analyzed through a natural language analysis model, a plurality of speech units corresponding to the natural language command are obtained through an acoustic network.

The speech unit is a basic constituent unit of a word pronunciation.

In some examples, a command feature representation corresponding to the natural language command is extracted, and the command feature representation is analyzed through the acoustic network.

For example, the command feature representation represents a plurality of acoustic features. An objective of the acoustic network is to map a continuous acoustic feature sequence to a speech unit sequence, for example, a phoneme or a segment. The acoustic network learns to predict a possible speech unit (phoneme or segment) sequence under a given acoustic feature.

In some examples, the acoustic network outputs one or more possible speech unit sequences. The speech unit sequence includes a plurality of speech units. Different speech unit sequences may have different speech units, or may have only different orders of speech units. A plurality of speech unit sequences represent speech unit arrangements that are considered most probable by the language network during understanding of the inputted natural language command.

The natural language analysis model includes the acoustic network, a preset dictionary, and language sub-networks respectively corresponding to at least two virtual scenes.

For example, a virtual environment includes at least two virtual scenes. For example, the virtual environment is a large virtual world including a virtual kitchen 1, a virtual kitchen 2, a virtual office, and the like, and the virtual kitchen 1, the virtual kitchen 2, the virtual office, and the like each may be considered as a virtual scene.

In an example, a first language sub-network corresponding to the first virtual scene is determined from at least two language sub-networks based on the first virtual scene in which the target virtual character is located.

For example, a plurality of virtual scenes each correspond to a language sub-network, and different language sub-networks are configured for specially analyzing virtual scenes corresponding to the language sub-networks. For example: a virtual scene A corresponds to a language sub-network 1, and a virtual scene B corresponds to a language sub-network 2. When analysis needs to be performed based on the virtual scene A, language analysis is performed through the language sub-network 1. When analysis needs to be performed based on the virtual scene B, language analysis is performed through the language sub-network 2.

For example, the first virtual scene is a virtual scene of the at least two virtual scenes. In addition to determining the first scene hot-word based on the first virtual scene in which the target virtual character is located, the first language sub-network corresponding to the first virtual scene is further determined from the at least two language sub-networks based on the first virtual scene. The first language sub-network is a sub-network layer for analyzing semantics of the natural language command based on the first virtual scene.

In an example, a sequence matching relationship between the plurality of speech units and a selected word in the preset dictionary is analyzed through the first language sub-network, to convert the natural language command in the speech form into the text form.

In some examples, different language sub-networks are language sub-networks obtained through pre-training based on corresponding virtual scenes. The first language sub-network is a language sub-network obtained through training based on the first virtual scene.

In some examples, a matching relationship between the plurality of speech units and the selected word in the preset dictionary is analyzed to obtain a plurality of candidate word sequences.

The selected word includes at least the at least one first scene hot-word and a general word.

For example, a process of analyzing the matching relationship represents a process of analyzing a status of matching between the selected word and the speech units. For example, each selected word corresponds to at least one speech unit, and a conversion probability of converting the speech unit into the selected word is determined by analyzing the plurality of speech units and the selected word. The conversion probability represents a probability of matching between the selected word and the speech unit. A higher conversion probability indicates that the speech unit is closer to the selected word, in other words, indicates a higher probability that the speech unit may express the selected word, and therefore indicates a stronger matching relationship between the selected word and the speech unit.

In some examples, the plurality of speech units form at least one speech unit sequence, and at least one candidate word sequence respectively corresponding to the at least one speech unit sequence is determined based on a matching analysis process between the speech units and the selected word, to obtain the plurality of candidate word sequences.

In some examples, sequence semantics of the plurality of candidate word sequences are analyzed through the first language sub-network, and the at least one candidate word sequence is obtained from the plurality of candidate word sequences as the text form into which the natural language command is converted.

For example, the sequence semantics are configured for representing semantic information expressed by the candidate word sequence, and not only can indicate a semantic change of at least one word in the candidate word sequence, but also can indicate sentence semantics of the entire candidate word sequence.

For example, the natural language command in the text form is referred to as a command analysis result. The first language sub-network separately evaluates the plurality of candidate word sequences, to use at least one candidate word sequence that better conforms to a current semantic situation as the command analysis result, that is, convert the natural language command in the speech form into the text form.

The foregoing are merely examples. This is not limited in examples of this disclosure.

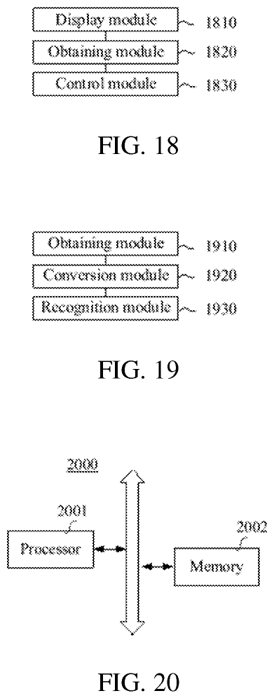

FIG. 18 is a block diagram of a structure of a virtual character control apparatus according to an example of this disclosure. As shown in FIG. 18, the apparatus includes the following parts:
a display module 1810, configured to display at least one of a main control virtual character and an NPC that are located in a virtual environment;
an obtaining module 1820, configured to obtain a natural language command in a speech form, the natural language command including natural semantics for controlling the NPC; and
a control module 1830, configured to control, based on a behavioral intention expressed by the natural language command, the NPC to perform a virtual activity, the behavioral intention being recognized from the natural language command based on environmental perception information, the environmental perception information including information obtained by perceiving the virtual environment by at least one of the main control virtual character and the NPC.

In an example, the control module 1830 is further configured to: convert the natural language command into a command analysis result in a text form, the command analysis result being a result obtained by performing speech-to-text conversion on the natural language command based on the environmental perception information, the command analysis result being configured to recognize the behavioral intention, and the behavioral intention being intention information expressed in the command analysis result; and control, based on the behavioral intention, the NPC to perform the virtual activity.

In an example, the control module 1830 is further configured to: obtain at least one first scene hot-word based on a first virtual scene in which the main control virtual character and/or the NPC are/is located, the at least one first scene hot-word being a scene-associated word of the first virtual scene; and convert the natural language command into the command analysis result in the text form based on the at least one first scene hot-word.

In an example, the control module 1830 is further configured to: obtain a first scene type corresponding to the first virtual scene in which the main control virtual character and/or the NPC are/is located, obtain a hot-word set corresponding to the first scene type, and use a word in the hot-word set as the at least one first scene hot-word, the hot-word set being a set of scene-associated words collected based on the first scene type; or obtain an object perception range of the main control virtual character and/or the NPC in the first virtual scene, the object perception range being a three-dimensional space range in which the main control virtual character and/or the NPC have/has perception for another scene element, and obtain the at least one first scene hot-word based on environmental perception information in the object perception range; or obtain a first scene type corresponding to the first virtual scene, obtain a hot-word set corresponding to the first scene type, obtain an object perception range of the main control virtual character and/or the NPC in the first virtual scene, and obtain at least one word from the hot-word set as the at least one first scene hot-word based on environmental perception information in the object perception range.

In an example, the object perception range includes at least one of the following:
a visual perception range of the main control virtual character and/or the NPC;
an auditory perception range of the main control virtual character and/or the NPC;
an olfactory perception range of the main control virtual character and/or the NPC; or
a range perceived by a perceptual skill or a perceptual item that is owned by the main control virtual character and/or the NPC.

In an example, the control module 1830 is further configured to: when the object perception range includes the visual perception range, generate a preset frustum as the visual perception range by using a location of the main control virtual character and/or the NPC as a start point and using a rotation of the main control virtual character and/or the NPC as a center line of the frustum, the preset frustum being a three-dimensional area for measuring the visual perception range.

In an example, the environmental perception information includes a virtual element; and
the control module 1830 is further configured to: highlight the virtual element within the object perception range in the first virtual scene; and use an element name of the virtual element as the first scene hot-word; or use an action name of an interactive action corresponding to the virtual element as the first scene hot-word.

In an example, the first virtual scene is one of a plurality of virtual scenes in the virtual environment; and the control module 1830 is further configured to determine, from the plurality of virtual scenes based on a location of the main control virtual character and/or the NPC in the virtual environment, the first virtual scene in which the main control virtual character and/or the NPC are/is located.

In an example, the control module 1830 is further configured to: when the command analysis result is not obtained, in response to that the main control virtual character and/or the NPC move/moves from the first virtual scene to a second virtual scene, obtain at least one second scene hot-word corresponding to the second virtual scene; and convert the natural language command into the command analysis result in the text form based on the at least one second scene hot-word.

In an example, the display module 1810 is further configured to: display the command analysis result in the text form; and display a reply statement of the NPC in reply to the command analysis result, the reply statement being a text statement generated by performing semantic analysis based on the command analysis result.

In an example, the control module 1830 is further configured to: obtain a plurality of scene hot-words, the plurality of scene hot-words corresponding to at least two virtual scenes; and obtain, from the plurality of scene hot-words based on the first virtual scene in which the main control virtual character and/or the NPC are/is located, the at least one first scene hot-word corresponding to the first virtual scene.

In an example, the plurality of scene hot-words correspond to scene identifiers, and the scene identifiers are configured to indicate virtual scenes in which scene hot-words are collected; and the control module 1830 is further configured to: obtain a plurality of candidate scene hot-words with a first scene identifier from the plurality of scene hot-words based on the first virtual scene in which the main control virtual character and/or the NPC are/is located, the first scene identifier being a scene identifier corresponding to the first virtual scene; and select at least one candidate scene hot-word from the plurality of candidate scene hot-words as the first scene hot-word based on the object perception range of the main control virtual character and/or the NPC in the first virtual scene.

In an example, the control module 1830 is further configured to: obtain a pre-trained natural language analysis model, the pre-trained natural language analysis model including an acoustic network, a language network, and a preset dictionary, and the preset dictionary including the at least one first scene hot-word, another scene hot-word, and a general word; obtain, through the acoustic network, a plurality of speech units corresponding to the natural language command, the speech unit being a basic constituent unit of a word pronunciation; and analyze a sequence matching relationship between the plurality of speech units and a selected word in the preset dictionary through the language network to obtain the command analysis result in the text form, the selected word including at least the at least one first scene hot-word and the general word.

In an example, the selected word further includes the another scene hot-word; and a word in the preset dictionary includes an analysis weight, a first analysis weight of the at least one first scene hot-word is higher than a second analysis weight of the another scene hot-word, and the analysis weight is a degree of attention paid to a word when the word participates in sequence matching.

In an example, the control module 1830 is further configured to: analyze the matching relationship between the plurality of speech units and the selected word in the preset dictionary to obtain a plurality of candidate word sequences, the plurality of candidate word sequences including at least one of a plurality of selected words, and the candidate word sequence being a word sequence obtained based on a change relationship between the plurality of speech units; and analyze sequence semantics of the plurality of candidate word sequences through the language network, and obtain at least one candidate word sequence from the plurality of candidate word sequences as the command analysis result in the text form.

In an example, the language network includes language sub-networks respectively corresponding to at least two virtual scenes; and the control module 1830 is further configured to: determine, from at least two language sub-networks based on the first virtual scene in which the main control virtual character and/or the NPC are/is located, a first language sub-network corresponding to the first virtual scene; and analyze the sequence semantics of the plurality of candidate word sequences through the first language sub-network, and obtain the at least one candidate word sequence from the plurality of candidate word sequences as the command analysis result in the text form.

In an example, the NPC has a plurality of behavior capabilities in the virtual scene, and the plurality of behavior capabilities correspond to a plurality of classification labels; and the control module 1830 is further configured to: invoke at least one hierarchical prediction network to perform behavioral intention recognition on the command analysis result to obtain, as the behavioral intention, a first classification label of an intention of the command analysis result to command the NPC, the hierarchical prediction network including at least two layers of sub-networks, and the at least two layers of sub-networks being constructed based on a tree structure of the plurality of classification labels; and control the NPC to perform the virtual activity based on a first intention corresponding to the first classification label.

In an example, the behavioral intention includes at least one intention dimension; each of the at least one hierarchical prediction network being configured to predict a command intention of the command analysis result for the NPC in one intention dimension; an i^{th}-layer sub-network in each hierarchical prediction network being configured to predict a first-level behavior label of the command analysis result in the intention dimension, an (i+1)^{th}-layer sub-network in the hierarchical prediction network being configured to predict a second-level behavior label corresponding to the command analysis result in the first-level behavior label, and i is a positive integer; and the intention dimension includes at least one of a subject dimension, a semantic dimension, or a behavior dimension.

In an example, the intention dimension includes the subject dimension, the hierarchical prediction network includes a subject prediction network of a hierarchical structure, the subject prediction network has a capability of predicting a subject type in the command analysis result, and the subject type is configured to represent an identity of the NPC under the command of the command analysis result; and/or the intention dimension includes the semantic dimension, the hierarchical prediction network includes a semantic prediction network of a hierarchical structure, the semantic prediction network has a capability of predicting a semantic type in the command analysis result, and the semantic type is configured to represent a control mode of the NPC for initiating a virtual attack; and/or the intention dimension includes the behavior dimension, the hierarchical prediction network includes a behavior prediction network of a hierarchical structure, the behavior prediction network has a capability of predicting a behavior type in the command analysis result, and the behavior type is configured to represent a behavior mode of the NPC for performing the virtual activity.

FIG. 19 is a block diagram of a structure of a virtual character control apparatus according to an example of this disclosure. As shown in FIG. 19, the apparatus includes the following parts:
an obtaining module 1910, configured to obtain a natural language command in a speech form, the natural language command including natural semantics for controlling an NPC;
a conversion module 1920, configured to convert the natural language command into a command analysis result in a text form, the command analysis result being a result obtained by performing speech-to-text conversion on the natural language command based on environmental perception information, and the environmental perception information including information obtained by perceiving a virtual environment by at least one of a main control virtual character and the NPC; and
a recognition module 1930, configured to perform behavioral intention recognition on the command analysis result to obtain a behavioral intention, the behavioral intention being intention information expressed in the command analysis result, and the behavioral intention being configured to control the NPC to perform a virtual activity.

In an example, the conversion module 1920 is further configured to: obtain at least one first scene hot-word based on a first virtual scene in which the main control virtual character and/or the NPC are/is located, the at least one first scene hot-word being a scene-associated word of the first virtual scene; and convert the natural language command into the command analysis result in the text form based on the at least one first scene hot-word.

In an example, the conversion module 1920 is further configured to: obtain a first scene type corresponding to the first virtual scene in which the main control virtual character and/or the NPC are/is located, obtain a hot-word set corresponding to the first scene type, and use a word in the hot-word set as the at least one first scene hot-word, the hot-word set being a set of scene-associated words collected based on the first scene type; or obtain an object perception range of the main control virtual character and/or the NPC in the first virtual scene, the object perception range being a three-dimensional space range in which the main control virtual character and/or the NPC have/has perception for another scene element, and obtain the at least one first scene hot-word based on environmental perception information in the object perception range; or obtain a first scene type corresponding to the first virtual scene, obtain a hot-word set corresponding to the first scene type, obtain an object perception range of the main control virtual character and/or the NPC in the first virtual scene, and obtain at least one word from the hot-word set as the at least one first scene hot-word based on environmental perception information in the object perception range.

In an example, the object perception range includes at least one of the following: a visual perception range of the main control virtual character and/or the NPC; an auditory perception range of the main control virtual character and/or the NPC; an olfactory perception range of the main control virtual character and/or the NPC; or a range perceived by a perceptual skill or a perceptual item that is owned by the main control virtual character and/or the NPC.

In an example, the conversion module 1920 is further configured to: when the object perception range includes the visual perception range, generate a preset frustum as the visual perception range by using a location of the main control virtual character and/or the NPC as a start point and using a rotation of the main control virtual character and/or the NPC as a center line of the frustum, the preset frustum being a three-dimensional area for measuring the visual perception range.

In an example, the environmental perception information includes a virtual element; and
the conversion module 1920 is further configured to: determine the virtual element within the object perception range in the first virtual scene; and use an element name of the virtual element as the first scene hot-word; or use an action name of an interactive action corresponding to the virtual element as the first scene hot-word.

In an example, the first virtual scene is one of a plurality of virtual scenes in the virtual environment; and
the conversion module 1920 is further configured to determine, from the plurality of virtual scenes based on a location of the main control virtual character and/or the NPC in the virtual environment, the first virtual scene in which the main control virtual character and/or the NPC are/is located.

In an example, the conversion module 1920 is further configured to: when the command analysis result is not obtained, in response to that the main control virtual character and/or the NPC move/moves from the first virtual scene to a second virtual scene, obtain at least one second scene hot-word corresponding to the second virtual scene; and convert the natural language command into the command analysis result in the text form based on the at least one second scene hot-word.

In an example, the conversion module 1920 is further configured to: obtain a plurality of scene hot-words, the plurality of scene hot-words corresponding to at least two virtual scenes; and obtain, from the plurality of scene hot-words based on the first virtual scene in which the main control virtual character and/or the NPC are/is located, the at least one first scene hot-word corresponding to the first virtual scene.

In an example, the conversion module 1920 is further configured to: obtain a plurality of candidate scene hot-words with a first scene identifier from the plurality of scene hot-words based on the first virtual scene in which the main control virtual character and/or the NPC are/is located, the first scene identifier being a scene identifier corresponding to the first virtual scene; and select at least one candidate scene hot-word from the plurality of candidate scene hot-words as the first scene hot-word based on the object perception range of the main control virtual character and/or the NPC in the first virtual scene.

In an example, the conversion module 1920 is further configured to: obtain a pre-trained natural language analysis model, the pre-trained natural language analysis model including an acoustic network, a language network, and a preset dictionary, and the preset dictionary including the at least one first scene hot-word, another scene hot-word, and a general word; obtain, through the acoustic network, a plurality of speech units corresponding to the natural language command, the speech unit being a basic constituent unit of a word pronunciation; and analyze a sequence matching relationship between the plurality of speech units and a selected word in the preset dictionary through the language network to obtain the command analysis result in the text form, the selected word including at least the at least one first scene hot-word and the general word.

In an example, the selected word further includes the another scene hot-word; and a word in the preset dictionary includes an analysis weight, a first analysis weight of the at least one first scene hot-word is higher than a second analysis weight of the another scene hot-word, and the analysis weight is a degree of attention paid to a word when the word participates in sequence matching.

In an example, the conversion module 1920 is further configured to: analyze the matching relationship between the plurality of speech units and the selected word in the preset dictionary to obtain a plurality of candidate word sequences, the plurality of candidate word sequences including at least one of a plurality of selected words, and the candidate word sequence being a word sequence obtained based on a change relationship between the plurality of speech units; and analyze sequence semantics of the plurality of candidate word sequences through the language network, and obtain at least one candidate word sequence from the plurality of candidate word sequences as the command analysis result in the text form.

In an example, the conversion module 1920 is further configured to: determine, from at least two language sub-networks based on the first virtual scene in which the main control virtual character and/or the NPC are/is located, a first language sub-network corresponding to the first virtual scene; and analyze the sequence semantics of the plurality of candidate word sequences through the first language sub-network, and obtain the at least one candidate word sequence from the plurality of candidate word sequences as the command analysis result in the text form.

In an example, the NPC has a plurality of behavior capabilities in the virtual scene, and the plurality of behavior capabilities correspond to a plurality of classification labels; and the recognition module 1930 is further configured to invoke at least one hierarchical prediction network to perform behavioral intention recognition on the command analysis result to obtain, as the behavioral intention, a first classification label of an intention of the command analysis result to command the NPC, the hierarchical prediction network including at least two layers of sub-networks, and the at least two layers of sub-networks being constructed based on a tree structure of the plurality of classification labels.

In an example, the behavioral intention includes at least one intention dimension; each of the at least one hierarchical prediction network being configured to predict a command intention of the command analysis result for the NPC in one intention dimension; an i^{th}-layer sub-network in each hierarchical prediction network being configured to predict a first-level behavior label of the command analysis result in the intention dimension, an (i+1)^{th}-layer sub-network in the hierarchical prediction network being configured to predict a second-level behavior label corresponding to the command analysis result in the first-level behavior label, and i is a positive integer; and the intention dimension includes at least one of a subject dimension, a semantic dimension, or a behavior dimension.

In an example, the intention dimension includes the subject dimension, the hierarchical prediction network includes a subject prediction network of a hierarchical structure, the subject prediction network has a capability of predicting a subject type in the command analysis result, and the subject type is configured to represent an identity of the NPC under the command of the command analysis result; and/or the intention dimension includes the semantic dimension, the hierarchical prediction network includes a semantic prediction network of a hierarchical structure, the semantic prediction network has a capability of predicting a semantic type in the command analysis result, and the semantic type is configured to represent a control mode of the NPC for initiating a virtual attack; and/or the intention dimension includes the behavior dimension, the hierarchical prediction network includes a behavior prediction network of a hierarchical structure, the behavior prediction network has a capability of predicting a behavior type in the command analysis result, and the behavior type is configured to represent a behavior mode of the NPC for performing the virtual activity.

To sum up, the environmental perception information of the main control virtual character and/or the NPC helps better understand the natural language command, to improve accuracy of analyzing the natural language command, and further improve precision of the recognized behavioral intention, so that the behavioral intention better matches the virtual environment. This greatly avoids ineffective command or incorrect command on the NPC, helps reduce a misoperation rate of the player, helps the player reduce a quantity of operations during a virtual battle to some extent, reduces an amount of operation-related data to be processed, and improves utilization of computing resources and efficiency of human-computer interaction.

FIG. 20 is a block diagram of a structure of an electronic device 2000 according to an example of this disclosure. The electronic device 2000 may be a portable mobile terminal, for example, a smartphone, an in-vehicle terminal, a tablet computer, a moving picture experts group audio layer III (MP3) player, a moving picture experts group audio layer IV (MP4) player, a notebook computer, or a desktop computer. The electronic device 2000 may also be referred to as another name such as user equipment, a portable terminal, a laptop terminal, or a desktop terminal.

Usually, the electronic device 2000 includes a processor 2001 and a memory 2002.

The processor 2001 may include one or more processing cores, for example, a 4-core processor or an 8-core processor.

The memory 2002 may include one or more computer-readable storage media, and the computer-readable storage medium may be non-transient.

In some examples, the electronic device 2000 further includes one or more sensors. The one or more sensors include, but are not limited to, a proximity sensor, a gyroscope sensor, and a pressure sensor.

In some examples, the electronic device 2000 further includes other component parts. A person skilled in the art may understand that the structure shown in FIG. 20 constitutes no limitation on the electronic device 2000, and the electronic device 2000 may include more or fewer components than those shown in the figure, or some components may be combined, or different component arrangements may be used.

A person of ordinary skill in the art may understand that all or some of the operations of the foregoing examples may be implemented by hardware, or may be implemented by a program instructing relevant hardware. The program may be stored in a computer-readable storage medium. The storage medium may be a read-only memory, a magnetic disk, an optical disc, or the like. The foregoing descriptions are merely examples of this disclosure, but are not intended to limit this disclosure. Any modification, equivalent replacement, or improvement made within the spirit and principle of this disclosure shall fall within the protection scope of this disclosure.

What is claimed is:

1. A virtual character control method, performed by a computer device, the method comprising:
displaying at least one of a main control virtual character or a non-player character (NPC) in a virtual environment;
obtaining a natural language command in a voice form, the natural language command comprising natural semantics for controlling the NPC;
determining a behavioral intention from the natural language command based on environmental perception information, the environmental perception information comprising information obtained by perceiving the virtual environment by at least one of the main control virtual character or the NPC; and
controlling, based on the behavioral intention from the natural language command, the NPC to perform a virtual activity.

2. The method according to claim 1, wherein the controlling, based on the behavioral intention from the natural language command, the NPC to perform the virtual activity comprises:
converting the natural language command into a command analysis result in a text form by performing speech-to-text conversion on the natural language command based on the environmental perception information, the command analysis result being configured to obtain the behavioral intention through intention recognition.

3. The method according to claim 2, wherein the converting the natural language command into the command analysis result in the text form comprises:
obtaining at least one first scene hot-word based on a first virtual scene in which at least the main control virtual character or the NPC is located, the at least one first scene hot-word being a scene-associated word of the first virtual scene; and
converting the natural language command into the command analysis result in the text form based on the at least one first scene hot-word.

4. The method according to claim 3, wherein the obtaining the at least one first scene hot-word based on a first virtual scene comprises:
obtaining a first scene type corresponding to the first virtual scene; and obtaining a hot-word set corresponding to the first scene type, and using at least one word in the hot-word set as the at least one first scene hot-word, the hot-word set being a set of scene-associated words collected based on the first scene type; or
obtaining an object perception range of at least one of the main control virtual character or the NPC in the first virtual scene, the object perception range being a three-dimensional space range in which the at least one of the main control virtual character or the NPC has perception for another scene element; and obtaining the at least one first scene hot-word based on environmental perception information in the object perception range; or
obtaining the first scene type corresponding to the first virtual scene; obtaining the hot-word set corresponding to the first scene type; obtaining the object perception range of the at least one of the main control virtual character or the NPC in the first virtual scene; and obtaining the at least one word from the hot-word set as the at least one first scene hot-word based on environmental perception information in the object perception range.

5. The method according to claim 4, wherein the object perception range comprises at least one of the following:
a visual perception range of the at least one of the main control virtual character or the NPC;
an auditory perception range of the at least one of the main control virtual character or the NPC;
an olfactory perception range of the at least one of the main control virtual character or the NPC; or
a range perceived by a perceptual skill or a perceptual item that is owned by the at least one of the main control virtual character or the NPC.

6. The method according to claim 5, wherein the obtaining the object perception range of the at least one of the main control virtual character or the NPC in the first virtual scene comprises:
when the object perception range comprises the visual perception range, generating a preset frustum as the visual perception range by using a location of the at least one of the main control virtual character or the NPC as a start point and using a rotation of the at least one of the main control virtual character or the NPC as a center line of the frustum, the preset frustum being a three-dimensional area for measuring the visual perception range.

7. The method according to claim 3, wherein the first virtual scene is one of a plurality of virtual scenes in the virtual environment, and
the method further comprises:
determining, from the plurality of virtual scenes based on a location of the at least one of the main control virtual character or the NPC in the virtual environment, the first virtual scene in which the at least one of the main control virtual character or the NPC are located.

8. The method according to claim 3, further comprising:
when the command analysis result is not obtained, in response to that the at least one of the main control virtual character and/or the NPC moves from the first virtual scene to a second virtual scene, obtaining at least one second scene hot-word corresponding to the second virtual scene; and
converting the natural language command into the command analysis result in the text form based on the at least one second scene hot-word.

9. The method according to claim 2, wherein after the converting the natural language command into the command analysis result in the text form, the method further comprises:
displaying the command analysis result in the text form; and
displaying a reply statement of the NPC in reply to the command analysis result, the reply statement being a text statement generated by performing semantic analysis based on the command analysis result.

10. A virtual character control method, performed by a server, the method comprising:
obtaining a natural language command in a voice form, the natural language command comprising natural semantics for controlling a non-player character (NPC);
converting the natural language command into a command analysis result in a text form, the command analysis result being a result obtained by performing speech-to-text conversion on the natural language command based on environmental perception information, and the environmental perception information comprising information obtained by perceiving a virtual environment by at least one of a main control virtual character or the NPC; and
performing behavioral intention recognition on the command analysis result to obtain a behavioral intention, the behavioral intention being intention information expressed in the command analysis result, and the behavioral intention being configured to control the NPC to perform a virtual activity.

11. The method according to claim 10, wherein the converting the natural language command into the command analysis result in the text form comprises:
obtaining at least one first scene hot-word based on a first virtual scene in which the at least one of the main control virtual character or the NPC is located, the at least one first scene hot-word being a scene-associated word of the first virtual scene; and
converting the natural language command into the command analysis result in the text form based on the at least one first scene hot-word.

12. The method according to claim 11, wherein the obtaining the at least one first scene hot-word based on the first virtual scene comprises:
obtaining a first scene type corresponding to the first virtual scene in which the at least one of the main control virtual character or the NPC is located; and obtaining a hot-word set corresponding to the first scene type, and using at least one word in the hot-word set as the at least one first scene hot-word, the hot-word set being a set of scene-associated words collected based on the first scene type; or
obtaining an object perception range of the at least one of the main control virtual character or the NPC in the first virtual scene, the object perception range being a three-dimensional space range in which the at least one of the main control virtual character or the NPC has perception for another scene element; and obtaining the at least one first scene hot-word based on environmental perception information in the object perception range; or
obtaining the first scene type corresponding to the first virtual scene; obtaining the hot-word set corresponding to the first scene type; obtaining the object perception range of the at least one of the main control virtual character or the NPC in the first virtual scene; and obtaining the at least one word from the hot-word set as the at least one first scene hot-word based on environmental perception information in the object perception range.

13. The method according to claim 12, wherein the object perception range comprises at least one of the following:
a visual perception range of the at least one of the main control virtual character or the NPC;
an auditory perception range of the at least one of the main control virtual character or the NPC;
an olfactory perception range of the at least one of the main control virtual character or the NPC; or
a range perceived by a perceptual skill or a perceptual item that is owned by the at least one of the main control virtual character or the NPC.

14. The method according to claim 13, wherein the obtaining the object perception range of the at least one of the main control virtual character or the NPC in the first virtual scene comprises:
when the object perception range comprises the visual perception range, generating a preset frustum as the visual perception range by using a location of the at least one of the main control virtual character or the NPC as a start point and using a rotation of the at least one of the main control virtual character or the NPC as a center line of the frustum, the preset frustum being a three-dimensional area for measuring the visual perception range.

15. The method according to claim 12, wherein the first virtual scene is one of a plurality of virtual scenes in the virtual environment; and
the method further comprises:
determining, from the plurality of virtual scenes based on a location of the at least one of the main control virtual character or the NPC in the virtual environment, the first virtual scene in which the at least one of the main control virtual character or the NPC is located.

16. The method according to claim 12, further comprising:
when the command analysis result is not obtained, in response to that the at least one of the main control virtual character or the NPC moves from the first virtual scene to a second virtual scene, obtaining at least one second scene hot-word corresponding to the second virtual scene; and
converting the natural language command into the command analysis result in the text form based on the at least one second scene hot-word.

17. An apparatus comprising:
one or more processors; and
memory storing instructions that, when executed by the one or more processors, cause the apparatus to:
display at least one of a main control virtual character or a non-player character (NPC) in a virtual environment;
obtain a natural language command in a voice form, the natural language command comprising natural semantics for controlling the NPC;
determine a behavioral intention from the natural language command based on environmental perception information, the environmental perception information comprising information obtained by perceiving the virtual environment by at least one of the main control virtual character or the NPC; and
control, based on the behavioral intention from the natural language command, the NPC to perform a virtual activity.

18. The apparatus of claim 17, wherein the instructions, when executed by the one or more processors, cause the apparatus to control, based on the behavioral intention from the natural language command, the NPC to perform the virtual activity by:
converting the natural language command into a command analysis result in a text form by performing speech-to-text conversion on the natural language command based on the environmental perception information, the command analysis result being configured to obtain the behavioral intention through intention recognition.

19. The apparatus of claim 18, wherein the instructions, when executed by the one or more processors, cause the apparatus to convert the natural language command into the command analysis result in the text form by:
obtaining at least one first scene hot-word based on a first virtual scene in which at least the main control virtual character or the NPC is located, the at least one first scene hot-word being a scene-associated word of the first virtual scene; and
converting the natural language command into the command analysis result in the text form based on the at least one first scene hot-word.

20. The apparatus of claim 18, wherein the instructions, when executed by the one or more processors, cause the apparatus to convert the natural language command into the command analysis result in the text form by:
displaying the command analysis result in the text form; and
displaying a reply statement of the NPC in reply to the command analysis result, the reply statement being a text statement generated by performing semantic analysis based on the command analysis result.
